(19) United States
(12) Patent Application Publication
(10) Pub. No.: US 2020/0227763 A1
(43) Pub. Date: Jul. 16, 2020

(54) Electrochemical Reactor Systems

(71) Applicant: Utility Global, Inc., Provo, UT (US)

(72) Inventors: David R. Hall, Provo, UT (US); Matthew Dawson, Draper, UT (US); Nicholas Farandos, London (GB); Jin Dawson, Draper, UT (US)

(73) Assignee: Utility Global, Inc., Provo, UT (US)

(21) Appl. No.: 16/775,176

(22) Filed: Jan. 28, 2020

Related U.S. Application Data
(63) Continuation-in-part of application No. 16/674,580, filed on Nov. 5, 2019.
Application No. 16/674,580 is a continuation-in-part of application No. 16/674,629, filed on Nov. 5, 2019.
Application No. 16/674,629 is a continuation-in-part of application No. 16/674,657, filed on Nov. 5, 2019.
Application No. 16/674,657 is a continuation-in-part of application No. 16/674,695, filed on Nov. 5, 2019.
Application No. 16/674,695 is a continuation-in-part of application No. 16/680,770, filed on Nov. 12, 2019.
Application No. 16/680,770 is a continuation-in-part of application No. 16/684,838, filed on Nov. 15, 2019.
Application No. 16/684,838 is a continuation-in-part of application No. 16/684,864, filed on Nov. 15, 2019.
Application No. 16/684,864 is a continuation-in-part of application No. 16/693,268, filed on Nov. 23, 2019.
Application No. 16/693,268 is a continuation-in-part of application No. 16/693,269, filed on Nov. 23, 2019.
Application No. 16/693,269 is a continuation-in-part of application No. 16/693,270, filed on Nov. 23, 2019.
Application No. 16/693,270 is a continuation-in-part of application No. 16/693,271, filed on Nov. 23, 2019.
Application No. 16/693,271 is a continuation-in-part of application No. 16/707,046, filed on Dec. 9, 2019.
Application No. 16/707,046 is a continuation-in-part of application No. 16/707,066, filed on Dec. 9, 2019.
Application No. 16/707,066 is a continuation-in-part of application No. 16/707,084, filed on Dec. 9, 2019.
Application No. 16/707,084 is a continuation-in-part of application No. 16/739,612, filed on Jan. 10, 2020.
Application No. 16/739,612 is a continuation-in-part of application No. 16/739,671, filed on Jan. 10, 2020.
Application No. 16/739,671 is a continuation-in-part of application No. 16/739,727, filed on Jan. 10, 2020.
Application No. 16/739,727 is a continuation-in-part of application No. 16/739,748, filed on Jan. 10, 2020.
(60) Provisional application No. 62/767,413, filed on Nov. 14, 2018.
(60) Provisional application No. 62/768,864, filed on Nov. 17, 2018.
(60) Provisional application No. 62/771,045, filed on Nov. 24, 2018.
(60) Provisional application No. 62/773,071, filed on Nov. 29, 2018.
(60) Provisional application No. 62/773,912, filed on Nov. 30, 2018.
(60) Provisional application No. 62/777,273, filed on Dec. 10, 2018.
(60) Provisional application No. 62/777,338, filed on Dec. 10, 2018.
(60) Provisional application No. 62/779,005, filed on Dec. 13, 2018.
(60) Provisional application No. 62/780,211, filed on Dec. 15, 2018.
(60) Provisional application No. 62/783,192, filed on Dec. 20, 2018.
(60) Provisional application No. 62/784,472, filed on Dec. 23, 2018.
(60) Provisional application No. 62/786,341, filed on Dec. 29, 2018.
(60) Provisional application No. 62/791,629, filed on Jan. 11, 2019.
(60) Provisional application No. 62/797,572, filed on Jan. 28, 2019.
(60) Provisional application No. 62/798,344, filed on Jan. 29, 2019.
(60) Provisional application No. 62/804,115, filed on Feb. 11, 2019.
(60) Provisional application No. 62/805,250, filed on Feb. 13, 2019.
(60) Provisional application No. 62/808,644, filed on Feb. 21, 2019.
(60) Provisional application No. 62/809,602, filed on Feb. 23, 2019.
(60) Provisional application No. 62/814,695, filed on Mar. 6, 2019.
(60) Provisional application No. 62/819,374, filed on Mar. 15, 2019.
(60) Provisional application No. 62/819,289, filed on Mar. 15, 2019.
(60) Provisional application No. 62/824,229, filed on Mar. 26, 2019.
(60) Provisional application No. 62/825,576, filed on Mar. 28, 2019.
(60) Provisional application No. 62/827,800, filed on Apr. 1, 2019.
(60) Provisional application No. 62/834,531, filed on Apr. 16, 2019.
(60) Provisional application No. 62/837,089, filed on Apr. 22, 2019.
(60) Provisional application No. 62/839,587, filed on Apr. 26, 2019.
(60) Provisional application No. 62/840,381, filed on Apr. 29, 2019.
(60) Provisional application No. 62/844,126, filed on May 7, 2019.
(60) Provisional application No. 62/844,127, filed on May 7, 2019.
(60) Provisional application No. 62/847,472, filed on May 14, 2019.
(60) Provisional application No. 62/849,269, filed on May 17, 2019.
(60) Provisional application No. 62/852,045, filed on May 23, 2019.
(60) Provisional application No. 62/856,736, filed on Jun. 3, 2019.
(60) Provisional application No. 62/863,390, filed on Jun. 19, 2019.
(60) Provisional application No. 62/864,492, filed on Jun. 20, 2019.
(60) Provisional application No. 62/866,758, filed on Jun. 26, 2019.
(60) Provisional application No. 62/869,322, filed on Jul. 1, 2019.
(60) Provisional application No. 62/875,437, filed on Jul. 17, 2019.
(60) Provisional application No. 62/877,699, filed on Jul. 23, 2019.
(60) Provisional application No. 62/888,319, filed on Aug. 16, 2019.
(60) Provisional application No. 62/895,416, filed on Sep. 3, 2019.
(60) Provisional application No. 62/896,466, filed on Sep. 5, 2019.
(60) Provisional application No. 62/904,683, filed on Sep. 24, 2019.
(60) Provisional application No. 62/899,087, filed on Sep. 11, 2019.
(60) Provisional application No. 62/912,626, filed on Oct. 8, 2019.
(60) Provisional application No. 62/925,210, filed on Oct. 23, 2019.
(60) Provisional application No. 62/927,627, filed on Oct. 29, 2019.
(60) Provisional application No. 62/928,326, filed on Oct. 30, 2019.
(60) Provisional application No. 62/756,257, filed on Nov. 6, 2018.
(60) Provisional application No. 62/756,264, filed on Nov. 6, 2018.
(60) Provisional application No. 62/757,751, filed on Nov. 8, 2018.
(60) Provisional application No. 62/758,778, filed on Nov. 12, 2018.
(60) Provisional application No. 62/934,808, filed on Nov. 13, 2019.
(60) Provisional application No. 62/939,531, filed on Nov. 22, 2019.
(60) Provisional application No. 62/941,358, filed on Nov. 27, 2019.
(60) Provisional application No. 62/944,259, filed on Dec. 5, 2019.
(60) Provisional application No. 62/944,756, filed on Dec. 6, 2019.
(60) Provisional application No. 62/948,759, filed on Dec. 16, 2019.
(60) Provisional application No. 62/955,443, filed on Dec. 31, 2019.

(51) Int. Cl. H01M 8/0606; H01M 8/04007; H01M 8/18

(52) U.S. Cl. CPC H01M 8/0606; H01M 2008/1293; H01M 8/188; H01M 8/04074

(57) ABSTRACT

A system comprising an electrochemical reactor chamber, an integrated chiller, and optionally a reformer chamber, wherein the reactor chamber, integrated chiller, and optional reformer chamber are of unitary construction.

### CROSS-REFERENCE TO RELATED APPLICATIONS

This application is a continuation-in-part application of U.S. patent application Ser. Nos. 16/739,612, 16/739,671, 16/739,727, and 16/739,748, filed Jan. 10, 2020, which are continuation-in-part applications of U.S. patent application Ser. Nos. 16/707,046, 16/707,066 and 16/707,084, filed Dec. 9, 2019, which are continuation-in-part applications of U.S. patent application Ser. Nos. 16/699,453 and 16/699,461, filed Nov. 29, 2019, which are continuation-in-part applications of U.S. patent application Ser. Nos. 16/693,268, 16/693,269, 16/693,270, and 16/693,271, filed Nov. 23, 2019, which are continuation-in-part applications of U.S. patent application Ser. Nos. 16/684,838 and 16/684,864 filed Nov. 15, 2019, which are continuation-in-part applications of U.S. patent application Ser. No. 16/680,770 filed Nov. 12, 2019, which is a continuation-in-part application of U.S. patent application Ser. Nos. 16/674,580, 16/674,629, 16/674,657, 16/674,695 all filed Nov. 5, 2019, each of which claims the benefit under 35 U.S.C. 119(e) of U.S. Provisional Patent Application No. 62/756,257 filed Nov. 6, 2018, U.S. Provisional Patent Application No. 62/756,264 filed Nov. 6, 2018, U.S. Provisional Patent Application No. 62/757,751 filed Nov. 8, 2018, U.S. Provisional Patent Application No. 62/758,778 filed Nov. 12, 2018, U.S. Provisional Patent Application No. 62/767,413 filed Nov. 14, 2018, U.S. Provisional Patent Application No. 62/768,864 filed Nov. 17, 2018, U.S. Provisional Patent Application No. 62/771,045 filed Nov. 24, 2018, U.S. Provisional Patent Application No. 62/773,071 filed Nov. 29, 2018, U.S. Provisional Patent Application No. 62/773,912 filed Nov. 30, 2018, U.S. Provisional Patent Application No. 62/777,273 filed Dec. 10, 2018, U.S. Provisional Patent Application No. 62/777,338 filed Dec. 10, 2018, U.S. Provisional Patent Application No. 62/779,005 filed Dec. 13, 2018, U.S. Provisional Patent Application No. 62/780,211 filed Dec. 15, 2018, U.S. Provisional Patent Application No. 62/783,192 filed Dec. 20, 2018, U.S. Provisional Patent Application No. 62/784,472 filed Dec. 23, 2018, U.S. Provisional Patent Application No. 62/786,341 filed Dec. 29, 2018, U.S. Provisional Patent Application No. 62/791,629 filed Jan. 11, 2019, U.S. Provisional Patent Application No. 62/797,572 filed Jan. 28, 2019, U.S. Provisional Patent Application No. 62/798,344 filed Jan. 29, 2019, U.S. Provisional Patent Application No. 62/804,115 filed Feb. 11, 2019, U.S. Provisional Patent Application No. 62/805,250 filed Feb. 13, 2019, U.S. Provisional Patent Application No. 62/808,644 filed Feb. 21, 2019, U.S. Provisional Patent Application No. 62/809,602 filed Feb. 23, 2019, U.S. Provisional Patent Application No. 62/814,695 filed Mar. 6, 2019, U.S. Provisional Patent Application No. 62/819,374 filed Mar. 15, 2019, U.S. Provisional Patent Application No. 62/819,289 filed Mar. 15, 2019, U.S. Provisional Patent Application No. 62/824,229 filed Mar. 26, 2019, U.S. Provisional Patent Application No. 62/825,576 filed Mar. 28, 2019, U.S. Provisional Patent Application No. 62/827,800 filed Apr. 1, 2019, U.S. Provisional Patent Application No. 62/834,531 filed Apr. 16, 2019, U.S. Provisional Patent Application No. 62/837,089 filed Apr. 22, 2019, U.S. Provisional Patent Application No. 62/840,381 filed Apr. 29, 2019, U.S. Provisional Patent Application No. 62/844,125 filed May 7, 2019, U.S. Provisional Patent Application No. 62/844,127 filed May 7, 2019, U.S. Provisional Patent Application No. 62/847,472 filed May 14, 2019, U.S. Provisional Patent Application No. 62/849,269 filed May 17, 2019, U.S. Provisional Patent Application No. 62/852,045 filed May 23, 2019, U.S. Provisional Patent Application No. 62/856,736 filed Jun. 3, 2019, U.S. Provisional Patent Application No. 62/863,390 filed Jun. 19, 2019, U.S. Provisional Patent Application No. 62/864,492 filed Jun. 20, 2019, U.S. Provisional Patent Application No. 62/866,758 filed Jun. 26, 2019, U.S. Provisional Patent Application No. 62/869,322 filed Jul. 1, 2019, U.S. Provisional Patent Application No. 62/875,437 filed Jul. 17, 2019, U.S. Provisional Patent Application No. 62/877,699 filed Jul. 23, 2019, U.S. Provisional Patent Application No. 62/888,319 filed Aug. 16, 2019, U.S. Provisional Patent Application No. 62/895,416 filed Sep. 3, 2019, U.S. Provisional Patent Application No. 62/896,466 filed Sep. 5, 2019, U.S. Provisional Patent Application No. 62/899,087 filed Sep. 11, 2019, U.S. Provisional Patent Application No. 62/904,683 filed Sep. 24, 2019, U.S. Provisional Patent Application No. 62/912,626 filed Oct. 8, 2019, U.S. Provisional Patent Application No. 62/925,210 filed Oct. 23, 2019, U.S. Provisional Patent Application No. 62/927,627 filed Oct. 29, 2019, U.S. Provisional Patent Application No. 62/928,326 filed Oct. 30, 2019, U.S. Provisional Patent Application No. 62/934,808 filed Nov. 13, 2019, U.S. Provisional Patent Application No. 62/939,531 filed Nov. 22, 2019, U.S. Provisional Patent Application No. 62/941,358 filed Nov. 27, 2019, U.S. Provisional Patent Application No. 62/944,259 filed Dec. 5, 2019, U.S. Provisional Patent Application No. 62/944,756 filed Dec. 6, 2019, U.S. Provisional Patent Application No. 62/948,759 filed Dec. 16, 2019, and U.S. Provisional Patent Application No. 62/955,443 filed Dec. 31, 2019. The entire disclosures of each of these listed applications are hereby incorporated herein by reference.

### TECHNICAL FIELD

This invention generally relates to electrochemical reactors. More specifically, this invention relates to electrochemical reactor systems that recycle and reuse material and energy.

### BACKGROUND

A fuel cell is an electrochemical apparatus or reactor that converts the chemical energy from a fuel into electricity through an electrochemical reaction. Sometimes, the heat generated by a fuel cell is also usable. There are many types of fuel cells. For example, proton-exchange membrane fuel cells (PEMFCs) are built out of membrane electrode assemblies (MEA) which include the electrodes, electrolyte, catalyst, and gas diffusion layers. An ink of catalyst, carbon, and electrode are sprayed or painted onto the solid electrolyte and carbon paper is hot pressed on either side to protect the inside of the cell and also act as electrodes. The most important part of the cell is the triple phase boundary where the electrolyte, catalyst, and reactants mix and thus where the cell reactions actually occur. The membrane must not be electrically conductive so that the half reactions do not mix.

PEMFCs are good candidates for vehicle and other mobile applications of all sizes (e.g., mobile phones) because they are compact. However, water management is crucial to performance. Too much water will flood the membrane and too little will dry it. In both cases, power output will drop. Water management is a difficult problem in PEM fuel cell systems, mainly because water in the membrane is attracted toward the cathode of the cell through polarization. Furthermore, the platinum catalyst on the membrane is easily poisoned by carbon monoxide (CO level needs to be no more than one part per million). The membrane is also sensitive to things like metal ions which can be introduced by corrosion of metallic bipolar plates, metallic components in the fuel cell system or from contaminants in the fuel and/or oxidant.

Solid oxide fuel cells (SOFCs) are a different class of fuel cells that use a solid oxide material as the electrolyte. SOFCs use a solid oxide electrolyte to conduct negative oxygen ions from the cathode to the anode. The electrochemical oxidation of the oxygen ions with fuel (e.g., hydrogen, carbon monoxide) occurs on the anode side. Some SOFCs use proton-conducting electrolytes (PC-SOFCs) which transport protons instead of oxygen ions through the electrolyte. Typically, SOFCs using oxygen ion conducting electrolytes have higher operating temperatures than PC-SOFCs. In addition, SOFCs do not typically require expensive platinum catalyst materials which are typically necessary for lower temperature fuel cells (i.e., PEMFCs), and are not vulnerable to carbon monoxide catalyst poisoning. Solid oxide fuel cells have a wide variety of applications, such as auxiliary power units for homes and vehicles as well as stationary power generation units for data centers. SOFCs comprise interconnects, which are placed between each individual cell so that the cells are connected in series and that the electricity generated by each cell is combined. One category of SOFCs are segmented-in-series (SIS) type SOFCs. The electrical current flow in SIS type SOFCs is parallel to the electrolyte in the lateral direction. Contrary to the SIS type SOFC, a different category of SOFC has electrical current flow perpendicular to the electrolyte in the lateral direction. These two categories of SOFCs are connected differently and assembled differently.

For the fuel cell to function properly and continuously, components for balance of plant (BOP) are needed. For example, the mechanical balance of plant includes air preheater, reformer and/or pre-reformer, afterburner, water heat exchanger and anode tail gas oxidizer. Other components are also needed, such as, power electronics, hydrogen sulfide sensors and fans for electrical balance of plant. These BOP components are often complex and expensive. For example, heat exchangers are an important BOP component. A fuel cell system can have many traditional heat exchangers (e.g., 4-10). A heat exchanger is a device capable of transferring heat between fluids. The fluids may flow counter-currently or concurrently. Heat exchangers may be used for both heating and cooling purposes. Heat exchangers have many applications, such as space heating, refrigeration, air conditioning, power stations, chemical plants, petrochemical plants, petroleum refineries, natural-gas processing, and sewage treatment. For example, shell and tube heat exchangers are a popular type of heat exchanger because they allow for a wide range of pressures and temperatures.

Fuel cells are simply examples of electrochemical reactors. These reactors output exhaust streams that often have high value heat and useful chemicals. As such, there is continuing need and interest to develop electrochemical reactor systems that recycle and reuse such energy and material to increase overall system efficiencies.

### SUMMARY

Further aspects and embodiments are provided in the following drawings, detailed description and claims. Unless specified otherwise, the features as described herein are combinable and all such combinations are within the scope of this disclosure.

One aspect of the present invention is a system that includes an electrochemical reactor chamber, an optional reformer chamber, an integrated chiller. The reactor chamber, reformer chamber, and integrated chiller are of unitary construction.

In another aspect, the system further includes an electrochemical reactor in the reactor chamber.

In still another aspect, the reactor chamber, reformer chamber, and integrated chiller are of a single material.

In a still further aspect, the system further includes a heat exchanger. The heat exchanger includes at least three fluid inlets and at least three fluid channels. Each of the at least three fluid channels has a minimum dimension of no greater than 30 mm.

In a yet still further aspect, the reactor chamber, the reformer chamber, the integrated chiller, and the heat exchanger are of unitary construction.

In still yet another aspect, the integrated chiller comprises a generator, absorber, evaporator, condenser, and optionally a rectifier.

In another aspect, the heat exchanger is configured such that exhaust from the reactor chamber is conveyed to the generator of the integrated chiller.

In another aspect of the present invention, a system includes at least one electrochemical reactor, a vessel containing the at least one electrochemical reactor, and an absorption chiller that includes a heating loop and a cooling loop. The vessel includes a heat exchange wall or a multi-fluid heat exchanger. At least a portion of the heat exchange wall or at least a portion of the multi-fluid heat exchanger transfers heat to the heating loop of the absorption chiller.

In still another aspect, at least a portion of the heat exchange wall or at least a portion of the multi-fluid heat exchanger is an integral part of the heating loop of the absorption chiller.

In a still further aspect, the cooling loop is configured to cool a residential space, a commercial space, or an apparatus.

In a yet still further aspect, the at least one electrochemical reactor is a solid oxide fuel cell or a solid oxide flow battery.

In a method aspect of the invention, a method includes placing an electrochemical reactor in an electrochemical reactor chamber, optionally placing a reformer in a reformer chamber and allowing exhaust from the reactor to add thermal energy to an integrated chiller. The reactor chamber, reformer chamber, and integrated chiller are of unitary construction. The integrated chiller can heat at least one reactant for the reactor. The integrated chiller can cool data centers or computing equipment.

In another method aspect, the exhaust from the reactor is allowed to heat at least one reactant for the reactor in a heat exchanger. The heat exchanger, the reactor chamber, the optional reformer chamber, and the integrated chiller are of unitary construction. The heat exchanger can include at least three fluid inlets and at least three fluid channels.

In still another method aspect, each of the at least three fluid channels has a minimum dimension of no greater than 30 mm.

In yet another method aspect, only one layer of material separates two fluid channels, wherein the layer is no greater than 5 mm thick.

In a yet still another method aspect, the heat is exchanged between a fluid that passes through the reactor chamber and at least a portion of the integrated chiller.

In a still yet another method aspect, the integrated chiller includes lithium bromide or ammonia.

In another method aspect, heat from the reactor or reactor chamber causes phase change in a fluid in the integrated chiller.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 illustrates a system for integrated deposition and heating using electromagnetic radiation (EMR), according to an embodiment of the disclosure;

FIG. 2 schematically illustrates two fuel cells in a fuel cell stack;

FIG. 3 illustrates maximum height profile roughness of an anode or cathode surface;

FIG. 4A illustrates a perspective view of a fuel cell cartridge (FCC);

FIG. 4B illustrates a perspective view of a cross-section of a fuel cell cartridge (FCC);

FIG. 4C illustrates cross-sectional views of a fuel cell cartridge (FCC);

FIG. 4D illustrates top view and bottom view of a fuel cell cartridge (FCC);

FIG. 5 illustrates a fuel cell unit comprising a reformer-anode layer, according to an embodiment of this disclosure;

FIG. 6A illustrates a reformer-anode layer design, according to an embodiment of the disclosure;

FIG. 6B illustrates a cross-sectional view of a reformer-anode layer design, according to an embodiment of the disclosure;

FIG. 6C illustrates another cross-sectional view of a reformer-anode layer design, according to an embodiment of the disclosure;

FIG. 6D illustrates another cross-sectional view of a reformer-anode layer design, according to an embodiment of the disclosure;

FIG. 7A schematically illustrates an embodiment of a device;

FIG. 7B schematically illustrates a cross-section of an embodiment of a device;

FIG. 7C schematically illustrates an embodiment of a channel in a reformer;

FIG. 7D schematically illustrates another embodiment of a channel in a reformer;

FIG. 8A schematically illustrates an embodiment of a wall in a device;

FIG. 8B schematically illustrates another embodiment of a wall in a device;

FIG. 8C schematically illustrates another embodiment of a wall in a device;

FIG. 8D schematically illustrates another embodiment of a wall in a device;

FIG. 8E schematically illustrates another embodiment of a wall in a device;

FIG. 8F schematically illustrates another embodiment of a wall in a device;

FIG. 9 illustrates a system comprising a vessel and an absorption chiller unit, according to an embodiment of this disclosure;

FIG. 10 schematically illustrates fluid flow directions in a heat exchange wall or a multi-fluid heat exchanger, according to embodiments of the disclosure;

FIG. 11A illustrates an integrated absorption chiller in an electrochemical reactor system, according to an embodiment of the disclosure;

FIG. 11B illustrates a cross-sectional view of the system, according to an embodiment of the disclosure;

FIG. 11C illustrates a cross-sectional view of the system, according to an embodiment of the disclosure; and

FIG. 11D illustrates a cross-sectional view of the integrated chiller, according to an embodiment of this disclosure.

### DETAILED DESCRIPTION

### Overview

Embodiments of methods, materials and processes described herein are directed towards electrochemical reactors. Electrochemical reactors include solid oxide fuel cells, solid oxide fuel cell stacks, electrochemical gas producers, electrochemical compressors, solid state batteries, or solid oxide flow batteries.

Absorption chillers use a lesser amount of power compared to compressor based chillers. Absorption chillers are a more efficient solution when residual heat is available instead of using mechanical energy to drive the cooling process. The disclosure herein describes a system integrating an electrochemical reactor with an absorption chiller. Heat from the electrochemical reactor can be used to drive the absorption chiller. Other components the system may include are a reformer and a heat exchanger. The systems described herein may be of unitary construction.

### Definitions

The following description recites various aspects and embodiments of the inventions disclosed herein. No particular embodiment is intended to define the scope of the invention. Rather, the embodiments provide non-limiting examples of various compositions and methods that are included within the scope of the claimed inventions. The description is to be read from the perspective of one of ordinary skill in the art. Therefore, information that is well-known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like. As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

As used herein, compositions and materials are used interchangeably unless otherwise specified. Each composition/material may have multiple elements, phases, and components. Heating as used herein refers to actively adding energy to the compositions or materials.

The term “in situ” in this disclosure refers to the treatment (e.g., heating) process being performed either at the same location or in the same device of the forming process of the compositions or materials. For example, the deposition process and the heating process are performed in the same device and at the same location, in other words, without changing the device and without changing the location within the device. For example, the deposition process and the heating process are performed in the same device at different locations, which is also considered in situ.

In this disclosure, a major face of an object is the face of the object that has a surface area larger than the average surface area of the object, wherein the average surface area of the object is the total surface area of the object divided by the number of faces of the object. In some cases, a major face refers to a face of an item or object that has a larger surface area than a minor face. In the case of planar fuel cells or non-SIS type fuel cells, a major face is the face or surface in the lateral direction.

As used herein, lateral refers to the direction that is perpendicular to the stacking direction of the layers in a non-SIS type fuel cell. Thus, lateral direction refers to the direction that is perpendicular to the stacking direction of the layers in a fuel cell or the stacking direction of the slices to form an object during deposition. Lateral also refers to the direction that is the spread of deposition process.

Syngas (i.e., synthesis gas) in this disclosure refers to a mixture consisting primarily of hydrogen, carbon monoxide and carbon dioxide.

In this disclosure, absorbance is a measure of the capacity of a substance to absorb electromagnetic radiation (EMR) of a wavelength.

Absorption of radiation refers to the energy absorbed by a substance when exposed to the radiation.

An interconnect in an electrochemical device (e.g., a fuel cell) is often either metallic or ceramic that is placed between the individual cells or repeat units. Its purpose is to connect each cell or repeat unit so that electricity can be distributed or combined. An interconnect is also referred to as a bipolar plate in an electrochemical device. An interconnect being an impermeable layer as used herein refers to it being a layer that is impermeable to fluid flow. For example, an impermeable layer has a permeability of less than 1 micro darcy, or less than 1 nano darcy.

In this disclosure, an interconnect having no fluid dispersing element refers to an interconnect having no elements (e.g., channels) to disperse a fluid. A fluid may comprise a gas or a liquid or a mixture of a gas and a liquid. Such fluids may include one or more of hydrogen, methane, ethane, propane, butane, oxygen, ambient air or light hydrocarbons (i.e., pentane, hexane, octane). Such an interconnect may have inlets and outlets (i.e., openings) for materials or fluids to pass through.

In this disclosure, the term “microchannels” is used interchangeably with microfluidic channels or microfluidic flow channels.

In this disclosure, sintering refers to a process to form a solid mass of material by heat or pressure, or a combination thereof, without melting the material to the extent of liquefaction. For example, material particles are coalesced into a solid or porous mass by being heated, wherein atoms in the material particles diffuse across the boundaries of the particles, causing the particles to fuse together and form one solid piece. In this disclosure and the appended claims, Tₛᵢₙₜₑᵣ refers to the temperature at which this phenomenon begins to take place.

As used herein, the term “pore former” is intended to have a relatively broad meaning. “Pore former” may be referring to any particulate material that is included in a composition during formation, which may partially or completely vacate a space by a process, such as heating, combustion or vaporizing. As used herein, the term “electrically conductive component” is intended to refer to components in a fuel cell, such as electrodes and interconnects, that are electrically conductive.

For illustrative purposes, the production of solid oxide fuel cells (SOFCs) will be used as an example system herein to describe the various embodiments. As one in the art recognizes though, the methodologies and the manufacturing processes described herein are applicable to any electrochemical device, reactor, vessel, catalyst, etc. Examples of electrochemical devices or electrochemical reactors includes electrochemical (EC) gas producer, electrochemical (EC) compressor, solid oxide fuel cells, solid oxide fuel cell stack, solid state battery, or solid oxide flow battery. Catalysts include Fischer Tropsch (FT) catalysts or reformer catalysts. Reactor/vessel includes FT reactor or heat exchanger.

### Integrated Deposition and Heating

Disclosed herein is a method comprising depositing a composition on a substrate slice by slice (this may also be described as line-by-line deposition) to form an object; heating in situ the object using electromagnetic radiation (EMR); wherein the composition comprises a first material and a second material, wherein the second material has a higher absorbance of EMR than the first material. In various embodiments, heating may cause an effect comprising drying, curing, sintering, annealing, sealing, alloying, evaporating, restructuring, foaming or combinations thereof. In some embodiments, the EMR has a peak wavelength ranging from 10 to 1500 nm and a minimum energy density of 0.1 Joule/cm² wherein the peak wavelength is on the basis of irradiance with respect to wavelength. The EMR may comprise one or more of UV light, near ultraviolet light, near infrared light, infrared light, visible light, laser or electron beam.

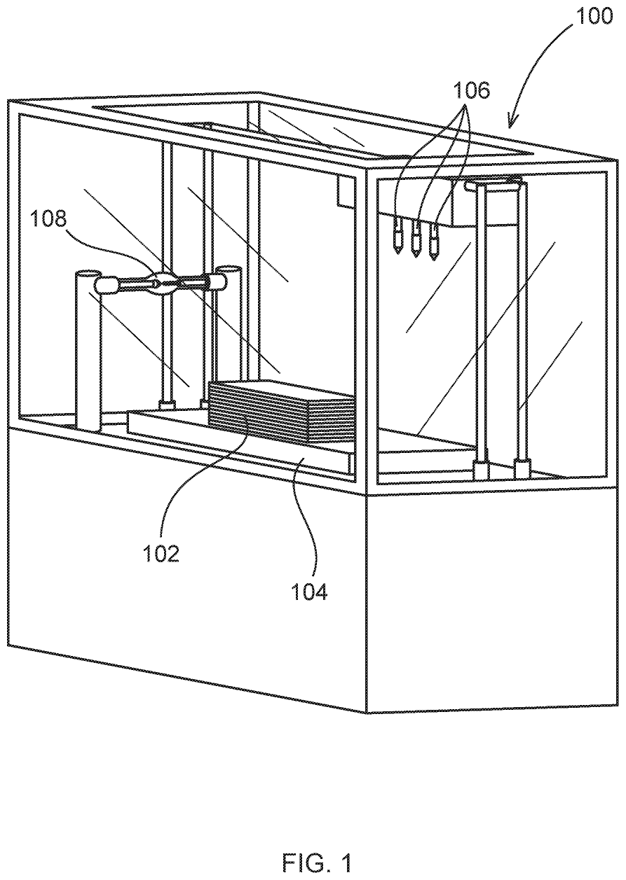

FIG. 1 illustrates a system for integrated deposition and heating using electromagnetic radiation (EMR), according to an embodiment of the disclosure. FIG. 1 further illustrates system 100 an object 102 on a receiver 104 formed by deposition nozzles 106 and EMR 108 for heating in situ, according to an embodiment of this disclosure. Receiver 104 may be a platform that moves and may further receive deposition, heat, irradiation, or combinations thereof. Receiver 104 may also be referred to as a chamber wherein the chamber may be completely enclosed, partially enclosed or completely open to the atmosphere.

In some embodiments, the first material comprises yttria-stabilized zirconia (YSZ), 8YSZ (8 mol % YSZ powder), yttrium, zirconium, gadolinia-doped ceria (GDC or CGO), samaria-doped ceria (SDC), scandia-stabilized zirconia (SSZ), lanthanum strontium manganite (LSM), lanthanum strontium cobalt ferrite (LSCF), lanthanum strontium cobaltite (LSC), lanthanum strontium gallium magnesium oxide (LSGM), nickel, NiO, NiO—YSZ, Cu—CGO, Cu₂O, CuO, cerium, copper, silver, crofer, steel, lanthanum chromite, doped lanthanum chromite, ferritic steel, stainless steel or combinations thereof. The first material may comprise YSZ, SSZ, CGO, SDC, NiO—YSZ, LSM-YSZ, CGO-LSCF, doped lanthanum chromite, stainless steel or combinations thereof. The second material may comprise carbon, nickel oxide, nickel, silver, copper, CGO, SDC, NiO—YSZ, NiO—SSZ, LSCF, LSM, doped lanthanum chromite ferritic steels or combinations thereof.

In some embodiments, object 102 comprises a catalyst, a catalyst support, a catalyst composite, an anode, a cathode, an electrolyte, an electrode, an interconnect, a seal, a fuel cell, an electrochemical gas producer, an electrolyser, an electrochemical compressor, a reactor, a heat exchanger, a vessel or combinations thereof.

In some embodiments, the second material may be deposited in the same slice as the first material. The second material may be deposited in a slice adjacent another slice that contains the first material. The heating may remove at least a portion of the second material. In preferred embodiments, the heating leaves minimal residue of the second material such that there is no significant residue that would interfere with the subsequent steps in the process or the operation of the device being constructed. More preferably, this leaves no measurable reside of the portion of the second material.

In some embodiments, the second material may add thermal energy to the first material during heating. The second material may have a radiation absorbance that is at least 5 times that of the first material; the second material has a radiation absorbance that is at least 10 times that of the first material; the second material has a radiation absorbance that is at least 50 times that of the first material or the second material has a radiation absorbance that is at least 100 times that of the first material.

In some embodiments, the second material may have a peak absorbance wavelength no less than 200 nm, or 250 nm, or 300 nm, or 400 nm, or 500 nm. The first material may have a peak absorbance wavelength no greater than 700 nm, or 600 nm, or 500 nm, or 400 nm, or 300 nm. The EMR may have a peak wavelength no less than 200 nm, or 250 nm, or 300 nm, or 400 nm, or 500 nm.

In some embodiments, the second material may comprise carbon, nickel oxide, nickel, silver, copper, CGO, NiO—YSZ, LSCF, LSM, ferritic steels, other metal oxides or combinations thereof. In some cases, the ferritic steel is Crofer 22 APU. The first material may comprise YSZ, CGO, NiO—YSZ, LSM-YSZ, other metal oxides or combinations thereof. The second material may comprise LSCF, LSM, carbon, nickel oxide, nickel, silver, copper, or steel. Carbon may comprise graphite, graphene, carbon nanoparticles, nano diamonds or combinations thereof.

In some embodiments, the deposition method comprises material jetting, binder jetting, inkjet printing, aerosol jetting, aerosol jet printing, vat photopolymerization, powder bed fusion, material extrusion, directed energy deposition, sheet lamination, ultrasonic inkjet printing or combinations thereof.

In some embodiments, the deposition method further comprises one or more of the steps of controlling distance from the EMR to the receiver, EMR energy density, EMR spectrum, EMR voltage, EMR exposure duration, EMR exposure area, EMR exposure volume, EMR burst frequency, EMR exposure repetition number. The object may not change location between the deposition and heating steps. EMR may have a power output of no less than 1 W, or 10 W, or 100 W, or 1000 W.

Also disclosed herein is a system comprising at least one deposition nozzle, an electromagnetic radiation (EMR) source and a deposition receiver, wherein the deposition receiver is configured to receive EMR exposure and deposition at the same location. In some cases, the receiver is configured such that it receives deposition for a first time period, moves to a different location in the system to receive EMR exposure for a second time period.

The following detailed description describes the production of solid oxide fuel cells (SOFCs) for illustrative purposes. As one in the art recognizes, the methodology and the manufacturing processes are applicable to all fuel cell types. As such, the production of all fuel cell types is within the scope of this disclosure.

### Additive Manufacturing

Additive manufacturing (AM) refers to a group of techniques that join materials to make objects, usually slice by slice or layer upon layer. AM is contrasted to subtractive manufacturing methodologies, which involve removing sections of a material by machining, cutting, grinding or etching away. AM may also be referred to as additive fabrication, additive processes, additive techniques, additive layer manufacturing, layer manufacturing or freeform fabrication. Some examples of AM are extrusion, photopolymerization, powder bed fusion, material jetting, binder jetting, directed energy deposition, lamination, direct metal laser sintering (DMLS), selective laser sintering (SLS), selective laser melting (SLM), directed energy deposition (DED), laser metal deposition (LMD), electron beam (EBAM) and metal binder jetting. A 3D printer is a type of AM machine (AMM). An inkjet printer or ultrasonic inkjet printer are additional examples of AMMs.

In a first aspect, the invention is a method of making a fuel cell comprising: (a) producing an anode using an AMM; (b) creating an electrolyte using the AMM; and (c) making a cathode using the AMM. In preferred embodiments, the anode, the electrolyte and the cathode are assembled into a fuel cell utilizing an AMM in addition to other steps that are not completed using an AMM. In a preferred embodiment, the fuel cell is formed using only the AMM. In other embodiments, steps (a), (b), and (c) exclude tape casting and screen printing. In an embodiment, the method of assembling a fuel cell with an AMM excludes compression in assembling. In other embodiments, the layers are deposited one on top of another in a step-wise manner such that assembling is accomplished at the same time as deposition. The methods described herein are useful in making planar fuel cells. The methods described herein are also useful in making fuel cell, wherein electrical current flow is perpendicular to the electrolyte in the lateral direction when the fuel cell is in use.

In an embodiment, the interconnect, the anode, the electrolyte, and the cathode are formed layer on layer, for example, printed layer on layer. It is important to note that, within the scope of the invention, the order of forming these layers can be varied. In other words, either the anode or the cathode can be formed before the other. Naturally, the electrolyte is formed so that it is between the anode and the cathode. Barrier layer(s), catalyst layer(s) and interconnect(s) are formed so as to lie in the appropriate position within the fuel cell to perform their functions.

In some embodiments, each of the interconnect, the anode, the electrolyte and the cathode have six faces. In preferred embodiments, the anode is printed on the interconnect and is in contact with the interconnect; the electrolyte is printed on the anode and is in contact with the anode; the cathode is printed on the electrolyte and is in contact with the electrolyte. Each print may be sintered, for example, using EMR. As such, the assembly process and the forming process are simultaneous, which is not possible with conventional methods. Moreover, with the preferred embodiment, the needed electrical contact and gas tightness are also achieved at the same time. In contrast, conventional fuel cell assembly processes accomplish this via pressing or compression of the fuel cell components or layers. The pressing and compression processes can cause cracks in the fuel cell layers that are undesirable.

In some embodiments, the AM method comprises making at least one barrier layer using the AMM. In preferred embodiments, the at least one barrier layer may be located between the electrolyte and the cathode or between the electrolyte and the anode or both. The at least one barrier layer may be assembled with the anode, the electrolyte and the cathode using the AMM. No barrier layer may be needed or utilized in the fuel cell.

In some embodiments, the AM method comprises making an interconnect using the AMM. The interconnect may be assembled with the anode, the electrolyte and the cathode using the AMM. In some embodiments, the AMM forms a catalyst and incorporates said catalyst into the fuel cell.

In some embodiments, the anode, the electrolyte, the cathode and the interconnect are made at a temperature above 100° C. The AM method may comprise heating the fuel cell, wherein said fuel cell comprises the anode, the electrolyte, the cathode, the interconnect and optionally at least one barrier layer. The fuel cell may comprise a catalyst. The method may comprise heating the fuel cell to a temperature above 500° C. The fuel cell may be heated using one or both of EMR or oven curing.

In a preferred embodiment, the AMM utilizes a multi-nozzle additive manufacturing method. In a preferred embodiment, the multi-nozzle additive manufacturing method comprises nanoparticle jetting. A first nozzle may deliver a first material, a second nozzle delivers a second material, a third nozzle delivers a third material. Particles of a fourth material may be placed in contact with a partially constructed fuel cell and bonded to the partially constructed fuel cell using a laser, photoelectric effect, light, heat, polymerization or binding. In an embodiment, the anode, the cathode or the electrolyte comprises a first, second, third or fourth material. In preferred embodiments, the AMM performs multiple AM techniques. In various embodiments, the AM techniques comprise one or more of extrusion, photopolymerization, powder bed fusion, material jetting, binder jetting, directed energy deposition or lamination. In various embodiments, AM is a deposition technique comprising material jetting, binder jetting, inkjet printing, aerosol jetting, or aerosol jet printing, vat photopolymerization, powder bed fusion, material extrusion, directed energy deposition, sheet lamination, ultrasonic inkjet printing or combinations thereof.

Further described herein is an AM method of making a fuel cell stack comprising: (a) producing an anode using an additive manufacturing machine (AMM); (b) creating an electrolyte using the AMM; (c) making a cathode using the AMM; (d) making an interconnect using the AMM; wherein the anode, the electrolyte, the cathode, and the interconnect form a first fuel cell; (e) repeating steps (a)-(d) to make a second fuel cell; and (f) assembling the first fuel cell and the second fuel cell into a fuel cell stack.

In some embodiments, the first fuel cell and the second fuel cell are formed from the anode, the electrolyte, the cathode and the interconnect utilizing the AMM. The fuel cell stack may be formed using only the AMM. Steps (a)-(f) may exclude one or both of tape casting and screen printing.

In some embodiments, the AM method comprises making at least one barrier layer using the AMM. The at least one barrier layer may be located between the electrolyte and the cathode or between the electrolyte and the anode or both for the first fuel cell and the second fuel cell.

In some embodiments, steps (a)-(d) are performed at a temperature above 100° C. In other embodiments, steps (a)-(d) are performed at a temperature in the range of 100° C. to 500° C. The AMM may make a catalyst and incorporates the catalyst into the fuel cell stack.

In some embodiments, the AM method comprises heating the fuel cell stack. The AM method may comprise heating the fuel cell stack to a temperature above 500° C. The fuel cell stack may be heated using EMR and/or oven curing. The laser may have a laser beam, wherein the laser beam is expanded to create a heating zone with uniform power density. The laser beam may be expanded by utilizing one or more mirrors. Each layer of the fuel cell may be cured separately by EMR. A combination of one or more fuel cell layers may be cured together by EMR. The first fuel cell may be EMR cured, assembled with the second fuel cell, and then the second fuel cell is EMR cured. The first fuel cell may be assembled with the second fuel cell, and then the first fuel cell and the second fuel cell are cured separately by EMR. The first fuel cell and the second fuel cell may be cured separately by EMR, and then the first fuel cell is assembled with the second fuel cell to form a fuel cell stack. The first fuel cell is assembled with the second fuel cell to form a fuel cell stack, and then the fuel cell stack may be cured by EMR.

Also discussed herein is an AM method of making a multiplicity of fuel cells comprising (a) producing a multiplicity of anodes simultaneously using an additive manufacturing machine (AMM); (b) creating a multiplicity of electrolytes using the AMM simultaneously; and (c) making a multiplicity of cathodes using the AMM simultaneously. In preferred embodiments, the anodes, the electrolytes and cathodes are assembled into fuel cells utilizing the AMM simultaneously. In other preferred embodiments, the fuel cells are formed using only the AMM.

In some embodiments, the method comprises making at least one barrier layer using the AMM for each of the multiplicity of fuel cells simultaneously. The at least one barrier layer may be located between the electrolyte and the cathode or located between the electrolyte and the anode, or both. In preferred embodiments, the at least one barrier layer may be assembled with the anode, the electrolyte and the cathode using the AMM for each fuel cell.

In some embodiments, the method comprises making an interconnect using the AMM for each of the multiplicity of fuel cells simultaneously. The interconnect may be assembled with the anode, the electrolyte and the cathode using the AMM for each fuel cell. The AMM may form a catalyst for each of the multiplicity of fuel cells simultaneously and incorporates said catalyst into each of the fuel cells. Heating each layer or heating a combination of layers of the multiplicity of fuel cells takes place simultaneously. The multiplicity of fuel cells may include two or more fuel cells.

In preferred embodiments, the AMM uses two or more different nozzles to jet or print different materials at the same time. For a first example, in an AMM, a first nozzle deposits an anode layer for fuel cell 1, a second nozzle deposits a cathode layer for fuel cell 2 and a third nozzle deposits an electrolyte for fuel cell 3, at the same time. For a second example, in an AMM, a first nozzle deposits an anode for fuel cell 1, a second nozzle deposits a cathode for fuel cell 2, a third nozzle deposits an electrolyte for fuel cell 3 and a fourth nozzle deposits an interconnect for fuel cell 4, at the same time.

Disclosed herein is an additive manufacturing machine (AMM) comprising a chamber wherein manufacturing of fuel cells takes place. The chamber is able to withstand temperatures of at least 100° C. The chamber may enable production of the fuel cells. The chamber enables heating of the fuel cells in situ as the components of the fuel cell are being deposited.

In some embodiments, the chamber may be heated by laser, electromagnetic waves/electromagnetic radiation (EMR), hot fluid or a heating element associated with the chamber, or combinations thereof. The heating element may comprise a heated surface, heating coil or a heating rod. In other embodiments, said chamber may be configured to apply pressure to the fuel cells inside. The pressure may be applied via a moving element associated with the chamber. The moving element may be a moving stamp or plunger. In some embodiments, said chamber may be configured to withstand pressure. the chamber may be configured to be pressurized or depressurized by a fluid. The fluid in the chamber may be changed or replaced when needed.

In some cases, the chamber may be enclosed. In some cases, the chamber may be sealed. In some cases, the chamber may be open to ambient atmosphere or to a controlled atmosphere. In some cases, the chamber may be a platform without top and side walls.

Referring to FIG. 1, system 100 comprises deposition nozzles or material jetting nozzles 106, EMR source 108 (e.g., xenon lamp), object being formed 102, and chamber or receiver 104 as a part of an AMM. As illustrated in FIG. 1, the chamber or receiver 104 is configured to receive both deposition from nozzles and radiation from EMR source 108. In various embodiments, deposition nozzles 106 may be movable. The chamber or receiver 104 may be movable. The EMR source 108 may be movable. In various embodiments, the object comprises a catalyst, a catalyst support, a catalyst composite, an anode, a cathode, an electrolyte, an electrode, an interconnect, a seal, a fuel cell, an electrochemical gas producer, an electrolyser, an electrochemical compressor, a reactor, a heat exchanger, a vessel or combinations thereof.

AM techniques suitable for this disclosure comprise extrusion, photopolymerization, powder bed fusion, material jetting, binder jetting, directed energy deposition and lamination. In some embodiments, extrusion may be used for AM. Extrusion AM involves the spatially controlled deposition of material (e.g., thermoplastics). Extrusion AM may also be referred to as fused filament fabrication (FFF) or fused deposition modeling (FDM) in this disclosure.

In some embodiments, AM comprises photopolymerization (i.e., stereolithography (SLA)) for the process of this disclosure. SLA involves spatially-defined curing of a photoactive liquid (a “photoresin”), using a scanning laser or a high-resolution projected image, and transforming the photoactive liquid into a crosslinked solid. Photopolymerization can produces parts with details and dimensions ranging from the micrometer- to meter-scales.

In some embodiments, AM comprises powder bed fusion (PBF). PBF AM processes build objects by melting powdered feedstock, such as a polymer or metal. PBF processes begin by spreading a thin layer of powder across a build area. Cross-sections are then melted a layer at a time, most often using a laser, electron beam or intense infrared lamps. PBF of metals may use selective laser melting (SLM) or electron beam melting (EBM). PBF of polymers may use selective laser sintering (SLS). SLS systems may print thermoplastic polymer materials, polymer composites or ceramics. SLM systems may be suitable for a variety of pure metals and alloys, wherein the alloys are compatible with rapid solidification that occurs in SLM.

In some embodiments, AM may comprise material jetting. AM by material jetting may be accomplished by depositing small drops (or droplets) of material with spatial control. In various embodiments, material jetting is performed three dimensionally (3D), two dimensionally (2D) or both. 3D jetting may be accomplished layer by layer. In preferred embodiments, print preparation converts the computer-aided design (CAD), along with specifications of material composition, color, and other variables to the printing instructions for each layer. Binder jetting AM involves inkjet deposition of a liquid binder onto a powder bed. In some cases, binder jetting is combined with other AM processes, such as for example, spreading of powder to make the powder bed (analogous to SLS/SLM) and inkjet printing.

In some embodiments, AM comprises directed energy deposition (DED). Instead of using a powder bed as discussed above, the DED process uses a directed flow of powder or a wire feed, along with an energy intensive source such as laser, electric arc or electron beam. In preferred embodiments, DED is a direct-write process, wherein the location of material deposition is determined by movement of the deposition head which allows large metal structures to be built without the constraints of a powder bed.

In some embodiments, AM comprises lamination AM or laminated object manufacturing (LOM). In preferred embodiments, consecutive layers of sheet material are consecutively bonded and cut in order to form a 3D structure.

Traditional methods of manufacturing a fuel cell stack can comprise over 100 steps. These steps may include, but not limited to, milling, grinding, filtering, analyzing, mixing, binding, evaporating, aging, drying, extruding, spreading, tape casting, screen printing, stacking, heating, pressing, sintering and compressing. The methods disclosed herein describe manufacturing of a fuel cell or fuel cell stack using one AMM.

The AMM of this disclosure preferably performs both extrusion and ink jetting to manufacture a fuel cell or fuel cell stack. Extrusion may be used to manufacture thicker layers of a fuel cell, such as, the anode and/or the cathode. Ink jetting may be used to manufacture thin layers of a fuel cell. Ink jetting may be used to manufacture the electrolyte. The AMM may operate at temperature ranges sufficient to enable curing in the AMM itself. Such temperature ranges are 100° C. or above, 100-300° C. or 100-500° C.

As a preferred example, all layers of a fuel cell are formed and assembled via printing. The material for making the anode, cathode, electrolyte and the interconnect, respectively, may be made into an ink form comprising a solvent and particles (e.g., nanoparticles). There are two categories of ink formulations—aqueous inks and non-aqueous inks. In some cases, the aqueous ink comprises an aqueous solvent (e.g., water, deionized water), particles, dispersant and a surfactant. In some cases, the aqueous ink comprises an aqueous solvent, particles, dispersant, surfactant but no polymeric binder. The aqueous ink may optionally comprise a co-solvent, such as an organic miscible solvent (methanol, ethanol, isopropyl alcohol). Such co-solvents preferably have a lower boiling point than water. The dispersant may be an electrostatic dispersant, steric dispersant, ionic dispersant, or a non-ionic dispersant, or a combination thereof. The surfactant may preferably be non-ionic, such as an alcohol alkoxylate or an alcohol ethoxylate. The non-aqueous ink may comprise an organic solvent (e.g., methanol, ethanol, isopropyl alcohol, butanol) and particles.

For example, CGO powder is mixed with water to form an aqueous ink further comprising a dispersant and a surfactant but with no polymeric binder added. The CGO fraction based on mass (herein expressed as weight % (wt %)) is in the range of 10 wt % to 25 wt %. For example, CGO powder is mixed with ethanol to form a non-aqueous ink further comprising polyvinyl butaryl added with the CGO fraction in the range of 3 wt % to 30 wt %. For example, LSCF is mixed with n-butanol or ethanol to form a non-aqueous ink further comprising polyvinyl butaryl with the LSCF fraction in the range of 10 wt % to 40 wt %. For example, YSZ particles are mixed with water to form an aqueous ink further comprising a dispersant and surfactant but with no polymeric binder added. The YSZ fraction is in the range of 3 wt % to 40 wt %. For example, NiO particles are mixed with water to form an aqueous ink further comprising a dispersant and surfactant but with no polymeric binder added with the NiO fraction in the range of 5 wt % to 25 wt %.

As an example, for the cathode of a fuel cell, LSCF or LSM particles are dissolved in a solvent, wherein the solvent is water or an alcohol (e.g., butanol) or a mixture of alcohols. Organic solvents other than alcohols may also be used in other examples. As an example, LSCF is deposited (e.g., printed) into a layer. A xenon lamp may be used to irradiate the LSCF layer with EMR to sinter the LSCF particles. The xenon flash lamp may be a 10 kW unit applied at a voltage of 400V and a frequency of 10 Hz for a total exposure duration of 1000 ms.

For example, for the electrolyte, YSZ particles are mixed with a solvent, wherein the solvent is water (e.g., de-ionized water) or an alcohol (e.g., butanol) or a mixture of alcohols. Organic solvents other than alcohols may also be used in other examples. For the interconnect, metallic particles (e.g., silver nanoparticles) are dissolved in a solvent, wherein the solvent may comprise water (e.g., de-ionized water) and an organic solvent. The organic solvent may comprise mono-, di-, or tri-ethylene glycols or higher ethylene glycols, propylene glycol, 1,4-butanediol or ethers of such glycols, thiodiglycol, glycerol and ethers and esters thereof, polyglycerol, mono-, di-, and tri-ethanolamine, propanolamine, N,N-dimethylformamide, dimethyl sulfoxide, dimethylacetamide, N-methylpyrrolidone, 1,3-dimethylimidazolidone, methanol, ethanol, isopropanol, n-propanol, diacetone alcohol, acetone, methyl ethyl ketone or propylene carbonate, or combinations thereof. For a barrier layer in a fuel cell, CGO particles are dissolved in a solvent, wherein the solvent may be water (e.g., de-ionized water) or an alcohol. The alcohol may comprise methanol, ethanol, butanol or a mixture of alcohols. Organic solvents other than alcohols may also be used. CGO may be used as barrier layer for LSCF. YSZ may also be used as a barrier layer for LSM. In some cases, for the aqueous inks where water is the solvent, no polymeric binder may be added to the aqueous inks.

The manufacturing process of a conventional fuel cell sometimes comprises more than 100 steps and utilizing dozens of machines. According to an embodiment of this disclosure, a method of making a fuel cell comprises using only one AMM to manufacture a fuel cell, wherein the fuel cell comprises an anode, electrolyte and a cathode. In preferred embodiments, the fuel cell comprises at least one barrier layer, for example, between the electrolyte and the cathode, or between the electrolyte and the cathode, or both. The at least one barrier layer is preferably also made by the same AMM. In preferred embodiments, the AMM may also produce an interconnect and assembles the interconnect with the anode, cathode, at least one barrier layer and the electrolyte. Such manufacturing methods and systems are applicable not only to making fuel cells but also for making other types of electrochemical devices. The following discussion uses fuel cells as an example, but any reactor or catalyst is within the scope of this disclosure.

In various embodiments, a single AMM makes a first fuel cell, wherein the fuel cell comprises an anode, electrolyte, cathode, at least one barrier layer and an interconnect. In various embodiments, a single AMM makes a second fuel cell. In various embodiments, a single AMM is used to assemble a first fuel cell with a second fuel cell to form a fuel cell stack. In various embodiments, the production of fuel cells using an AMM is repeated as many times as desired. A fuel cell stack comprising two or more fuel cells is thus assembled using an AMM. In some embodiments, the various layers of the fuel cell are produced by an AMM above ambient temperature. For example, the temperatures may be above 100° C., in the range of 100° C. to 500° C. or in the range of 100° C. to 300° C. In various embodiments, a fuel cell or fuel cell stack is heated after it is assembled. In some embodiments, the fuel cell or fuel cell stack is heated at a temperature above 500° C. In preferred embodiments, the fuel cell or fuel cell stack is heated at a temperature in the range of 500° C. to 1500° C.

In various embodiments, an AMM comprises a chamber where the manufacturing of fuel cells takes place. This chamber may be able to withstand high temperature to enable the production of the fuel cells wherein the high temperature is at least 300° C., at least 500° C., at least 1000° C. or at least 1500° C. In some cases, this chamber may also enable the heating of the fuel cells to take place in the chamber. Various heating methods may be applied, such as laser heating/curing, electromagnetic wave heating, hot fluid heating or one or more heating elements associated with the chamber. The heating element may be a heating surface, heating coil or a heating rod and is associated with the chamber such that the content in the chamber is heated to the desired temperature range. In various embodiments, the chamber of the AMM may also be able to apply pressure to the fuel cell(s) inside. For example, a pressure may be applied via a moving element, such as a moving stamp or plunger. In various embodiments, the chamber of the AMM is able to withstand pressure. The chamber can be pressurized or depressurized as desired by a fluid. The fluid in the chamber can also be changed or replaced as needed.

In preferred embodiments, a fuel cell or fuel cell stack is heated using EMR. In other embodiments, the fuel cell or fuel cell stack may be heated using oven curing. In other embodiments, the laser beam may be expanded (for example, by the use of one or more mirrors) to create a heating zone with uniform power density. In a preferred embodiment, each layer of the fuel cell may be cured by EMR separately. In preferred embodiments, a combination of fuel cell layers may be EMR cured separately, for example, a combination of the anode, the electrolyte, and the cathode layers. In some embodiments, a first fuel cell is EMR cured, assembled with a second fuel cell, and then the second fuel cell is EMR cured. In an embodiment, a first fuel cell is assembled with a second fuel cell, and then the first fuel cell and the second fuel cell are EMR cured separately. In an embodiment, a first fuel cell is assembled with a second fuel cell to form a fuel cell stack, and then the fuel cell stack is EMR cured. A fuel cell stack comprising two or more fuel cells may be EMR cured. The sequence of laser heating/curing and assembling is applicable to all other heating methods.

In preferred embodiments, an AMM produces each layer of a multiplicity of fuel cells simultaneously. In preferred embodiments, the AMM assembles each layer of a multiplicity of fuel cells simultaneously. In preferred embodiments, heating each layer or heating a combination of layers of a multiplicity of fuel cells takes place simultaneously. All the discussion and all the features described herein for a fuel cell or a fuel cell stack are applicable to the production, assembling and heating of the multiplicity of fuel cells. In preferred embodiments, a multiplicity of fuel cells may be 2 or more 20 or more, 50 or more, 80 or more, 100 or more, 500 or more, 800 or more, 1000 or more, 5000 or more or 10,000 or more.

### Treatment Process

Herein disclosed is a treatment process that comprises one or more of the following effects: heating, drying, curing, sintering, annealing, sealing, alloying, evaporating, restructuring, foaming or sintering. A preferred treatment process is sintering. The treatment process comprises exposing a substrate to a source of electromagnetic radiation (EMR). In some embodiments, EMR is exposed to a substrate having a first material. In various embodiments, the EMR has a peak wavelength ranging from 10 to 1500 nm. In various embodiments, the EMR has a minimum energy density of 0.1 Joule/cm². In an embodiment, the EMR has a burst frequency of 10⁻⁴-1000 Hz or 1-1000 Hz or 10-1000 Hz. In an embodiment, the EMR has an exposure distance of no greater than 50 mm. In an embodiment, the EMR has an exposure duration no less than 0.1 ms or 1 ms. In an embodiment, the EMR is applied with a capacitor voltage of no less than 100V. For example, a single pulse of EMR is applied with an exposure distance of about 10 mm and an exposure duration of 5-20 ms. For example, multiple pulses of EMR are applied at a burst frequency of 100 Hz with an exposure distance of about 10 mm and an exposure duration of 5-20 ms. In some embodiments, the EMR consists of one exposure. In other embodiment, the EMR comprises no greater than 10 exposures, or no greater than 100 exposures, or no greater than 1000 exposures, or no greater than 10,000 exposures.

In various embodiments, metals and ceramics are sintered almost instantaneously (milliseconds for <<10 microns) using pulsed light. The sintering temperature may be controlled to be in the range of 100° C. to 2000° C. The sintering temperature may be tailored as a function of depth. In one example, the surface temperature is 1000° C. and the sub-surface is kept at 100° C., wherein the sub-surface is 100 microns below the surface. In some embodiments, the material suitable for this treatment process includes yttria-stabilized zirconia (YSZ), 8YSZ (8 mol % YSZ powder), yttrium, zirconium, gadolinia-doped ceria (GDC or CGO), samaria-doped ceria (SDC), scandia-stabilized zirconia (SSZ), lanthanum strontium manganite (LSM), lanthanum strontium cobalt ferrite (LSCF), lanthanum strontium cobaltite (LSC), lanthanum strontium gallium magnesium oxide (LSGM), nickel, NiO, NiO—YSZ, Cu—CGO, Cu₂O, CuO, cerium, copper, silver, crofer, steel, lanthanum chromite, doped lanthanum chromite, ferritic steel, stainless steel, or combinations thereof.

This treatment process is applicable in the manufacturing process of a fuel cell. In preferred embodiments, a layer in a fuel cell (i.e., anode, cathode, electrolyte, seal, catalyst, etc) is treated using processes described herein to be heated, cured, sintered, sealed, alloyed, foamed, evaporated, restructured, dried or annealed or combinations thereof. In preferred embodiments, a portion of a layer in a fuel cell is treated using processes described herein to be heated, cured, sintered, sealed, alloyed, foamed, evaporated, restructured, dried, annealed, or combinations thereof. In preferred embodiments, a combination of layers of a fuel cell are treated using processes described herein to be heated, cured, sintered, sealed, alloyed, foamed, evaporated, restructured, dried, annealed or combinations thereof, wherein the layers may be a complete layer or a partial layer.

The treatment process of this disclosure is preferably rapid, with the treatment duration varied from microseconds to milliseconds. The treatment duration may be accurately controlled. The treatment process of this disclosure may produce fuel cell layers that have no cracks or have minimal cracking. The treatment process of this disclosure controls the power density or energy density in the treatment volume (the volume of an object being treated) of the material being treated. The treatment volume may be accurately controlled. In an embodiment, the treatment process of this disclosure provides the same energy density or different energy densities in a treatment volume. In an embodiment, the treatment process of this disclosure provides the same treatment duration or different treatment durations in a treatment volume. In an embodiment, the treatment process of this disclosure provides simultaneous treatment for one or more treatment volumes. In an embodiment, the treatment process of this disclosure provides simultaneous treatment for one or more fuel cell layers or partial layers or combination of layers. In an embodiment, the treatment volume is varied by changing the treatment depth.

In an embodiment, a first portion of a treatment volume is treated by electromagnetic radiation of a first wavelength; a second portion of the treatment volume is treated by electromagnetic radiation of a second wavelength. In some cases, the first wavelength is the same as the second wavelength. In some cases, the first wavelength is different from the second wavelength. In an embodiment, the first portion of a treatment volume has a different energy density from the second portion of the treatment volume. In an embodiment, the first portion of a treatment volume has a different treatment duration from the second portion of the treatment volume.

In an embodiment, the EMR has a broad emission spectrum so that the desired effects are achieved for a wide range of materials having different absorption characteristics. In this disclosure, absorption of electromagnetic radiation (EMR) refers to the process, wherein the energy of a photon is taken up by matter, such as the electrons of an atom. Thus, the electromagnetic energy is transformed into internal energy of the absorber, for example, thermal energy. For example, the EMR spectrum extends from the deep ultraviolet (UV) range to the near infrared (IR) range, with peak pulse powers at 220 nm wavelength. The power of such EMR is on the order of Megawatts. Such EMR sources perform tasks such as breaking chemical bonds, sintering, ablating or sterilizing.

In an embodiment, the EMR has an energy density of no less than 0.1, 1, or 10 Joule/cm². In an embodiment, the EMR has a power output of no less than 1 watt (W), 10 W, 100 W, 1000 W. The EMR delivers power to the substrate of no less than 1 W, 10 W, 100 W, 1000 W. In an embodiment, such EMR exposure heats the material in the substrate. In an embodiment, the EMR has a range or a spectrum of different wavelengths. In various embodiments, the treated substrate is at least a portion of an anode, cathode, electrolyte, catalyst, barrier layer, or interconnect of a fuel cell.

In an embodiment, the peak wavelength of the EMR is between 50 and 550 nm or between 100 and 300 nm. In an embodiment, the absorption of at least a portion of the substrate for at least one frequency of the EMR between 10 and 1500 nm is no less than 30% or no less than 50%. In an embodiment, the absorption of at least a portion of the substrate for at least one frequency between 50 and 550 nm is no less than 30% or no less than 50%. In an embodiment, the absorption of at least a portion of the substrate for at least one frequency between 100 and 300 nm is no less than 30% or no less than 50%.

Sintering is the process of compacting and forming a solid mass of material by heat or pressure without melting it to the point of liquefaction. In this disclosure, the substrate under EMR exposure is sintered but not melted. In preferred embodiments, the EMR comprises one or more of UV light, near ultraviolet light, near infrared light, infrared light, visible light, laser, electron beam, microwave. In an embodiment, the substrate is exposed to the EMR for no less than 1 microsecond, no less than 1 millisecond. In an embodiment, the substrate is exposed to the EMR for less than 1 second at a time or less than 10 seconds at a time. In an embodiment, the substrate is exposed to the EMR for less than 1 second or less than 10 seconds. In an embodiment, the substrate is exposed to the EMR repeatedly, for example, more than 1 time, more than 3 times, more than 10 times. In an embodiment, the substrate is distanced from the source of the EMR for less than 50 cm, less than 10 cm, less than 1 cm, or less than 1 mm.

In some embodiments, after EMR exposure a second material is added to or placed on to the first material. In various cases, the second material is the same as the first material. The second material may be exposed to EMR. In some cases, a third material may be added. The third material is exposed to EMR.

In some embodiments, the first material comprises YSZ, 8YSZ, yttrium, zirconium, GDC, SDC, LSM, LSCF, LSC, nickel, NiO or cerium or a combination thereof. The second material may comprise graphite. In some embodiments, the electrolyte, anode, or cathode comprises a second material. In some cases, the volume fraction of the second material in the electrolyte, anode, or cathode is less than 20%, 10%, 3%, or 1%. The absorption rate of the second material for at least one frequency (e.g., between 10 and 1500 nm or between 100 and 300 nm or between 50 and 550 nm) is greater than 30% or greater than 50%.

In various embodiments, one or a combination of parameters may be controlled, wherein such parameters include distance between the EMR source and the substrate, the energy density of the EMR, the spectrum of the EMR, the voltage of the EMR, the duration of exposure, the burst frequency and the number of EMR exposures. Preferably, these parameters are controlled to minimize the formation of cracks in the substrate.

In an embodiment, the EMR energy is delivered to a surface area of no less than 1 mm², or no less than 1 cm^{z}, or no less than 10 cm², or no less than 100 cm². In some cases, during EMR exposure of the first material, at least a portion of an adjacent material is heated at least in part by conduction of heat from the first material. In various embodiments, the layers of the fuel cell (e.g., anode, cathode, electrolyte) are thin. Preferably they are no greater than 30 microns, no greater than 10 microns, or no greater than 1 micron.

In some embodiments, the first material of the substrate is in the form of a powder, sol gel, colloidal suspension, hybrid solution or sintered material. In various embodiments, the second material may be added by vapor deposition. In preferred embodiments, the second material coats the first material. In preferred embodiments, the second material reacts with light, (e.g. focused light), as by a laser, and sintered or annealed with the first material.

### Advantages

The preferred treatment process of this disclosure enables rapid manufacturing of fuel cells by eliminating traditional, costly, time consuming, expensive sintering processes and replacing them with rapid, in situ methods that allow continuous manufacturing of the layers of a fuel cell in a single machine if desired. This process also shortens sintering time from hours and days to seconds or milliseconds or even microseconds.

In various embodiments, this treatment method is used in combination with manufacturing techniques like screen printing, tape casting, spraying, sputtering, physical vapor deposition and additive manufacturing.

This preferred treatment method enables tailored and controlled heating by tuning EMR characteristics (such as, wavelengths, energy density, burst frequency, and exposure duration) combined with controlling thicknesses of the layers of the substrate and heat conduction into adjacent layers to allow each layer to sinter, anneal, or cure at each desired target temperature. This process enables more uniform energy applications, decreases or eliminates cracking, which improves electrolyte performance. The substrate treated with this preferred process also has less thermal stress due to more uniform heating.

### Fuel Cell

A fuel cell is an electrochemical apparatus that converts the chemical energy from a fuel into electricity through an electrochemical reaction. As mentioned above, there are many types of fuel cells, e.g., proton-exchange membrane fuel cells (PEMFCs), solid oxide fuel cells (SOFCs). A fuel cell typically comprises an anode, a cathode, an electrolyte, an interconnect, optionally a barrier layer and/or optionally a catalyst. Both the anode and the cathode are electrodes. The listings of material for the electrodes, the electrolyte, and the interconnect in a fuel cell are applicable in some cases to the EC gas producer and the EC compressor. These listings are only examples and not limiting. Furthermore, the designations of anode material and cathode material are also not limiting because the function of the material during operation (e.g., whether it is oxidizing or reducing) determines whether the material is used as an anode or a cathode.

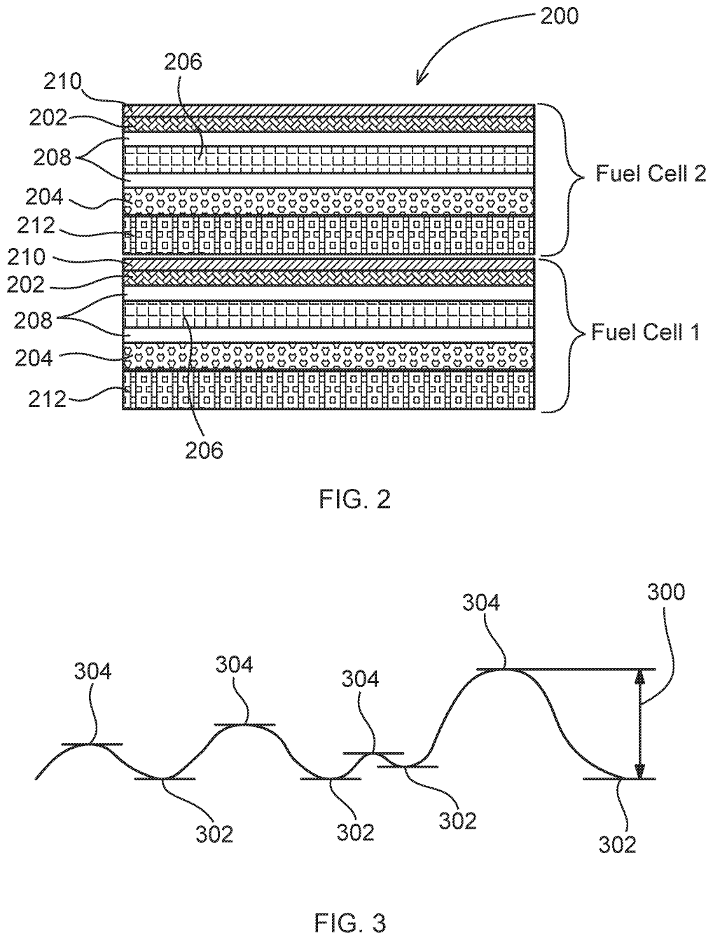

FIG. 2 schematically illustrates two fuel cells in a fuel cell stack 200. The two fuel cells are denoted “Fuel Cell 1” and “Fuel Cell 2”. Stack 200 may comprise two or more fuel cells though only two are shown for illustrative purposes. Each fuel cell in FIG. 2 comprises an anode layer 202, cathode layer 204, electrolyte layer 206, barrier layers 208, catalyst layer 210 and interconnect layer 212. Two fuel cell repeat units or two fuel cells form a stack 200 as illustrated. As is seen, on one side interconnect 212 is in contact with the largest surface of cathode 204 of fuel cell 2 (or fuel cell repeat unit) and on the opposite side interconnect 212 is in contact with the largest surface of catalyst 210 (optional) or the anode 202 of bottom fuel cell 2 (or fuel cell repeat unit). These repeat units or fuel cells are connected in parallel by being stacked atop one another and sharing an interconnect 212 in between via direct contact with the interconnect 212 rather than via electrical wiring. This kind of configuration illustrated in FIG. 2 contrasts with segmented-in-series (SIS) type fuel cells.

The cathode layer 204 may comprise perovskites, such as LSC, LSCF or LSM. In some embodiments, the cathode 204 comprises one or more of lanthanum, cobalt, strontium or manganite. The cathode 204 may be porous. The cathode 204 may comprise one or more of YSZ, nitrogen, nitrogen boron doped graphene, La_{0.6}Sr_{0.4}Co_{0.2}Fe_{0.8}O₃, SrCo_{0.5}Sc_{0.5}O₃, BaFe_{0.75}Ta_{0.25}O₃, BaFe_{0.875}Re_{0.125}O₃, Ba_{0.5}La_{0.125}Zn_{0.375}NiO₃, Ba_{0.75}Sr_{0.25}Fe_{0.875}Ga_{0.125}O₃, BaFe_{0.125}Co_{0.125}, Zr_{0.75}O₃. The cathode 204 may comprise LSCo, LCo, LSF, LSCoF, or a combination thereof. The cathode 204 may comprise perovskites LaCoO₃, LaFeO₃, LaMnO₃, (La,Sr)MnO₃, LSM-GDC, LSCF-GDC, LSC-GDC. Cathodes containing LSCF are suitable for intermediate-temperature fuel cell operation. The cathode 204 may comprise a material selected from the group consisting of lanthanum strontium manganite, lanthanum strontium ferrite, and lanthanum strontium cobalt ferrite. In preferred embodiments, the cathode comprises lanthanum strontium manganite.

The anode 202 may comprise copper, nickel-oxide, nickel-oxide-YSZ, NiO-GDC, NiO-SDC, aluminum doped zinc oxide, molybdenum oxide, lanthanum, strontium, chromite, ceria, perovskites (such as, LSCF [La{1-x}Sr{x}Co{1-y}Fe{y}O₃] or LSM [La{1-x}Sr{x}MnO₃], where x is usually in the range of 0.15-0.2 and y is in the range of 0.7 to 0.8). The anode 202 may comprise SDC or BZCYYb coating or barrier layer to reduce coking and sulfur poisoning. The anode 202 may be porous. The anode 202 may comprise a combination of electrolyte material and electrochemically active material or a combination of electrolyte material and electrically conductive material. In a preferred embodiment, the anode 202 comprises nickel and yttria stabilized zirconia. In a preferred embodiment, the anode 202 is formed by reduction of a material comprising nickel oxide and yttria stabilized zirconia. In a preferred embodiment, the anode 202 comprises nickel and gadolinium stabilized ceria. In a preferred embodiment, the anode 202 is formed by reduction of a material comprising nickel oxide and gadolinium stabilized ceria.

In some embodiments, the electrolyte 206 may comprise stabilized zirconia (e.g., YSZ, YSZ-8, Y_{0.16}Zr_{0.84}O₂), doped LaGaO3, (e.g., LSGM, La_{0.9}Sr_{0.1}Ga_{0.8}Mg0.2O₃), doped ceria, (e.g., GDC, Gd_{0.2}Ce_{0.8}O₂) or stabilized bismuth oxide (e.g., BVCO, Bi2V_{0.9}Cu_{0.1}O_{5.35}). he electrolyte 206 may comprise zirconium oxide, yttria stabilized zirconium oxide (also known as YSZ, YSZ8 (8 mole % YSZ)), ceria, gadolinia, scandia, magnesia or calcia or a combination thereof. The electrolyte 206 may be sufficiently impermeable to prevent significant gas transport and prevent significant electrical conduction; and allow ion conductivity. The electrolyte 206 may comprise doped oxide such as cerium oxide, yttrium oxide, bismuth oxide, lead oxide, lanthanum oxide. The electrolyte 206 may comprise perovskite, such as, LaCoFeO₃ or LaCoO₃ or Ce_{0.9}Gd_{0.1}O₂(GDC) or Ce_{0.9}Sm_{0.1}O₂ (SDC, samaria doped ceria) or scandia stabilized zirconia or a combination thereof. he electrolyte 206 may comprise a material selected from the group consisting of zirconia, ceria, and gallia. The material may be stabilized with a stabilizing material selected from the group consisting of scandium, samarium, gadolinium, and yttrium. The material may comprise yttria stabilized zirconia.

In some embodiments, interconnect 212 comprises silver, gold, platinum, AISI441, ferritic stainless steel, stainless steel, lanthanum, chromium, chromium oxide, chromite, cobalt, cesium, Cr₂O₃, or a combination thereof. In some embodiments, anode 202 comprises a LaCrO₃ coating on Cr₂O₃ or NiCo₂O₄ or MnCo₂O₄ coatings. The interconnect 212 surface may be coated with cobalt or cesium or both. The interconnect 212 may comprise ceramics. The interconnect 212 may comprise lanthanum chromite or doped lanthanum chromite. The interconnect 212 may comprise a material further comprising metal, stainless steel, ferritic steel, crofer, lanthanum chromite, silver, metal alloys, nickel, nickel oxide, ceramics, or lanthanum calcium chromite, or a combination thereof.

In various embodiments, one or more fuel cells in stack 200 may comprise a catalyst 210, such as, platinum, palladium, scandium, chromium, cobalt, cesium, CeO₂, nickel, nickel oxide, zine, copper, titania, ruthenium, rhodium, MoS₂, molybdenum, rhenium, vanadium, manganese, magnesium or iron or a combination thereof. The catalyst 210 may promote methane reforming reactions to generate hydrogen and carbon monoxide such that they may be oxidized in the fuel cell. Very often, the catalyst is part of the anode 202, especially nickel anode which has inherent methane reforming properties. The catalyst 210 may be between 1%-5%, or 0.1% to 10% by mass. The catalyst 210 may be used on the anode 202 surface or in the anode 202. In various embodiments, such anode catalysts can reduce harmful coking reactions and carbon deposits. Simple oxide versions of catalysts or perovskite may be used as catalysts. For example, about 2% mass CeO₂ catalyst is used for methane-powered fuel cells. The catalyst may be dipped or coated on the anode 202. The catalyst 210 may be made by an additive manufacturing machine (AMM) and incorporated into the fuel cell using the AMM.

The unique manufacturing methods discussed herein have described the assembly of ultra-thin fuel cells and fuel cell stacks. Conventionally, to achieve structural integrity, the fuel cell has at least one thick layer per repeat unit. This may be the anode (such as an anode-supported fuel cell) or the interconnect (such as an interconnect-supported fuel cell). As discussed above, pressing or compression steps are typically necessary to assemble the fuel cell components to achieve gas tightness and/or proper electrical contact in traditional manufacturing processes. As such, the thick layers are necessary not only because traditional methods (like tape casting) cannot produce ultra-thin layers but also because the layers must be thick to endure the pressing or compression steps. The preferred manufacturing methods of this disclosure have eliminated the need for pressing or compression. The preferred manufacturing methods of this disclosure have also enabled the making of ultra-thin layers. The multiplicity of the layers in a fuel cell or a fuel cell stack provides sufficient structural integrity for proper operation when they are made according to this disclosure.

Herein disclosed is a fuel cell comprising an anode no greater than 1 mm or 500 microns or 300 microns or 100 microns or 50 microns or no greater than 25 microns in thickness. The cathode no greater than 1 mm or 500 microns or 300 microns or 100 microns or 50 microns or no greater than 25 microns in thickness. The electrolyte no greater than 1 mm or 500 microns or 300 microns or 100 microns or 50 microns or 30 microns in thickness. The fuel cell may comprise an interconnect having a thickness of no less than 50 microns. In some cases, a fuel cell comprises an anode no greater than 25 microns in thickness, a cathode no greater than 25 microns in thickness, and an electrolyte no greater than 10 microns or 5 microns in thickness. The fuel cell may comprise an interconnect having a thickness of no less than 50 microns. The interconnect may have a thickness in the range of 50 microns to 5 cm.

In a preferred embodiment, a fuel cell comprises an anode no greater than 100 microns in thickness, a cathode no greater than 100 microns in thickness, an electrolyte no greater than 20 microns in thickness, and an interconnect no greater than 30 microns in thickness. In a more preferred embodiment, a fuel cell comprises an anode no greater than 50 microns in thickness, a cathode no greater than 50 microns in thickness, an electrolyte no greater than 10 microns in thickness, and an interconnect no greater than 25 microns in thickness. The interconnect may have a thickness in the range of 1 micron to 20 microns.

In a preferred embodiment, the fuel cell comprises a barrier layer between the anode and the electrolyte, or a barrier layer between the cathode and the electrolyte, or both barrier layers. In some cases, the barrier layers are the interconnects. In such cases, the reactants are directly injected into the anode and the cathode.

In an embodiment, the cathode has a thickness of no greater than 15 microns, or no greater than 10 microns, or no greater than 5 microns. The anode may have a thickness no greater than 15 microns, or no greater than 10 microns, or no greater than 5 microns. The electrolyte may have a thickness of no greater than 5 microns, or no greater than 2 microns, or no greater than 1 micron, or no greater than 0.5 micron. The interconnect may be made of a material comprising metal, stainless steel, silver, metal alloys, nickel, nickel oxide, ceramics, lanthanum chromite, doped lanthanum chromite, or lanthanum calcium chromite. In an embodiment, the fuel cell has a total thickness of no less than 1 micron.

Also discussed herein is a fuel cell stack comprising a multiplicity of fuel cells, wherein each fuel cell comprises an anode no greater than 25 microns in thickness, a cathode no greater than 25 microns in thickness, an electrolyte no greater than 10 microns in thickness, and an interconnect having a thickness in the range from 100 nm to 100 microns. Each fuel cell may comprise a barrier layer between the anode and the electrolyte, or a barrier layer between the cathode and the electrolyte, or both barrier layers. The barrier layers may act as the interconnects. For example, the interconnect may have a thickness in the range from 500 nm to 1000 nm. The interconnect may be made of a material comprising metal, stainless steel, silver, metal alloys, nickel, nickel oxide, ceramics, or lanthanum calcium chromite.

In an embodiment, the cathode has a thickness of no greater than 15 microns, or no greater than 10 microns, or no greater than 5 microns. The anode has a thickness of no greater than 15 microns, or no greater than 10 microns, or no greater than 5 microns. The electrolyte may have a thickness of no greater than 5 microns, or no greater than 2 microns, or no greater than 1 micron, or no greater than 0.5 micron. Each fuel cell may have a total thickness of no less than 1 micron.

Further discussed herein is a method of making a fuel cell comprising (a) forming an anode no greater than 25 microns in thickness, (b) forming a cathode no greater than 25 microns in thickness, and (c) forming an electrolyte no greater than 10 microns in thickness. Steps (a)-(c) may be performed using additive manufacturing. The additive manufacturing may employ one or more of extrusion, photopolymerization, powder bed fusion, material jetting, binder jetting, directed energy deposition or lamination.

In an embodiment, the method comprises assembling the anode, the cathode, and the electrolyte using additive manufacturing. In an embodiment, the method comprises forming an interconnect and assembling the interconnect with the anode, the cathode, and the electrolyte.

In preferred embodiments, the method comprises making at least one barrier layer. In preferred embodiments, the at least one barrier layer is used between the electrolyte and the cathode or between the electrolyte and the anode, or both. In an embodiment, the at least one barrier layer also acts as an interconnect.

In preferred embodiments, the method comprises heating the fuel cell such that shrinkage rates of the anode, the cathode, and the electrolyte are matched. In some embodiments, such heating takes place for no greater than 30 minutes, preferably no greater than 30 seconds, and most preferably no greater than 30 milliseconds. When a fuel cell comprises a first composition and a second composition, wherein the first composition has a first shrinkage rate and the second composition has a second shrinkage rate, the heating described in this disclosure preferably takes place such that the difference between the first shrinkage rate and the second shrinkage rate is no greater than 75% of the first shrinkage rate.

In a preferred embodiment, the heating employs electromagnetic radiation (EMR). In various embodiments, EMR comprises UV light, near ultraviolet light, near infrared light, infrared light, visible light, laser, electron beam. Preferably, heating is performed in situ.

Also disclosed herein is a method of making a fuel cell stack comprising a multiplicity of fuel cells, the method comprising: (a) forming an anode no greater than 25 microns in thickness in each fuel cell, (b) forming a cathode no greater than 25 microns in thickness in each fuel cell, (c) forming an electrolyte no greater than 10 microns in thickness in each fuel cell, and (d) producing an interconnect having a thickness of from 100 nm to 100 microns in each fuel cell.

In an embodiment, steps (a)-(d) are performed using AM. In various embodiments, AM employs one or more of processes of extrusion, photopolymerization, powder bed fusion, material jetting, binder jetting, directed energy deposition or lamination.

In an embodiment, the method of making a fuel cell stack comprises assembling the anode, the cathode, the electrolyte, and the interconnect using AM. In an embodiment, the method comprises making at least one barrier layer in each fuel cell. In an embodiment, the at least one barrier layer is used between the electrolyte and the cathode or between the electrolyte and the anode or both. In an embodiment, the at least one barrier layer also acts as the interconnect.

In an embodiment, the method of making a fuel cell stack comprises heating each fuel cell such that shrinkage rates of the anode, the cathode, and the electrolyte are matched. In an embodiment, such heating takes place for no greater than 30 minutes, or no greater than 30 seconds, or no greater than 30 milliseconds. In a preferred embodiment, said heating comprises one or more of electromagnetic radiation (EMR). In various embodiments, EMR comprises UV light, near ultraviolet light, near infrared light, infrared light, visible light, laser, electron beam. In an embodiment, heating is performed in situ.

In an embodiment, the method comprises heating the entire fuel cell stack such that shrinkage rates of the anode, the cathode, and the electrolyte are matched. In some embodiments, such heating takes place for no greater than 30 minutes, or no greater than 30 seconds, or no greater than 30 milliseconds.

Herein discussed is a method of making an electrolyte comprising (a) formulating a colloidal suspension, wherein the colloidal suspension comprises an additive, particles having a range of diameters and a size distribution, and a solvent; (b) forming an electrolyte comprising the colloidal suspension; and (c) heating at least a portion of the electrolyte; wherein formulating the colloidal suspension is preferably optimized by controlling the pH of the colloidal suspension, or concentration of the binder in the colloidal suspension, or composition of the binder in the colloidal suspension, or the range of diameters of the particles, or maximum diameter of the particles, or median diameter of the particles, or the size distribution of the particles, or boiling point of the solvent, or surface tension of the solvent, or composition of the solvent, or thickness of the minimum dimension of the electrolyte, or the composition of the particles, or combinations thereof.

Herein discussed is a method of making a fuel cell comprising (a) obtaining a cathode and an anode; (b) modifying the cathode surface and the anode surface; (c) formulating a colloidal suspension, wherein the colloidal suspension comprises an additive, particles having a range of diameters and a size distribution, and a solvent; (d) forming an electrolyte comprising the colloidal suspension between the modified anode surface and the modified cathode surface; and (e) heating at least a portion of the electrolyte; wherein formulating the colloidal suspension comprises controlling pH of the colloidal suspension, or concentration of the binder in the colloidal suspension, or composition of the binder in the colloidal suspension, or the range of diameters of the particles, or maximum diameter of the particles, or median diameter of the particles, or the size distribution of the particles, or boiling point of the solvent, or surface tension of the solvent, or composition of the solvent, or thickness of the minimum dimension of the electrolyte, or the composition of the particles, or combinations thereof. In various embodiments, the anode and the cathode are obtained via any suitable means. In an embodiment, the modified anode surface and the modified cathode surface have a maximum height profile roughness that is less than the average diameter of the particles in the colloidal suspension. FIG. 3 illustrates maximum height profile roughness of an anode or cathode surface. The maximum height profile roughness 300 refers to the maximum distance between any trough 302 and an adjacent peak 304 of an anode surface or a cathode surface as illustrated in FIG. 3. In various embodiments, the anode surface and the cathode surface are modified via any suitable means.

Further disclosed herein is a method of making a fuel cell comprising (a) obtaining a cathode and an anode; (b) formulating a colloidal suspension, wherein the colloidal suspension comprises an additive, particles having a range of diameters and a size distribution, and a solvent; (c) forming an electrolyte comprising the colloidal suspension between the anode and the cathode; and (d) heating at least a portion of the electrolyte; wherein formulating the colloidal suspension comprises controlling pH of the colloidal suspension, or concentration of the binder in the colloidal suspension, or composition of the binder in the colloidal suspension, or the range of diameters of the particles, or maximum diameter of the particles, or median diameter of the particles, or the size distribution of the particles, or boiling point of the solvent, or surface tension of the solvent, or composition of the solvent, or thickness of the minimum dimension of the electrolyte, or the composition of the particles, or combinations thereof. In various embodiments, the anode and the cathode are obtained via any suitable means. In an embodiment, the anode surface in contact with the electrolyte and the cathode surface in contact with the electrolyte have a maximum height profile roughness that is less than the average diameter of the particles in the colloidal suspension.

In a preferred embodiment, the solvent comprises water. In a preferred embodiment, the solvent comprises an organic component. The solvent may comprise ethanol, butanol, alcohol, terpineol, diethyl ether 1,2-dimethoxyethane (DME (ethylene glycol dimethyl ether), 1-propanol (n-propanol, n-propyl alcohol), or butyl alcohol or a combination thereof. In some embodiments, the solvent surface tension is less than half of water's surface tension in air. In an embodiment, the solvent surface tension is less than 30 mN/m at atmospheric conditions.

In some embodiments, the electrolyte is formed adjacent to a first substrate or the electrolyte is formed between a first substrate and a second substrate. In some embodiments, the first substrate has a maximum height profile roughness that is less than the average diameter of the particles. In some embodiments, the particles have a packing density greater than 40%, or greater than 50%, or greater than 60%. In an embodiment, the particles have a packing density close to the random close packing (RCP) density.

Random close packing (RCP) is an empirical parameter used to characterize the maximum volume fraction of solid objects obtained when they are packed randomly. A container is randomly filled with objects, and then the container is shaken or tapped until the objects do not compact any further, at this point the packing state is RCP. The packing fraction is the volume taken by a number of particles in a given space of volume. The packing fraction determines the packing density. For example, when a solid container is filled with grain, shaking the container will reduce the volume taken up by the objects, thus allowing more grain to be added to the container. Shaking increases the density of packed objects. When shaking no longer increases the packing density, a limit is reached and if this limit is reached without obvious packing into a regular crystal lattice, this is the empirical random close-packed density.

In some embodiments, the median particle diameter is between 50 nm and 1000 nm, or between 100 nm and 500 nm, or approximately 200 nm. In some embodiments, the first substrate comprises particles having a median particle diameter, wherein the median particle diameter of the electrolyte may be no greater than 10 times and no less than 1/10 of the median particle diameter of the first substrate. In some embodiments, the first substrate comprises a particle size distribution that is bimodal having a first mode and a second mode, each having a median particle diameter. In some embodiments, the median particle diameter in the first mode of the first substrate is greater than 2 times, or greater than 5 times, or greater than 10 times that of the second mode. The particle size distribution of the first substrate may be adjusted to change the behavior of the first substrate during heating. In some embodiments, the first substrate has a shrinkage that is a function of heating temperature. In some embodiments, the particles in the colloidal suspension may have a maximum particle diameter and a minimum particle diameter, wherein the maximum particle diameter is less than 2 times, or less than 3 times, or less than 5 times, or less than 10 times the minimum particle diameter. In some embodiments, the minimum dimension of the electrolyte is less than 10 microns, or less than 2 microns, or less than 1 micron, or less than 500 nm.

In some embodiments, the electrolyte has a gas permeability of no greater than 1 millidarcy, preferably no greater than 100 microdarcy, and most preferably no greater than 1 microdarcy. Preferably, the electrolyte has no cracks penetrating through the minimum dimension of the electrolyte. In some embodiments, the boiling point of the solvent is no less than 200° C., or no less than 100° C., or no less than 75° C. In some embodiments, the boiling point of the solvent is no greater than 125 OC, or no greater than 100° C., or no greater than 85° C., no greater than 70° C. In some embodiments, the pH of the colloidal suspension is no less than 7, or no less than 9, or no less than 10.

In some embodiments, the additive comprises polyethylene glycol (PEG), ethyl cellulose, polyvinylpyrrolidone (PVP), polyvinyl butyral (PVB), butyl benzyl phthalate (BBP), polyalkylene glycol (PAG) or a combination thereof. In an embodiment, the additive concentration is no greater than 100 mg/cm3, or no greater than 50 mg/cm3, or no greater than 30 mg/cm3, or no greater than 25 mg/cm3.

In an embodiment, the colloidal suspension is milled. In an embodiment, the colloidal suspension is milled using a rotational mill wherein the rotational mill is operated at no less than 20 rpm, or no less than 50 rpm, or no less than 100 rpm, or no less than 150 rpm. In an embodiment, the colloidal suspension is milled using zirconia milling balls or tungsten carbide balls wherein the colloidal suspension is milled for no less than 2 hours, or no less than 4 hours, or no less than 1 day, or no less than 10 days.

In some embodiments, the particle concentration in the colloidal suspension is no greater than 30 wt %, or no greater than 20 wt %, or no greater than 10 wt %. In other embodiments, the particle concentration in the colloidal suspension is no less than 2 wt %. In some embodiments, the particle concentration in the colloidal suspension is no greater than 10 vol %, or no greater than 5 vol %, or no greater than 3 vol %, or no greater than 1 vol %. In an embodiment, the particle concentration in the colloidal suspension is no less than 0.1 vol %.

In a preferred embodiment, the electrolyte is formed using an additive manufacturing machine (AMM). In a preferred embodiment, the first substrate is formed using an AMM. In a preferred embodiment, the heating comprises the use of electromagnetic radiation (EMR) wherein the EMR comprises one or more of UV light, near ultraviolet light, near infrared light, infrared light, visible light or laser. In a preferred embodiment, the first substrate and the electrolyte are heated to cause co-sintering. In a preferred embodiment, the first substrate, the second substrate, and the electrolyte are heated to cause co-sintering. In an embodiment, the EMR is controlled to preferentially sinter the first substrate over the electrolyte.

In an embodiment, the electrolyte is compresses after heating. In an embodiment, the first substrate and the second substrate apply compressive stress to the electrolyte after heating. In an embodiment, the first substrate and the second substrate that are applying compressive stress are the anode and cathode of a fuel cell. In some embodiments, the minimum dimension of the electrolyte is between 500 nm and 5 microns or between 1 micron and 2 microns.

The detailed discussion described herein uses the production of solid oxide fuel cells (SOFCs) as an illustrative example. As one in the art recognizes, the methodology and the manufacturing process described herein are applicable to all fuel cell types. As such, the production of all fuel cell types is within the scope of this disclosure.

### Fuel Cell Cartridge

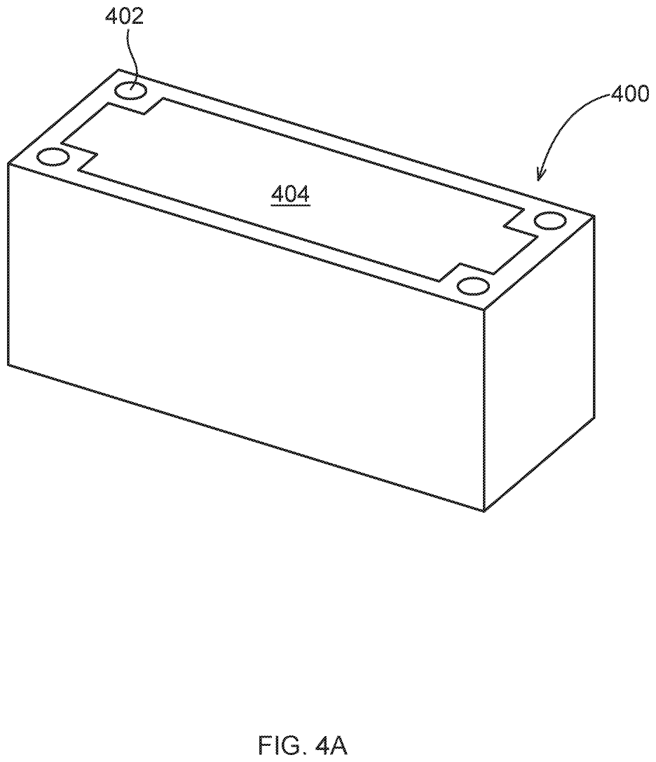

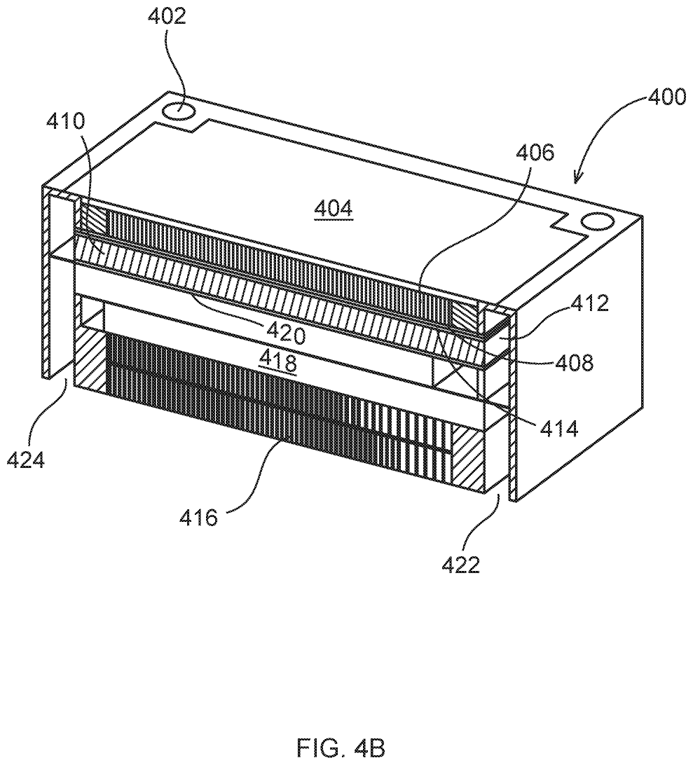

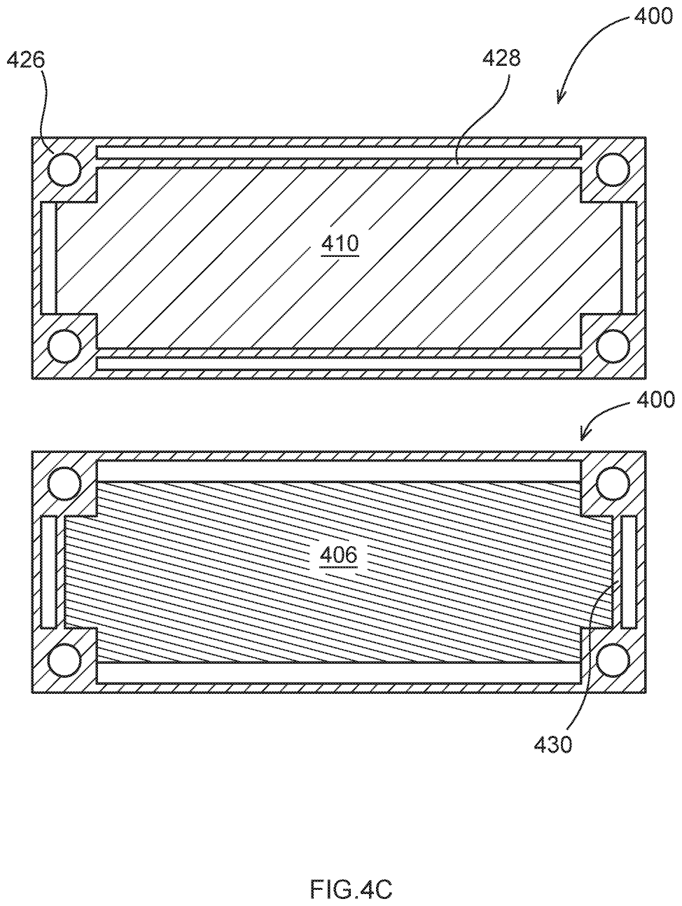

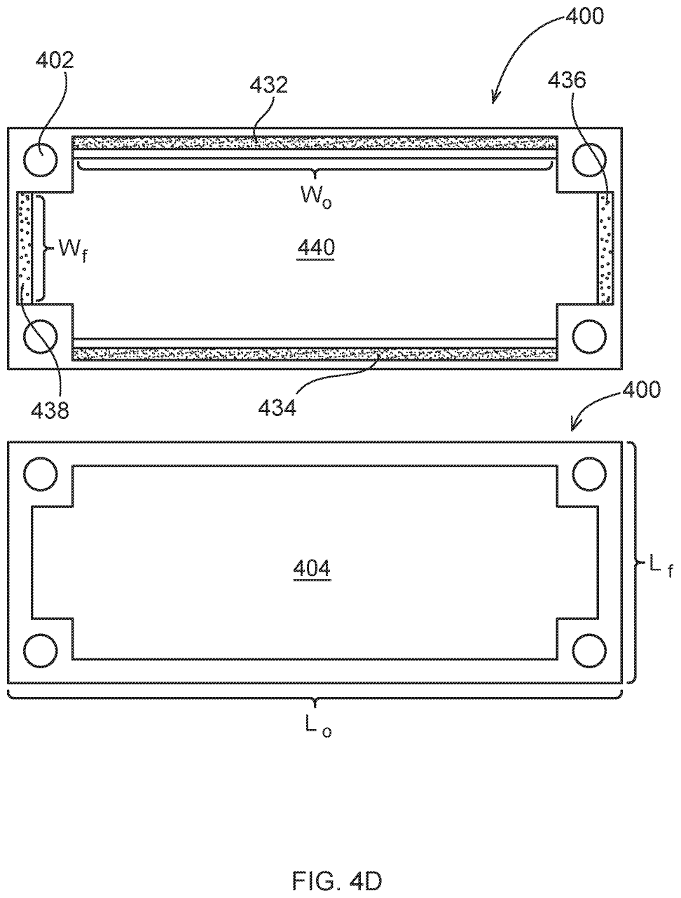

In various embodiments, the fuel cell stack is configured to be made into a cartridge form, such as an easily detachable flanged fuel cell cartridge (FCC) design. Such a design is not only applicable to fuel cells but also other electrochemical reactors, such as flow batteries, electrochemical gas producer, electrochemical gas compressor. FIG. 4A illustrates a perspective view of a fuel cell cartridge (FCC). FCC 400 comprises a rectangular shape as illustrated in FIG. 4A. Other form factors are possible such as square-like, cylindrical-like, hexagonal-like or combinations thereof. The form factor may depend on the application where the FCC may be used such as in industrial, home, automotive or other applications. FCC 400 also comprises holes for bolts 402 to secure the FCC in a system or in series with other FCCs, or both. FCC cartridge 400 housing may be comprised of aluminum, steel, plastic, ceramics, or a combination thereof. FCC 400 comprises a top interconnect 404.

FIG. 4B illustrates a perspective view of a cross-section of a fuel cell cartridge (FCC). FCC 400 comprises holes for bolts 402, cathode layer 406, barrier layer 408 anode layer 410, gas channels 412 in the electrodes (anode and cathode), electrolyte layer 414. an air heat exchanger 416, fuel heat exchanger 418 and top interconnect 404. Air heat exchanger 416 and fuel heat exchanger 418 combined form an integrated multi-fluid heat exchanger. In some embodiments, there is no barrier layer between the cathode and the electrolyte. FCC 400 comprises a second interconnect 420, such as between anode layer 410 and fuel heat exchanger 418. FCC 400 further comprises openings 422, 424 for fuel passages.

FIG. 4C illustrates cross-sectional views of a fuel cell cartridge (FCC). FCC 400 in FIG. 4C comprises electrical bolt isolation 426, anode 410, seal 428 that seals anode 410 from air flow, cathode 406 and seal 430 that seals cathode 406 from fuel flow. The bolts may be isolated electrically with a seal as well. In various embodiments, the seals may be dual functional seal (DFS) comprising YSZ (yttria-stabilized zirconia) or a mixture of 3YSZ (3 mol % Y₂O₃ in ZrO₂) and 8YSZ (8 mol % Y₂O₃ in ZrO₂). In some embodiments, the DFS is impermeable to non-ionic substances and electrically insulating. In some embodiments, the mass ratio of 3YSZ/8YSZ is in the range of from 10/90 to 90/10. In some embodiments, the mass ratio of 3YSZ/8YSZ is about 50/50. In some embodiments, the mass ratio of 3YSZ/8YSZ is 100/0 or 0/100.

FIG. 4D illustrates top view and bottom view of a fuel cell cartridge (FCC). FCC 400 comprises holes for bolts 402, air inlet 432, air outlet 434, fuel inlet 436, fuel outlet 438, bottom 440 and top interconnect 404 of FCC 400. FIG. 4D further illustrates the top view and bottom view of an embodiment of FCC 400, in which the length of the oxidant side of FCC 400 is shown Lₒ, the length of the fuel side of FCC 400 is shown L_{f}, the width of the oxidant (air inlet 432) entrance is shown Wₒ, and the width of the fuel inlet 436 is shown W_{f}. In FIG. 4C, two fluid exits are shown (air outlet 434 and fuel outlet 424). In some embodiments, the anode exhaust and the cathode exhaust may be mixed and extracted through one fluid exit. In some cases, bottom 440 is an interconnect and 432, 434, 436, 438 are openings for fluid passage, e.g., in the direction perpendicular to the lateral direction.

Disclosed herein is a fuel cell cartridge (FCC) 400 comprising an anode, a cathode, an electrolyte, an interconnect, a fuel entrance on a fuel side of the FCC, an oxidant entrance on an oxidant side of the FCC, at least one fluid exit, wherein the fuel entrance has a width of W_{f}, the fuel side of the FCC has a length of L_{f}, the oxidant entrance has a width of Wₒ, the oxidant side of the FCC has a length of Lₒ, wherein W_{f}/L_{f} is in the range of 0.1 to 1.0, or 0.1 to 0.9, or 0.2 to 0.9, or 0.5 to 0.9, or 0.5 to 1.0 and Wₒ/Lₒ is in the range of 0.1 to 1.0, or 0.1 to 0.9, or 0.2 to 0.9, or 0.5 to 0.9, or 0.5 to 1.0.

In some embodiments, the air and fuel entrances and exits are on one surface of the FCC wherein the FCC comprises no protruding fluid passages on said surface. In some embodiments, the surface is smooth with a maximum elevation change of no greater than 1 mm, or no greater than 100 microns, or no greater than 10 microns.

In some embodiments, an FCC comprises a barrier layer between the electrolyte and the cathode, or between the electrolyte and the anode, or both. In an embodiment, the FCC comprises a dual functional seal (DFS) that is impermeable to non-ionic substances and electrically insulating. In some embodiments, the DFS comprises YSZ (yttria-stabilized zirconia) or a mixture of 3YSZ (3 mol % Y₂O₃ in ZrO₂) and 8YSZ (8 mol % Y₂O₃ in ZrO₂).

In some embodiments, the interconnect comprises no fluid dispersing element and said anode and cathode comprise fluid dispersing components. In some embodiments, the interconnect comprises no fluid dispersing element while the anode and cathode comprise fluid channels.

In some embodiments, the FCC is detachably fixed to a mating surface and not soldered nor welded to the mating surface. The FCC may be bolted to or pressed to the mating surface. In some embodiments, the mating surface comprises a matching fuel entrance, matching oxidant entrance, and at least one matching fluid exit.

Also discussed herein is a fuel cell cartridge (FCC) comprising an anode, a cathode, an electrolyte, an interconnect, a fuel entrance, an oxidant entrance, at least one fluid exit, wherein said entrances and exit are on one surface of the FCC and said FCC comprises no protruding fluid passage on the surface. In some embodiments, the surface may be smooth with a maximum elevation change of no greater than 1 mm, or no greater than 100 microns, or no greater than 10 microns.

In some embodiments, the FCC comprises a DFS that is impermeable to non-ionic substances and electrically insulating. In an embodiment, said interconnect comprises no fluid dispersing element and said anode and cathode comprise fluid dispersing components. In an embodiment, said interconnect comprises no fluid dispersing element and said anode and cathode comprise fluid channels.

In an embodiment, the FCC is detachably fixed to a mating surface and not soldered nor welded to said mating surface. In an embodiment, the FCC is bolted to or pressed to the mating surface. The mating surface comprises matching fuel entrance, matching oxidant entrance, and at least one matching fluid exit.

Further disclosed herein is an assembly comprising a fuel cell cartridge (FCC) and a mating surface, wherein the FCC comprises an anode, a cathode, an electrolyte, an interconnect, a fuel entrance on a fuel side of the FCC, an oxidant entrance on an oxidant side of the FCC, at least one fluid exit, wherein the fuel entrance has a width of W_{f}, the fuel side of the FCC has a length of L_{f}, the oxidant entrance has a width of Wₒ, the oxidant side of the FCC has a length of Lₒ, wherein W_{f}/L_{f} is in the range of 0.1 to 1.0, or 0.1 to 0.9, or 0.2 to 0.9, or 0.5 to 0.9, or 0.5 to 1.0 and Wₒ/Lₒ is in the range of 0.1 to 1.0, or 0.1 to 0.9, or 0.2 to 0.9, or 0.5 to 0.9, or 0.5 to 1.0, wherein the FCC is detachably fixed to the mating surface.

In some embodiments, the FCC is not soldered nor welded to said mating surface. In some embodiments, the FCC is bolted to or pressed to said mating surface. In other embodiments, said mating surface comprises matching fuel entrance, matching oxidant entrance, and at least one matching fluid exit.

In some embodiments, said entrances and exits are on one surface of the FCC and wherein the FCC comprises no protruding fluid passage on said surface. The surface may be smooth with a maximum elevation change of no greater than 1 mm, or no greater than 100 microns, or no greater than 10 microns.

In an embodiment, said interconnect comprises no fluid dispersing element and said anode and cathode comprise fluid dispersing components. In an embodiment, said interconnect comprises no fluid dispersing element and said anode and cathode comprise fluid channels.

Discussed herein is a method comprising pressing or bolting together a fuel cell cartridge (FCC) and a mating surface, the method excludes welding or soldering together the FCC and the mating surface, wherein the FCC comprises an anode, a cathode, an electrolyte, an interconnect, a fuel entrance on a fuel side of the FCC, an oxidant entrance on an oxidant side of the FCC, at least one fluid exit, wherein the fuel entrance has a width of W_{f}, the fuel side of the FCC has a length of L_{f}, the oxidant entrance has a width of Wₒ, the oxidant side of the FCC has a length of Lₒ, wherein W_{f}/L is in the range of 0.1 to 1.0, or 0.1 to 0.9, or 0.2 to 0.9, or 0.5 to 0.9, or 0.5 to 1.0 and Wₒ/Lₒ is in the range of 0.1 to 1.0, or 0.1 to 0.9, or 0.2 to 0.9, or 0.5 to 0.9, or 0.5 to 1.0, wherein the FCC and the mating surface are detachable.

In an embodiment, said entrances and exit are on one surface of the FCC wherein the FCC comprises no protruding fluid passage on said surface. The surface is smooth with a maximum elevation change of no greater than 1 mm, or no greater than 100 microns, or no greater than 10 microns. In an embodiment, said interconnect comprises no fluid dispersing element and said anode and cathode comprise fluid dispersing components. In an embodiment, said interconnect comprises no fluid dispersing element and said anode and cathode comprise fluid channels.

Herein disclosed is a fuel cell cartridge (FCC) comprising a fuel cell and a fuel cell casing, wherein the fuel cell comprises an anode, a cathode and an electrolyte, wherein at least a portion of the fuel cell casing is made of the same material as the electrolyte. In an embodiment, the electrolyte is in contact with the portion of the fuel cell casing made of the same material. In an embodiment, the electrolyte and the portion of the fuel cell casing are made of a DFS, wherein the DFS comprises 3YSZ (3 mol % Y₂O₃ in ZrO₂) and 8YSZ (8 mol % Y₂O₃ in ZrO₂), wherein the mass ratio of 3YSZ/8YSZ is in the range of from 100/0 to 0/100 or from 10/90 to 90/10 and wherein the DFS is impermeable to non-ionic substances and electrically insulating. In an embodiment, the mass ratio of 3YSZ/8YSZ is about 50/50 or 40/60 or 60/40 or 30/70 or 70/30 or 20/80 or 80/20.

In an embodiment, said fuel cell casing comprises a fuel entrance and fuel passage for the anode, an oxidant entrance and oxidant passage for the cathode, and at least one fluid exit. In an embodiment, the entrances and at least one exit are on one surface of the FCC wherein the FCC comprises no protruding fluid passage on the surface. In an embodiment, the fuel cell casing is in contact with at least a portion of the anode.

In an embodiment, the FCC comprises a barrier layer between the electrolyte and the cathode and between the fuel cell casing and the cathode. In an embodiment, the FCC comprises an interconnect, wherein the interconnect comprises no fluid dispersing element and said anode and cathode comprise fluid dispersing components. In an embodiment, the FCC comprises an interconnect, wherein the interconnect comprises no fluid dispersing element and said anode and cathode comprise fluid channels.

In an embodiment, the FCC is detachably fixed to a mating surface and not soldered nor welded to said mating surface. In an embodiment, said mating surface comprises matching fuel entrance, matching oxidant entrance, and at least one matching fluid exit.

Also discussed herein is a DFS comprising 3YSZ (3 mol % Y₂O₃ in ZrO₂) and 8YSZ (8 mol % Y₂O₃ in ZrO₂), wherein the mass ratio of 3YSZ/8YSZ is in the range of from 10/90 to 90/10 and wherein the DFS is impermeable to non-ionic substances and electrically insulating. In an embodiment, the mass ratio of 3YSZ/8YSZ is about 50/50 or 40/60 or 60/40 or 30/70 or 70/30 or 20/80 or 80/20. In an embodiment, the DFS is used as an electrolyte in a fuel cell or as a portion of a fuel cell casing, or both.

Further disclosed herein is a method comprising providing a DFS in a fuel cell system, wherein the DFS comprises 3YSZ (3 mol % Y₂O₃ in ZrO₂) and 8YSZ (8 mol % Y₂O₃ in ZrO₂), wherein the mass ratio of 3YSZ/8YSZ is in the range of from 100/0 to 0/100 or from 10/90 to 90/10 and wherein the DFS is impermeable to non-ionic substances and electrically insulating. In an embodiment, the mass ratio of 3YSZ/8YSZ is about 50/50 or 40/60 or 60/40 or 30/70 or 70/30 or 20/80 or 80/20.

In an embodiment, the DFS is used as electrolyte or a portion of a fuel cell casing or both in the fuel cell system. The portion of a fuel cell casing may be the entire fuel cell casing. The portion of a fuel cell casing is a coating on the fuel cell casing. The electrolyte and said portion of a fuel cell casing are in contact.

Disclosed herein is a fuel cell system comprising an anode having six surfaces, a cathode having six surfaces, an electrolyte, and an anode surround in contact with at least three surfaces of the anode, wherein the electrolyte is part of the anode surround and said anode surround is made of the same material as the electrolyte. In an embodiment, said same material is a DFS comprising 3YSZ (3 mol % Y₂O₃ in ZrO₂) and 8YSZ (8 mol % Y₂O₃ in ZrO₂), wherein the mass ratio of 3YSZ/8YSZ is in the range of from 100/0 to 0/100 or from 10/90 to 90/10 and wherein the DFS is impermeable to non-ionic substances and electrically insulating. In an embodiment, the mass ratio of 3YSZ/8YSZ is about 50/50 or 40/60 or 60/40 or 30/70 or 70/30 or 20/80 or 80/20. In an embodiment, the anode surround is in contact with five surfaces of the anode.

In an embodiment, the fuel cell system comprises a barrier layer between the cathode and a cathode surround, wherein the barrier layer is in contact with at least three surfaces of the cathode, wherein the electrolyte is part of the cathode surround and said cathode surround is made of the same material as the electrolyte.

In an embodiment, the fuel cell system comprises fuel passage and oxidant passage in the anode surround and the cathode surround. In an embodiment, the fuel cell system comprises an interconnect, wherein the interconnect comprises no fluid dispersing element and said anode and cathode comprise fluid dispersing components. In an embodiment, the fuel cell system comprises an interconnect, wherein the interconnect comprises no fluid dispersing element and said anode and cathode comprise fluid channels.

### Integrated Reformer

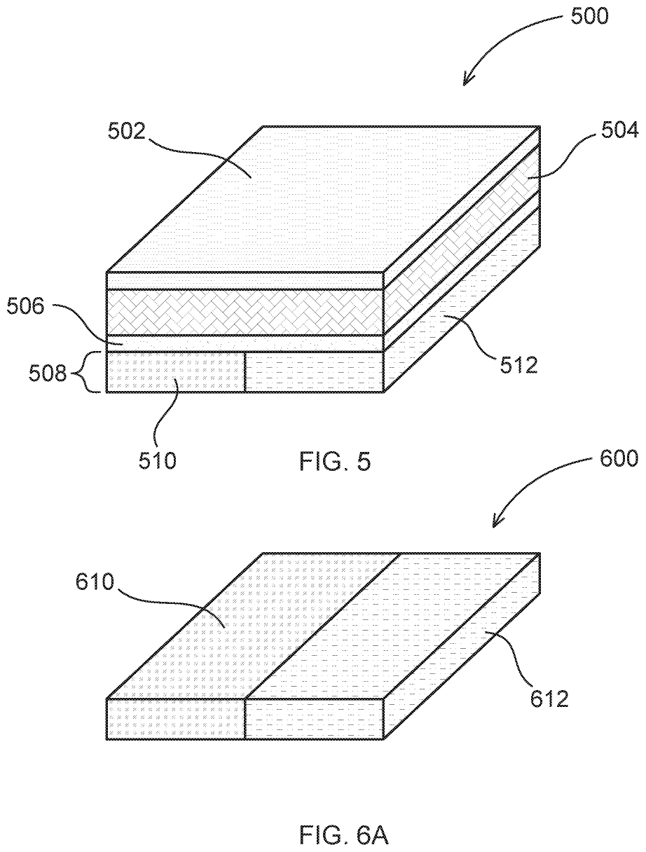

Herein discussed is a fuel cell comprising a reformer-anode layer. FIG. 5 illustrates a fuel cell unit 500 comprising a reformer-anode layer, according to an embodiment of this disclosure. Fuel cell unit 500 may be a single fuel cell or may be part of a fuel stack comprising two or more fuel cell units 500. Fuel cell unit 500 comprises an interconnect 502, cathode layer 504 and an electrolyte layer 506. Fuel cell unit 500 further comprises a reformer-anode layer 508. Reformer anode layer 508 further comprises a reformer component 510 and an anode component 512. At least a portion of the reformer and at least a portion of the anode are lateral to one another.

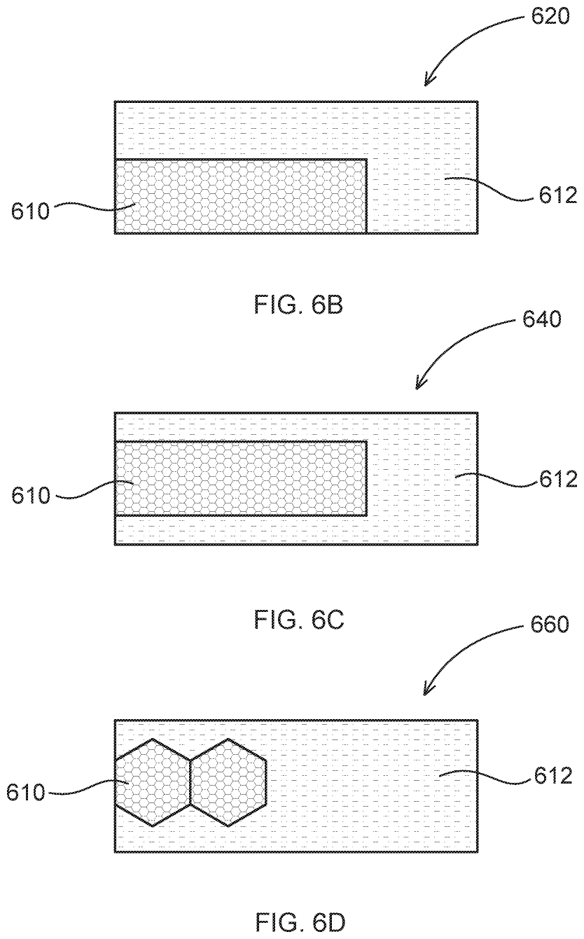

As shown in FIGS. 6A-D, various designs of the reformer anode layer 508 are possible. FIG. 6A illustrates a reformer-anode layer design 600, according to an embodiment of the disclosure. In this embodiment, the reformer 610 and the anode 612 have substantially the same thickness. The reformer 610 and anode 612 also substantially have the same volume wherein the ratio of the volume of the reformer (Vᵣ) to the volume of the anode (Vₐ) is about 1 (Vᵣ/Vₐ). In other various embodiments, the reformer 610 and the anode 612 may have regular shapes or irregular shapes.

FIG. 6B illustrates a cross-sectional view of a reformer-anode layer design 620, according to an embodiment of the disclosure. In this embodiment, the reformer 610 and the anode 612 do not have the same thickness. In this embodiment 620, the anode 612 may partially encapsulate the reformer layer 610. This allows for a larger amount of interfacial surface area between the reformer 610 and anode 612. This may allow for more efficient operation of fuel cell unit 500.

FIG. 6C illustrates another cross-sectional view of a reformer-anode layer design 640, according to an embodiment of the disclosure. In this embodiment, the reformer 610 and the anode 612 do not have the same thickness. In this embodiment 640, the anode 612 may nearly completely encapsulate the reformer layer 610. This allows for an even larger amount of interfacial surface area between the reformer 610 and anode 612 compared to the reformer-anode layer design 620.

FIG. 6D illustrates another cross-sectional view of a reformer-anode layer design 660, according to an embodiment of the disclosure. In this embodiment, the anode 612 may nearly encapsulate the reformer 610 for a substantial amount of interfacial surface area. Additionally, various designs of the reformer 610 may be possible. In the example in FIG. 6D, the reformer layer 610 is in a honeycomb-like cross-sectional shape formed from individual hexagonal-like shapes surrounded by anode 612. The reformer 610 may comprise other cross-sectional shapes such as circular, oval, square, triangular, rectangular or other shapes.

In an embodiment, the reformer 510, 610 may comprise platinum, cobalt, cerium, palladium, cesium, nickel, iron, manganese, nitrogen, tetra-nitrogen, molybdenum, copper, chromium, rhodium, ruthenium, gadolinium, Al2O₃, CeO₂, ZrO₂, SiO₂, TiO₂, steel, cordierite (2MgO-2Al₂O₃-5SiO₂), aluminum titanate (Al₂TiO₅), silicon carbide (SiC), or combinations thereof. The anode 512, 612 may comprise nickel, YSZ, nickel oxide, GDC, SDC, or combinations thereof. The electrolyte 506 may comprise YSZ, GDC, SDC, or combinations thereof. The cathode 504 may comprise LSM, LSCF, GDC, SDC, YSZ, or combinations thereof.

In an embodiment, the reformer 510, 610 and the anode 512, 612 may have a volume ratio (Vᵣ/Vₐ) no greater than 5, no greater than 2, or no greater than 1, or no greater than 0.5. In an embodiment, the reformer-anode layer may have a thickness in the range of 1 to 1000 microns or 5 to 500 microns or 25 to 250 microns. The electrolyte 506 may have a thickness in the range of 100 nm to 1 mm or 500 nm to 500 microns or 1 micron to 10 microns. The cathode layer 504 may have a thickness in the range of 1 to 1000 microns or 5 to 500 microns or 25 to 250 microns.

In an embodiment, the fuel cell unit 500 comprises one or more interconnects 502 in contact with the reformer-anode layer 508 and in contact with the cathode layer 504. The interconnects 502 may comprise silver, steel, chromium, magnesium, iron, Inconel, lanthanum, or combinations thereof. The interconnects 502 may have a thickness in the range of 100 nm to 1 cm or 500 nm to 1 mm or 1 micron to 10 microns. In an embodiment, the fuel cell unit 500 may further comprise a heat conductive component between the reformer 510 and the anode 512. The heat conductive component may comprise a metal.

In an embodiment, the reformer 510, 610, the anode 512, 612, the cathode 504 or combinations thereof may be porous and comprises channels for fluid flow. The channels may be preconfigured. In embodiments, the channels are preconfigured by providing a scaffold and removing at least a portion of the scaffold. Providing a scaffold may comprise dispersing metal oxide particles in a monomer ink before printing the scaffold. The metal oxide may comprise NiO, CuO, LSM (lanthanum strontium manganite), LSCF (lanthanum strontium cobalt ferrite), GDC (gadolinium doped ceria), SDC (samaria-doped ceria), or combinations thereof. The monomer ink may comprise an alcohol, aldehyde, carboxylic acid, ester, or ether functional groups or combinations thereof. The scaffold may comprise NiO, Cu(I)O, Cu(II)O, an organic compound, a photopolymer, or combinations thereof.

Also discussed herein is a method of making a fuel cell unit 500 comprising forming a reformer 510, forming an anode 512, forming an electrolyte 506, and forming a cathode layer 504, wherein the reformer 510 and the anode 512 are formed into a reformer-anode layer 508. At least a portion of the reformer 510 and at least a portion of the anode 512 may be lateral to one another. In an embodiment, the method comprises forming interconnects 502 in contact with the reformer-anode layer 508 and in contact with the cathode layer 504. The method may further comprise providing a heat conductive component between the reformer 510 and the anode 512.

In an embodiment, forming a reformer 510 comprises providing a scaffold wherein the scaffold is in contact with a reformer material and removing at least a portion of the scaffold to form channels in the reformer 510. Forming an anode 512 comprises providing a scaffold wherein the scaffold is in contact with an anode material and removing at least a portion of the scaffold to form channels in the anode 512. Forming a cathode 504 comprises providing a scaffold wherein the scaffold is in contact with a cathode material; removing at least a portion of the scaffold to form channels in the cathode 504.

In an embodiment, providing a scaffold comprises printing the scaffold or precursors that assemble to form a scaffold or polymerizing one or more monomers or a photo-initiator or both. In an embodiment, the method comprises curing monomers and or oligomers or both. The curing comprises UV curing. The method further comprises adding a polymerizing agent, wherein optionally the polymerizing agent comprises a photo-initiator. The polymerizing agent may be printed on top of the monomer or printed within each slice of the monomer. In an embodiment, providing a scaffold comprises dispersing metal oxide particles in a monomer ink before printing the scaffold. The metal oxide may comprise NiO, CuO, LSM (lanthanum strontium manganite), LSCF (lanthanum strontium cobalt ferrite), GDC (gadolinium doped ceria), SDC (samaria-doped ceria), or combinations thereof. The monomer may comprise alcohol, aldehyde, carboxylic acid, ester, or ether functional groups or a combination thereof. The scaffold may comprise NiO, Cu(I)O, Cu(II)O, an organic compound, a photopolymer, or combinations thereof.

In embodiments, removing at least a portion of the scaffold comprises heating, combustion, solvent treatment, oxidation, reduction, or combinations thereof. The combustion preferably leaves no deposits and is not explosive. Reduction may take place in a metal oxide and produces a porous scaffold. The removing of at least a portion of the scaffold may take place in situ. The removing may take place after a fuel cell stack or a repeat unit 1300 of a fuel cell stack is formed. The removing may take place when a fuel cell stack is initiated to operate.

In an embodiment, the forming comprises material jetting, binder jetting, inkjet printing, aerosol jetting, aerosol jet printing, or combinations thereof. The printing or jetting may take place slice by slice. The second slice may be printed atop a first slice before the first slice is heated, wherein the heating removes at least a portion of the scaffold.

Further discussed herein is a method comprising introducing a fuel into an EC reactor, such as a fuel cell, wherein the fuel comprises no molecular hydrogen (H₂) and wherein the fuel cell unit 500 comprises a reformer-anode layer 508, an electrolyte 506, and a cathode layer 504. The reformer-anode layer 508 comprises reformer 510 and anode 512, wherein at least a portion of the reformer 510 and at least a portion of the anode 512 are lateral to one another. The reformer 510, anode 512, cathode 504 or combinations thereof are porous and comprises channels for fluid flow. The channels may be preconfigured. The channels may be preconfigured by providing a scaffold and removing at least a portion of the scaffold.

In an embodiment, the method comprises introducing an oxidant into a fuel cell unit 500, wherein the oxidant has a flow rate that is reduced by no less than 20%, no less than 30%, no less than 40% or no less than 50% compared to oxidant flow rate in a fuel cell unit into which molecular hydrogen (H₂) is introduced.

Herein discussed is a method comprising forming a reformer composite wherein the reformer composite comprises a catalyst and a substrate, wherein the mass ratio between the catalyst and the substrate is in no less than 1/100 or no less than 1/10 or no less than ⅕, or no less than ⅓, or no less than 1/1. The catalyst comprises nickel oxide, silver, cobalt, cesium, nickel, iron, manganese, nitrogen, tetra-nitrogen, molybdenum, copper, chromium, rhodium, ruthenium, palladium, osmium, iridium, platinum, or combinations thereof. The substrate comprises gadolinium, CeO₂, ZrO₂, SiO₂, TiO₂, steel, cordierite (2MgO-2Al₂O₃-5SiO₂), aluminum titanate (Al₂TiO₅), silicon carbide (SiC), all phases of aluminum oxide, yttria or scandia-stabilized zirconia (YSZ), gadolinia or samaria-doped ceria, or combinations thereof.

In an embodiment, the forming a reformer composite comprises material jetting, binder jetting, inkjet printing, aerosol jetting, aerosol jet printing or combinations thereof. The reformer composite is formed upstream of an anode 512 in a fuel cell unit 500, wherein the fuel cell unit 500 comprises an electrochemical zone and wherein the reformer composite is outside the electrochemical zone of the fuel cell unit 500 or as an integral part of the electrochemical zone of the fuel cell unit 500 or both. As shown in FIGS. 5-6, a reformer 510 is formed as an integral part of the electrochemical zone of a fuel cell unit or a fuel cell stack repeat unit.

In an embodiment, the reformer composite is printed as part of an inlet or as part of a fluid passage for a fuel introduced into a fuel cell unit 500. In an embodiment, the reformer composite and inlet or the reformer composite and fluid passage are printed as one integral part. In an embodiment, the reformer composite is printed as part of a heat exchanger for a fuel introduced into a fuel cell unit 500. In an embodiment, the reformer composite and heat exchanger are printed as one integral part.

In an embodiment, the method comprises providing a scaffold wherein the scaffold is in contact with the reformer composite and removing at least a portion of the scaffold to form channels in the reformer composite. Providing a scaffold may comprise printing the scaffold or precursors that assemble to form the scaffold. Providing a scaffold may comprise polymerizing one or more monomers or a photo-initiator or both. The method may further comprise curing monomers or oligomers or both. The curing may comprise UV curing. The method may comprise adding a polymerizing agent, wherein optionally the polymerizing agent comprises a photo-initiator. The polymerizing agent may be printed on top of the monomer or printed within each slice of the monomer.

In an embodiment, providing a scaffold comprises dispersing metal oxide particles in a monomer ink before printing the scaffold. The metal oxide may comprise NiO, CuO, LSM (lanthanum strontium manganite), LSCF (lanthanum strontium cobalt ferrite), GDC (gadolinium doped ceria), SDC (samaria-doped ceria), or combinations thereof. The monomer may comprise alcohol, aldehyde, carboxylic acid, ester, or ether functional groups or combinations thereof. The scaffold may comprise NiO, Cu(I)O, Cu(II)O, an organic compound, a photopolymer, or combinations thereof.

In an embodiment, removing at least a portion of the scaffold comprises heating, combustion, solvent treatment, oxidation, reduction, or combinations thereof. The combustion preferably leaves no deposits and is not explosive. The reduction may take place in a metal oxide and produces a porous scaffold. The method may comprise heating in situ. The scaffold and reformer composite may be printed slice by slice and a second slice is printed atop a first slice before the first slice is heated, wherein the heating removes at least a portion of the scaffold. The heating may comprise electromagnetic radiation (EMR) wherein EMR comprises UV light, near ultraviolet light, near infrared light, infrared light, visible light, laser, electron beam or combinations thereof.

In an embodiment, the channels may have regular or random trajectories within the reformer composite. The channels may have more than one entry point and more than one exit point. The more than one entry point and more than one exit point may be distributed across the reformer composite.

In an embodiment, the reformer composite comprises pore formers, wherein at least a portion of the pore formers are removed. The pore formers may comprise polymer beads. The polymer beads may be made of polymers consisting of elements C, H, and O. The polymer beads may be made of polystyrene, or poly(methyl methacrylate) (PMMA), or latex, or combinations thereof. The pore formers comprise carbon nanoparticles wherein the carbon nanoparticles may comprise graphite, black carbon nanoparticles, activated carbon nanoparticles, non-activated carbon nanoparticles, or combinations thereof. The pore formers may have a diameter in the range of from 0.01 to 0.1 microns, or from 0.1 to 5 microns, or from 5 microns to 1 mm. The pore formers may have a diameter in the range of from 0.01 micron to 1 mm. The pore formers may have a diameter no greater than 5 microns or no greater than 1 micron or no greater than 0.1 micron. Removing at least a portion of the pore formers may comprise heating, combustion, solvent treatment, oxidation, reduction, or combinations thereof. Preferably, the combustion leaves no deposits and is not explosive. The catalyst, substrate, and pore formers may be deposited separately or deposited in any combination as a mixture.

### Balance of Plant

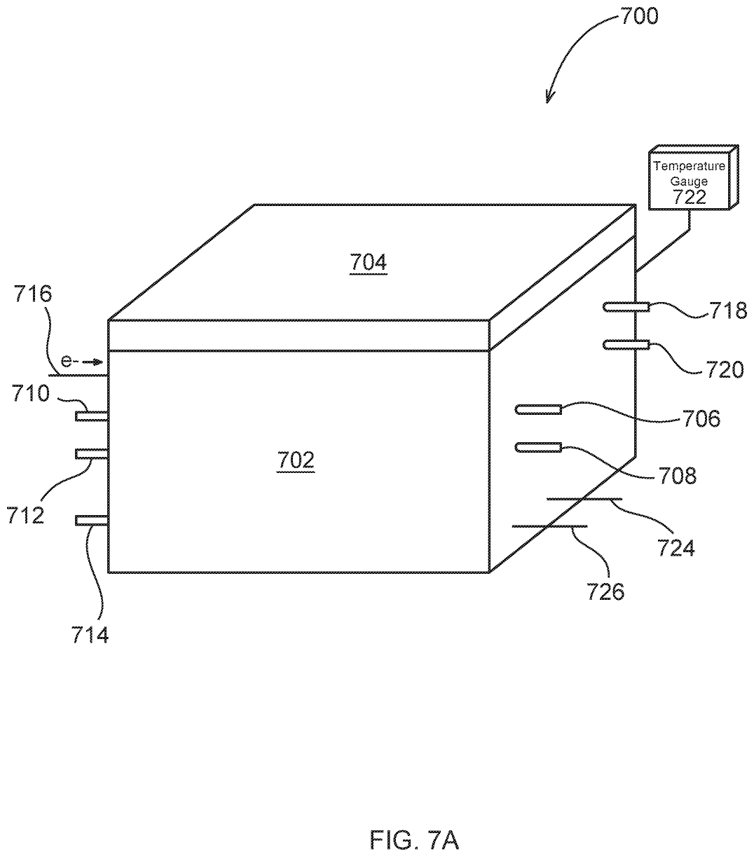

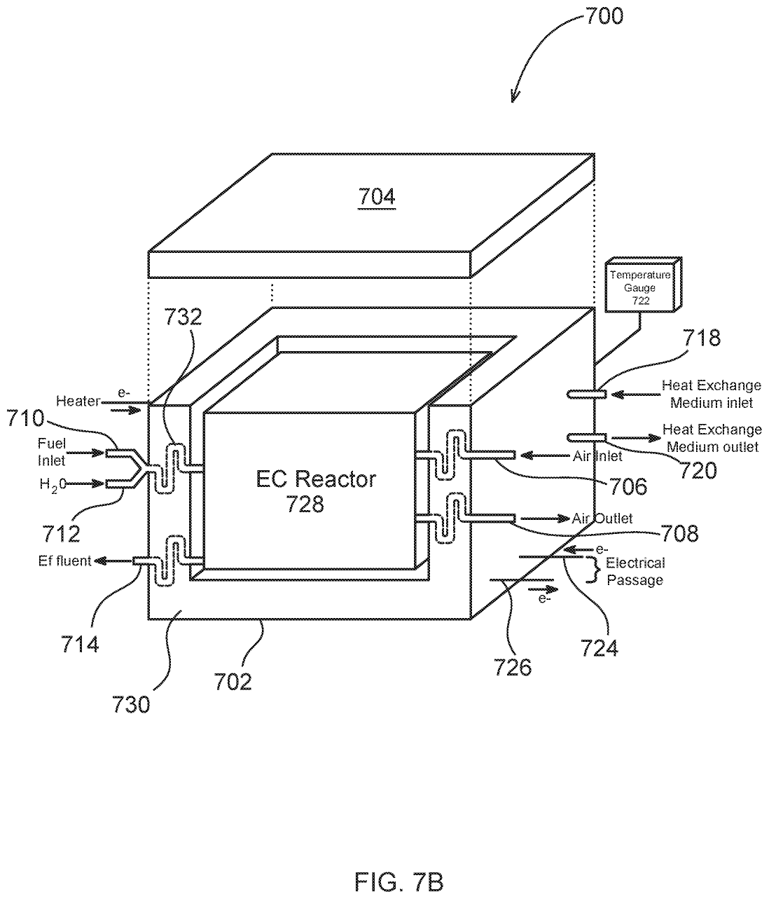

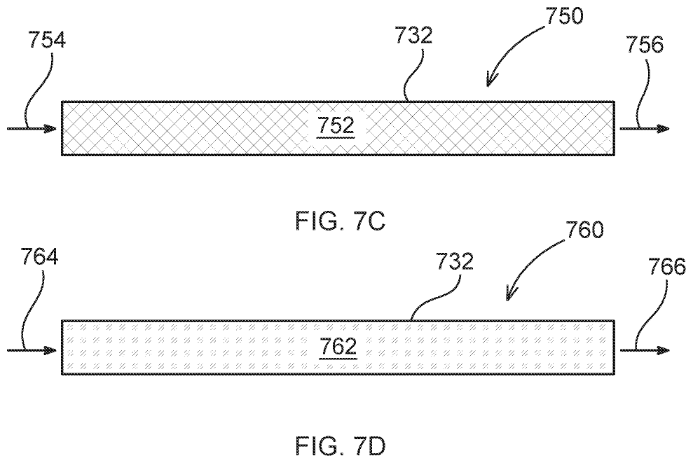

Balance of plant in an electrochemical (EC) reactor system includes the components of the system except the reactor itself such that the reactor operates in a reliable and balanced manner. This can include pumps, sensors, heat exchangers, compressors, reformers, recirculation blowers, fluid controls and other related auxiliary units. EC reactors may include EC compressors, EC gas producers, flow batteries, or fuel cells. FIG. 7A schematically illustrates an embodiment of a device. Device 700 comprises a vessel 702. Vessel 702 may also be referred to as a container, canister, receptacle, or case to receive an EC reactor. Vessel 702 may comprise an internal space to receive an EC reactor. Vessel 702 may be made in many suitable shapes. For example, the vessel 702 is in the shape of a cylinder, cylinder with a cone-shaped bottom, rectangular prism or a cube. Device 700 comprises a lid 704. Lid 704 may be partially or completely removable. Lid 704 may be connected to vessel 702 by a hinge or other related mechanism. Vessel 702 or lid 704 may comprise thermal insulation, vibrational padding or electrical isolation inside or outside or both inside and outside vessel 702 and lid 704.

Device 700 includes an inlet 706. Inlet 706 may be a passage for ambient air, cleaned air, dry air, oxygen, steam, cathode gas, or other gasses, fluids or oxidants. Inlet 706 may be in fluid communication with an oxidant inlet of the reactor. Device 700 comprises an outlet 708 to allow for unreacted and processed oxidizing gasses to escape. Passage or inlet 706 may be configured to be in fluid communication with an inlet of the EC reactor. Outlet 708 may also be in fluid communication with the EC reactor.

The device may comprise a fuel passage for a fuel, for example see the inlet 710 in FIG. 7A. Fuel passage 710 is configured to be in fluid communication with an inlet of the EC reactor, such as a fuel cell. The fuel passage may be configured to heat the fuel. The fuel may be hydrogen, carbon monoxide, methane or other light or heavy hydrocarbon. Device 700 comprises an inlet 712 for water to supply a reformer, such as a steam reformer. Device 700 may comprise a passage to allow for reacted, unreacted and processed fuels to escape as an effluent. Effluent outlet 714 may be in fluid communication with the effluent outlet of the EC reactor. In some embodiments, the effluent passage may be configured to be in thermal communication with the fuel passage or with the oxidant passage or with both. The effluent passage may be configured to extract thermal energy from the effluent. In some embodiments, the extracted thermal energy may be used for other applications such as heating water in a pool or water heater or heating a residential home or business.

Device 700 includes an electrical inlet 716. Electrical inlet 716 may be used to provide power to heat device 700. Heating may be carried out by inductive or other method of heating. Heating could be supplied to one or both of the vessel 702, or the lid 704.

In a preferred embodiment, device 700 comprise an inlet for a heat exchange medium (HEM). Heat exchange medium inlet 718 may provide a passage for a medium to regulate the temperature of device 700. The HEM may be a gas or a liquid or a combination of a gas and liquid. Device 700 further comprises a heat exchange medium outlet 720. Inlet 718 and outlet 720 allows for recirculation of the HEM. The device may be integrated with an external HEM recirculator and HEM reservoir. The HEM may be selected from the group of water, air, polyalkylene glycol, ethylene glycol, diethylene glycol, propylene glycol, betaine, mineral oil, silicone oil, transformer oil, nitrogen or carbon dioxide.

In a preferred embodiment, device 700 comprises a temperature gauge. Temperature gauge 722 is used to monitor the temperature of one or more of device 700, HEM, fuel, water, and oxidant. Device 700 may comprise more than one temperature gauge.

In a preferred embodiment, device 700 comprises an electrical passage. The electrical passage may be configured to transmit electricity to and from the EC reactor. FIG. 7A illustrates an electrical passage 724 where an electrical current may enter device 700 and an electrical passage 726 by where an electrical current may leave device 700. Passages 724, 726 may comprise one or more of an electrical conduit, insulation and electrical wiring.

FIG. 7B schematically illustrates a cross-section of an embodiment of a device. The illustration in FIG. 7B is a perspective view of a cross-section of device 700. The illustration in FIG. 7B shows an EC reactor 726 occupying a space in vessel 702. In a preferred embodiment, EC reactor 728 comprises at least one fuel cell stack wherein the stack comprises at least one anode, cathode and electrolyte layer. In a preferred embodiment, EC reactor 728 may be removeable and replaceable if, for example, reactor 728 is damaged or loses operating efficiency.

Device 700 comprises at least one wall 730. Wall 730 may be a functional wall providing one or more functions for operation of EC reactor 728. One or more walls 730 in vessel 700 may be functional walls. In some embodiments, lid 704 may also operate as a functional wall. In some embodiments, the wall may be detachable. Wall 730 may operate as a heat exchange wall (HEW). HEW may be configured to heat the fuel for the EC reactor. The HEW may further be configured to heat the oxidant for the EC reactor. The HEW may also be configured to cool the effluent for the EC reactor. HEW 730 may also be used to heat the water supply.

HEW 730 may comprise at least a portion of fuel inlet 710 and outlet 714. HEW 730 may comprise at least a portion of oxidant passage 706. HEW 730 may comprise at least a portion of the water inlet 712.

In some embodiments, vessel 702 may comprise a reformer. In some embodiments, one or more walls 730 of vessel 702 may operate as reformer walls. A reformer may convert a fuel into a syngas or other preferred form for more efficient operation of the EC reactor. In a preferred embodiment, heated water and fuel are combined in device 700 to convert hydrocarbons into H₂ and CO for operation of the EC reactor 726. At least a portion of one or more reformer walls overlaps with at least a portion of a HEW. One or more reformer walls comprises at least a portion of the fuel passage.

In a preferred embodiment, vessel 702 may comprise a desulphurization unit or built in desulphurization wall. The desulphurization unit or wall is to purify the fuel by removing unwanted sulphur-based compounds that may be present in the fuel. Sulphur-based compounds can poison EC reactors such as fuel cells and lower efficiency or even completely render the fuel cell useless. In a preferred embodiment, the desulphurization wall comprises one or more desulphurization agents such as zinc or zinc oxide. The desulphurization unit or wall comprises a volume filled with a packed bed. The material in the desulphurization packed bed may be removable and replaceable. The packed bed may comprise particles or pellets that are porous or non-porous. The particles or pellets may be about 1 to 5 mm, about 0.05 to 10 mm or about 0.1 to 1 mm in median hydraulic diameter. These particles or pellets may comprise 0.05 wt %-100 wt % catalyst. In some cases, the packed bed comprises zinc or zinc oxide. The desulphurization unit or desulphurization wall may scrub sulfur from fuel fluid (e.g., by converting H₂S in fuel into zinc sulfide). The desulphurization unit or desulphurization wall may be able to operate for hundreds or thousands of hours before the packed bed is replaced.

For more efficient heat exchange, desulphurization or reforming, walls 730 comprise one or more channels 732. Channels 732 are depicted in FIG. 7B as dotted lines which implies the channels are inside walls 730. In other embodiments, the channels may be outside of the walls. In some embodiments, the lid 704 may also comprise channels. The channels increase surface area and residence time to allow for heat transfer and reforming.

A reformer wall may comprise a volume that is at least partially filled with a catalyst. The catalyst may be replaceable. The reformer catalyst may be located in channels 732. Under suitable conditions (e.g., temperature, pressure, and composition) fuel fluid placed in the reformer is at least partially reformed into H₂ and/or CO.

FIG. 7C schematically illustrates an embodiment of a channel in a reformer. Reformer channel 750 comprises a channel 732 that is packed with a catalyst 752 in a mesh-like, high surface area design. Channel 732 in FIG. 7C further depicts fluid flow by flow inlet 754 and flow outlet 756. Fluid flow 754 depicts unreformed fuel entering the channel 732 where in combination with steam in the presence of mesh catalyst 752 can be transformed and converted to a more efficient fuel for EC reactor 728.

FIG. 7D schematically illustrates another embodiment of a channel in a reformer. Reformer channel 760 comprises a channel 732 that is packed with a catalyst 762 in a packed bed-like, high surface area design. Channel 732 in FIG. 7D further depicts fluid flow by flow inlet 764 and flow outlet 766. Fluid flow 764 depicts unreformed fuel entering the channel 732 where in combination with steam in the presence of packed bed catalyst 762 is converted to a more efficient fuel for EC reactor 728.

In some embodiments, channel 732 may comprise a desulphurization agent. For example, catalyst 752, 762 in reformer channel embodiment illustrated in FIGS. 7C-D may instead be a desulphurization agent. In other embodiments, channel 732 may comprise both a reformer catalyst and a desulphurization catalyst. In an exemplary embodiment, fuel entering into fuel inlet 710 and into a fuel passage that is in fluid communication with the EC reactor may first pass through a portion of a fuel passage that comprises a desulphurization agent wherein sulfur-based compounds are removed from the fuel. Then, the fuel may continue on through a different portion of the passage that contains a reformer catalyst and steam wherein the fuel is reformed. These portions of a fuel passage where desulphurization and reforming processes occur may be heated. These processes may occur inside of a wall or outside of a wall.

The catalysts in a reformer wall may comprise nickel, copper, platinum, rhodium, ruthenium, Al₂O₃, CeO₂, ZrO₂, SiO₂, TiO₂, gadolinium, steel, or combinations thereof. In other embodiments, the reformer may comprise a monolith, foam, packed bed, a steel shell, an expansion layer, a mixer, or combinations thereof. The monolith may comprise a catalyst such as one or more of nickel, copper, platinum rhodium, ruthenium, Al₂O₃, CeO₂, ZrO₂, SiO₂, TiO₂, gadolinium, cordierite (2MgO-2Al₂O₃—SSiO₂), aluminum titanate (Al₂TiO₅), silicon carbide (SiC), or combinations thereof. The monolith may have a porosity in the range of about 40-90% or in the range of about 70%-90%. In some embodiments, the monolith may be in a honeycomb configuration with channels ranging from about 200 to 1200 cells/inch² or from about 10 to 2000 cells/inch². The hydraulic diameter may be about 0.5-2 mm, or as small as 10 microns. The wall thickness may be in the range of about 0.05 to 1 mm, or about 0.05 to 0.3 mm. In some embodiments, the monolith is coated with a catalyst and wherein the catalyst coating has a thickness of about 1-500 microns, about 1-250 microns, about 10-100 microns or about 20-40 microns. In some embodiments, the expansion layer may be in contact with, or wraps the monolith and comprises a ceramic, alumina-silicate fibers, alumina, vermiculite, or combinations thereof.

In some embodiments, monoliths are preferred over packed beds because they have a lower pressure drop and higher surface area, and as such, better reactivity for less energy input. In some embodiments, a packed bed is used in-lieu of the monolith. The bed can comprise a catalyst. When using a packed bed, the packed bed may comprise porous pellets that are about 1 to 5 mm, about 0.05 to 10 mm or about 0.1 to 1 mm in median hydraulic diameter. The bed may comprise 0.05 wt %-100 wt % catalyst or noble metals. The packed bed may comprise Al₂O₃ for instance. In some cases, a foam is used, which is a porous material containing a suitable catalyst.

In a preferred embodiment, a reformer in device 700 may comprise a mixer that is configured to mix a fuel and an oxidant, and optionally and aqueous fluid (e.g., steam) to form a mixture to feed the mixture to a reformer (e.g., a monolith containing a reformer catalyst). The mixer may be a foam or a packed bed (e.g., an Al₂O₃ foam disk).

In some embodiments, vessel 702 may be configured such that material in the reformer is removable and replaceable.

In some embodiments, vessel 702 comprises a heater wall or a heater unit. the heater wall or heater unit may be configured to preheat a fuel or an oxidant or both for the EC reactor 728. The EC reactor 728 may produce an exit anode gas and an exit cathode gas. The heater wall or heater unit supplied by power inlet 1816, may be configured to burn the exit anode gas with the exit cathode gas. The heater wall or unit may also heat water from water inlet 712.

As mentioned previously, vessel 702 comprises at least one temperature gauge. The at least one temperature gauge 722 is configured to measure temperatures in the EC reactor 728, HEW, reformer wall, fuel, oxidant, effluent, or combinations thereof. In some cases, vessel 702 comprises controls for fluid flow rates wherein the controls are adjusted according to measurements of the temperature gauges. Vessel 702 may be operated at a temperature of no less than 300° C., or no less than 500° C., or no less than 700° C., or no less than 800° C., or no less than 1000° C.

Vessel 702 may be designed to come in a variety of form factors. FIGS. 7A-B depicts vessel 702 in a rectangular-like shape. Other shapes are possible depending on the application of the reactor. Such shapes may include square-like, cylindrical-like, hexagonal-like, rectangular-like, cube-like, or other shapes. Vessel 702 may have a volume no greater than 1 m³. The vessel 702 has a volume no greater than 1 ft³. Vessel 702 may have a maximum dimension no greater than 1 m. Walls 730 of vessel 702 may have a wall thickness of no greater than 10 cm, or no greater than 1 cm, or no greater than 1 mm, or no greater than 100 microns.

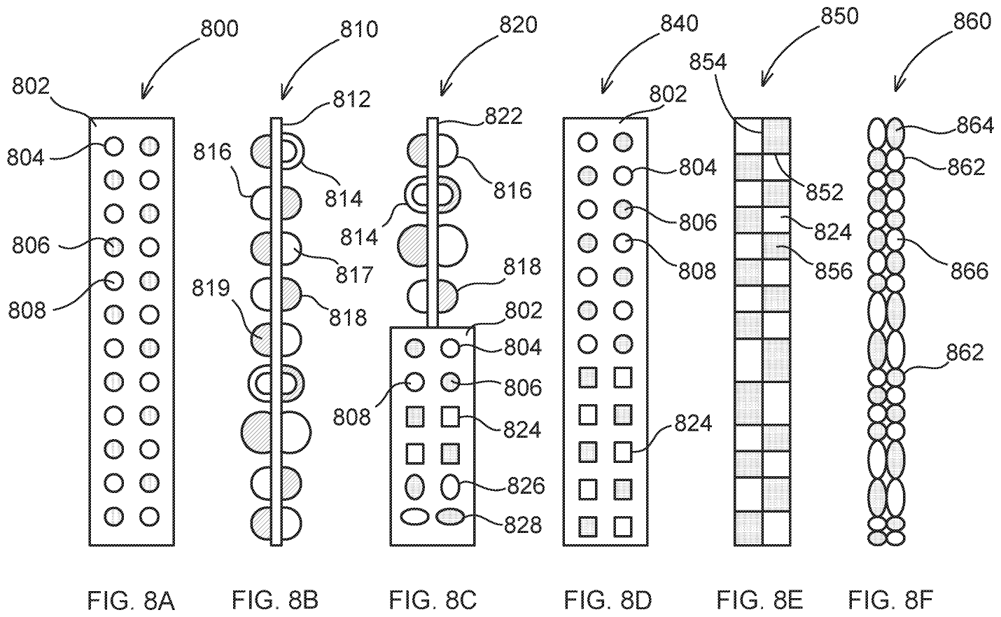

As mentioned previously, walls 730 of vessel 702 comprise channels 732. FIGS. 8A-F illustrate a few examples of how fluid flow channels 732 may be built into the walls 730 of vessel 702. The channels 732 may be in any suitable cross-sectional shape—circular, oval, square, rectangle, triangle, irregular or combinations thereof. FIG. 8A schematically illustrates an embodiment of a wall in a device. Wall embodiment 800 in FIG. 8A shows a wall material 802 further comprising channels 804. Fluids may flow through the channels in various directions. Non-shaded channels 808 depict flow in one direction while shaded channels 806 depict flow in the opposite direction. In this design, all channels are internal to the wall. The channels and walls may be of unitary construction.

FIG. 8B schematically illustrates another embodiment of a wall in a device. Wall embodiment 810 in FIG. 8B shows a wall material 812 further comprising channels 814, 816, 818. Fluids may flow through the channels in various directions. Non-shaded channels 817 depict fluid flow in one direction while shaded channels 819 depicts fluid flow in the opposite direction. In this design, all channels are external to the wall. The channels may begin on one side of the wall, enter the wall and end on the opposing side of the wall in a weave-like manner. These channels in some cases are removably attached to the wall and are replaceable.

FIG. 8C schematically illustrates another embodiment of a wall in a device. Wall embodiment 820 in FIG. 8C shows wall material 802, 822 further comprising channels 804, 814, 816, 818, 824, 826. Fluids may flow through the channels in various directions. Non-shaded channels depict fluid flow in one direction while shaded channels depict fluid flow in the opposite direction. This design is a combination of wall designs 800 and 810 wherein the channels are internal and external to the wall. The channels and walls may be of unitary construction. Some of the channels are removably attached to the wall and are replaceable.

In some embodiments, one or more fluid channels may be in or attached to at least a portion of wall 730 or lid 704 of vessel 702 and not be of unitary construction. In some cases, the channels could be a removable attachment that is added to the wall (i.e., bolted, latched or any other attaching means may be suitable). As can be seen in FIGS. 8B-C, the channels can be on the outside of the wall. As such, not only are the reformer catalyst or desulphurization agent located in the channels replaceable, the channels containing the reformer catalyst or desulphurization agent may also be replaceable. The fluid channels comprising reforming catalyst or desulphurization agent may be replaced when the efficiency of the catalyst or agent falls below a desired level. A removeable single channel may also comprise a portion further comprising a desulphurization agent and a reforming catalyst. Oxidant inlet channels, effluent outlet channels and unreacted oxidant outlet channels may also not be of unitary construction with a wall but may instead be removeable. These channels may also be in fluid communication with the EC reactor.

FIG. 8D schematically illustrates another embodiment of a wall in a device. Wall embodiment 840 in FIG. 8D shows a wall material 802 further comprising circular-like channels 804 and square-like channels 824. Fluids may flow through the channels in various directions. Non-shaded channels 808 depict fluid flow in one direction while shaded channels 806 depicts fluid flow in the opposite direction. In this design, all channels are internal to the wall. The difference is that the channels are a combination of square and circular-like channels instead of just being one or the other.

FIG. 8E schematically illustrates another embodiment of a wall in a device. Wall embodiment 850 in FIG. 8E shows a wall material 852, 854 further comprising square-like or rectangle-like channels. Fluids may flow through the channels in various directions. Non-shaded channels 824 depict fluid flow in one direction while shaded channels 856 depicts fluid flow in the opposite direction. In this design, the wall is primarily channel space. The wall is more like a frame made up of thin horizontal walls 852 and thin vertical walls 854.

FIG. 8F schematically illustrates another embodiment of a wall in a device. Wall embodiment 860 in FIG. 8F shows circular or oval-like channels 862. Fluids may flow through the channels in various directions. Non-shaded channels 866 depict fluid flow in one direction while shaded channels 864 depicts fluid flow in the opposite direction. In this design, the wall is made up of channels in the form of tubes.

In an embodiment, a first group of the fluid channels forms a fuel passage in fluid communication with a fuel inlet of the reactor. The first group of fluid channels comprises at least one channel. In some cases, a portion of the fuel passage includes a desulfurization agent, and wherein the desulfurization agent may be replaceable. The portion of the fuel passage containing the desulfurization agent may be replaceable, especially when such portion of fuel passage consists of removably attached fluid channels. In some cases, a portion of the fuel passage includes a reformer catalyst, wherein the reformer catalyst may be replaceable. The portion of the fuel passage containing the reformer catalyst may be replaceable, especially when such portion of fuel passage consists of removably attached fluid channels. A second group of fluid channels may form an oxidant passage in fluid communication with an oxidant inlet of the reactor. The second group of fluid channels comprises at least one channel. A third group of the fluid channels may form an effluent passage in fluid communication with an effluent outlet of the reactor. The third group of fluid channels comprises at least one channel.

In any of the channel embodiments described herein and whether they be for heat exchange, reformer, desulphurization walls or other components, may have a hydraulic diameter of no greater than 5 cm, or no greater than 1 cm, or no greater than 1 mm. The channels may have a hydraulic diameter of no less than 100 microns. The channels may have a hydraulic diameter of no less than 1 mm and no greater than 5 cm. The channels may have restrictions to utilize the Bernoulli or venturi effect to draw fluid from one channel to another. The channels in the vessel 702 may have foam or porous media to mix the streams.

In any of the channel embodiments described herein, they may have a length of no less than 1 cm, or no less than 100 cm, or no less than 1 m, or no less than 10 m, or no less than 100 m. The channels may have a length in the range of from about 1 cm to about 10 m. The channels may have a length in the range of from about 1 m to about 10 cm.

In some embodiments, vessel 702 comprises a built-in heater, ignition system, or start-up heater. These devices may be used to heat the fuel cell system to the needed temperature to initiate the reactions to operate the EC reactor 728. For example, the heater is able to burn natural gas or other combustible gasses for start-up. In some cases, the heater is also the afterburner, which is configured to burn exit gasses from an EC reactor 728, such as the exit anode gas with the exit cathode gas from a fuel cell. The afterburner produces heat and effluent waste gas stream. Alternatively, the vessel 702 comprises a heating battery to start up the EC reactor reactions, such as in a fuel cell.

In some embodiments, vessel 702 may comprise a water supply source (like a water tank or reservoir). The water supply source may be heated to produce steam for the reformer. The vessel 702 may be configured to have efficient heat transfer via conduction, radiation, and/or convection between the multiple streams.

Disclosed herein is a method of providing balance of plant (BOP) for an EC reactor device 700. The method comprises making a vessel 702, wherein the vessel 702 has at least a first wall and an internal space configured to contain an EC reactor. A heat exchange wall may also be formed and) integrated with at least a portion of the first wall (see FIGS. 7-8). The HEW may be inside the wall; the HEW may be outside the wall; or both.

In an embodiment, the first wall may be formed from a single material and may be formed as a single part. It should be noted that being made of a single part is referred to as unitary construction. This is opposed to a part being assembled from multiple parts or components. The wall may be formed using one or more methods of 2D printing, 3D printing, extrusion, tape casting, spraying, deposition, sputtering or screen printing. In a preferred embodiment, the wall may be formed by the method of additive manufacturing (AM). AM methods comprise one or more of extrusion, photopolymerization, powder bed fusion, material jetting, binder jetting, directed energy deposition or lamination. AM methods further comprise one or more of direct metal laser sintering (DMLS), selective laser sintering (SLS), selective laser melting (SLM), directed energy deposition (DED), laser metal deposition (LMD), electron beam (EBAM) or metal binder jetting. In some embodiments, the method of forming a wall comprises heating or sintering.

In an embodiment, the method of forming a wall to provide balance of plant (BOP) for an EC reactor comprises forming a reformer wall integrated with at least a portion of the wall. At least a portion of the reformer wall may overlap with at least a portion of the HEW.

In an embodiment, the method of providing BOP for an EC reactor comprises forming an inlet and an outlet for a heat exchange medium (HEM). The method may comprise forming an inlet and an outlet for a heat exchange medium (HEM) for the HEW. The method may comprise forming a fuel passage for an EC reactor, wherein the fuel passage is configured to be in fluid communication with an inlet of the EC reactor for the fuel. The method may comprise forming an oxidant passage for an oxidant, wherein the oxidant passage is configured to be in fluid communication with an inlet of the EC reactor for the oxidant. The method may comprise forming an effluent passage for an effluent, wherein the effluent passage is configured to be in fluid communication with an outlet of the EC reactor for the effluent.

In an embodiment, the HEW is configured to heat the fuel or the oxidant or both the fuel and oxidant for the EC reactor. In other embodiments, the HEW is configured to cool the effluent for the EC reactor. In an embodiment, the HEW may comprise at least a portion of the fuel passage, at least a portion of the oxidant passage or at least a portion of the effluent passage, or a combination thereof.

In an embodiment, the method of proving BOP for an EC reactor comprises forming electrical passage configured to transmit electricity from or to the EC reactor. The method may include forming a conduit for electrical wiring. The method may further comprise adding thermal insulation, vibrational padding or electrical isolation inside the vessel, outside the vessel or both.

In an embodiment, the reformer wall formed by the method of providing BOP for an EC reactor comprises at least a portion of the fuel passage. The reformer wall may comprise a catalyst wherein the catalyst may be replaceable. The reformer wall may comprise nickel, copper, platinum, rhodium, ruthenium, Al₂O₃, CeO₂, ZrO₂, SiO₂, TiO₂, gadolinium, steel, or combinations thereof. The reformer may also comprise a monolith, packed bed, foam, a steel shell, an expansion layer, a mixer, or combinations thereof. The monolith may comprise a catalyst. The monolith may comprise nickel, copper, platinum rhodium, ruthenium, Al₂O₃, CeO₂, ZrO₂, SiO₂, TiO₂, gadolinium, cordierite (2MgO-2Al₂O₃-5SiO₂), aluminum titanate (Al₂TiO₅), silicon carbide (SiC), or combinations thereof. The monolith may have a porosity in the range of 40-90% or 70%-90%. The monolith may also be coated with a catalyst wherein the catalyst coating has a thickness of 1-500 microns or 10-100 microns. The mixer in the reformer may be a foam or a packed bed. The mixer is configured to mix a fuel and an oxidant, and optionally steam to form a mixture. The mixer also feeds the mixture to a reformer catalyst.

In an embodiment, the method of providing BOP for an EC reactor comprises forming a desulphurization wall integrated with at least a portion of the formed wall. The desulphurization wall may comprise, copper, zinc or zinc oxide.

The method of providing BOP to an EC reactor comprises forming a heater wall or a heater unit. The heater wall or heater unit is configured to preheat a fuel, an oxidant or both fuel and oxidant for the EC reactor. The heater wall or heater unit may also be configured to burn the exit anode gas with the exit cathode gas that is produced by the EC reactor. The method of providing BOP to an EC reactor comprises providing a water supply. The water supply is used to generate steam, such as for steam reforming the fuel.

The method of providing BOP to an EC reactor comprises utilizing at least one temperature gauge. The at least one temperature gauge is configured to measure temperatures in the EC reactor, HEW, reformer wall, the fuel, the oxidant, the effluent, or combinations thereof. In an embodiment, the method comprises using controls for fluid flow rates wherein the controls are adjusted according to measurements of the temperature gauges.

In an embodiment, the method of providing BOP for an EC reactor comprises operating the vessel at a temperature of no less than 300° C., or no less than 500° C., or no less than 700° C., or no less than 800° C., or no less than 1000° C. The vessel may have a volume no greater than 1 m³ or no greater than 1 ft³. The vessel may have a maximum dimension no greater than 1 m and a wall thickness of no greater than 10 cm, or no greater than 1 cm, or no greater than 1 mm, or no greater than 100 microns.

In an embodiment, the HEW has channels with a hydraulic diameter of no greater than 5 cm, or no greater than 1 cm, or no greater than 1 mm. The HEW may have channels with a hydraulic diameter of no less than 100 microns, no less than 1 mm and no greater than 5 cm. The HEW may have channels with a length of no less than 1 cm, or no less than 100 cm, or no less than 1 m, or no less than 10 m, or no less than 100 m. The HEW may have channels with a length in the range of from about 1 cm to about 10 m. In other embodiments, the HEW may have channels with a length of about 10 cm.

Herein also discussed is a method of providing balance of plant (BOP) for an EC reactor comprising, forming a heat exchange wall (HEW) and a reformer wall in a single process. The forming may be accomplished via 2D printing, 3D printing, extrusion, tape casting, spraying, deposition, sputtering or screen printing. In a preferred embodiment, the forming is accomplished via additive manufacturing (AM). AM may comprise one or more methods of extrusion, photopolymerization, powder bed fusion, material jetting, binder jetting, directed energy deposition or lamination. AM may also comprise one or more of direct metal laser sintering (DMLS), selective laser sintering (SLS), selective laser melting (SLM), directed energy deposition (DED), laser metal deposition (LMD), electron beam (EBAM), or metal binder jetting. In an embodiment, the method comprises heating or sintering after metal binder jetting. The features disclosed previously are combinable with these embodiments.

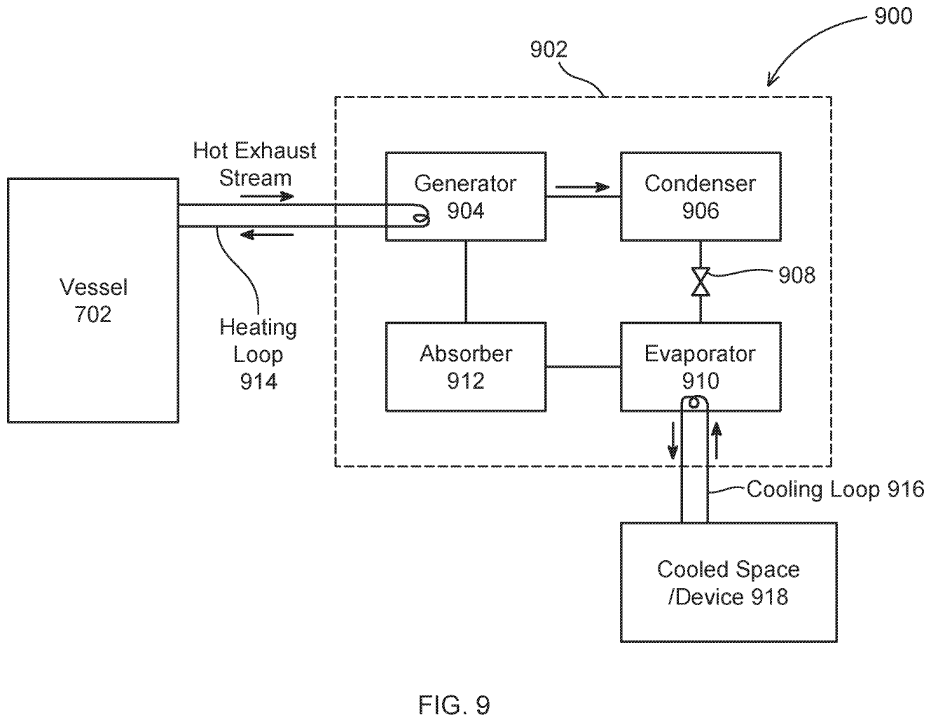

Vessel 702 containing the at least one fuel cell 728 may further comprise an absorption chiller unit. FIG. 9 illustrates a system 900 comprising a vessel and an absorption chiller unit 902, according to an embodiment of this disclosure. The absorption chiller unit 902 comprises a generator 904 that further contains a solution, such as lithium bromide in water or ammonia in water. The generator 904 is where a fluidic solution is heated and partially vaporized to cause a phase change. For example, in this step the ammonia in an ammonia water solution is vaporized

Absorption chiller unit 902 comprises a passageway and a condenser 906 where the partially vaporized fluid (e.g., ammonia vapor) enters from a passageway from the generator 904 is condensed and cooled. The liquified solution passes through a passageway and an expansion valve 908, wherein the liquified fluid (e.g., ammonia) loses pressure while maintaining its enthalpy, and then passes through a passageway and enters the evaporator 910. In the evaporator 910 the liquid (e.g., ammonia) absorbs heat and leaves as a vapor (e.g., ammonia vapor). The vapor then enters a passageway and then into the absorber 912 where the vapor is exposed to weak fluidic solution (e.g., ammonia in water), combined and cooled to form a strong fluidic solution (e.g., ammonia in water). The strong fluidic solution is then pumped to the generator 904 through a passageway wherein the process is continued in a continuous cycle.

System 900 further includes a heating loop 914 and a cooling loop 916. Heating loop 914 is in fluid communication with vessel 702. Heating loop 914 heats fluid in generator 904 in order to drive the operation of the absorption chiller 902. At least a portion of a HEW in vessel 902 transfers heat to the heating loop 914 of the absorption chiller unit 902. In an embodiment, at least a portion of the HEW is an integral part of the heating loop 914 of the absorption chiller unit 902.

In an embodiment, the cooling loop 916 is in communication with the evaporator 910 and configured to cool a residential space, a commercial space, or an apparatus 918. The cooling loop 916 may be configured to provide refrigeration or air conditioning. The cooling loop 916 may be configured to cool data centers or devices such as grid storage battery systems and computing equipment 918.

In an embodiment, the vessel 702 is configured to heat a residential space, a commercial space, an apparatus, or a fluid such as potable water.

In an embodiment, the system 900 further comprises a CO₂ recovery unit, wherein the CO₂ recovery unit is configured to utilize or dispose CO₂ from the fuel cell 728. The CO₂ recovery unit may be configured to utilize the CO₂ in a chemical process or a biological process or an electrochemical process. The CO₂ recovery unit may be configured to utilize the CO₂ in a green box or a green house. The CO₂ recovery unit can be configured to utilize the CO₂ in producing biofuel via microorganisms. The CO₂ recovery unit can be configured to use the CO₂ in a metal-CO₂ battery, in enhanced oil recovery or coal bed methane recovery.

Also discussed herein is a method of using a fuel cell comprising placing the fuel cell in a vessel 702 comprising a heat exchange wall (HEW), transferring heat from at least a portion of the HEW to a heating loop 914 of an absorption chiller unit 902, wherein the absorption chiller unit 902 comprises a cooling loop 916 that cools a residential space, a commercial space, an apparatus, a device 918 or a fluid. In an embodiment, at least a portion of the HEW is an integral part of the heating loop 914 of the absorption chiller unit 902. In an embodiment, the cooling loop 916 provides refrigeration or air conditioning. The cooling loop 916 may be used to cool data centers or computing equipment.

In an embodiment, the method comprises transferring heat from another portion of the HEW to heat a residential space, a commercial space, an apparatus, or a fluid such as potable water. In an embodiment, the fuel cell 728 is operated at a temperature of 500° C. or higher, such as 500° C.-1000° C. The fuel cell 728 in vessel 702 may be operated at a temperature in the range of from about 400° C. to about 650° C. or from about 500° C. to about 850° C. or from about 600° C. to about 900° C. The BOP for the fuel cell is configured such that it allows such operation temperatures.

Further discussed herein is a method of using a fuel cell 728 comprising harvesting CO₂ from the fuel cell and utilizing the CO₂ in a chemical process or a biological process or an electrochemical process. The method may comprise utilizing the CO₂ in a green box or a green house or producing biofuel via microorganisms. The method comprises sequestering the CO₂. The method may also comprise utilizing the CO₂ in enhanced oil recovery, coal bed methane recovery or in a metal-CO₂ battery.

### Multi-fluid Heat Exchanger

A multi-fluid heat exchanger allows three or more fluids to transfer thermal energy between one another. By using multi-fluid heat exchangers, it is possible to reduce the number of traditional heat exchangers needed for EC reactor systems. Using the manufacturing method of this disclosure, the complexity and cost to make multi-fluid heat exchangers are also reduced.

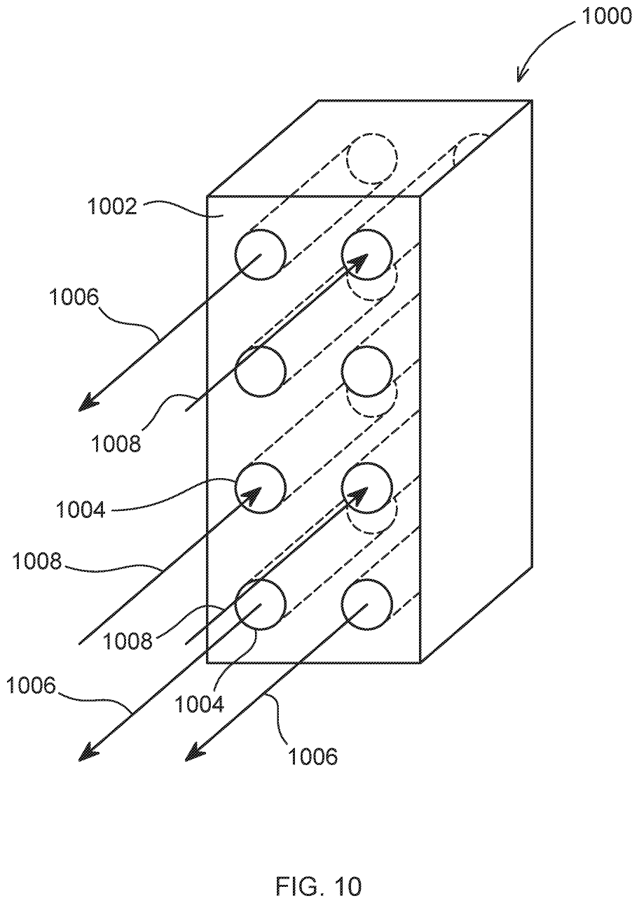

FIG. 10 schematically illustrates a cross-section of a portion of a multi-fluid heat exchanger, according to an embodiment of the disclosure. Multi-fluid heat exchanger 1000 in FIG. 10 comprises a wall 1002 and multiple channels 1004. The arrows represent directional fluid flow through channels 1004 of a heat exchanger. Arrows 1006 represent flow in one direction while arrows 1008 represent fluid flow in an opposite direction. Alternatively, FIG. 10 illustrates fluid flow directions in the channels in a HEW in a vessel as shown in FIG. 8.

Each channel may flow a unique fluid. For example, two channels may be the air passage. Two channels may be fuel passage and water passage while another channel may be for effluent passage. Other channels in the multi-fluid heat exchanger may be for the heat exchange medium to flow throughout the heat exchanger. The multi-fluid heat exchanger may comprise at least three fluid inlets and at least three fluid channels, wherein each of the at least three fluid channels has a minimum dimension of no greater than 30 mm. In some embodiments, each of the three fluid channels may have a minimum dimension of no greater than 30 mm. In other embodiments, the minimum dimension is no greater than 15 mm. In other embodiments, the minimum dimension is no greater than 10 mm. In still other embodiments, In other embodiments, the minimum dimension is no greater than 5 mm. In some embodiments, at least two of the three fluid channels converge. In some cases, three fluid channels converge. In a preferred embodiment, the heat exchanger may comprise no brazed or soldered part. The heat exchanger may be one part and be of unitary construction. The heat exchanger may be made of one material wherein the one material comprises one or more of Inconel, stainless steel, ceramic, aluminum, copper or brass.

The multi-fluid heat exchanger may comprise four fluid inlets and four fluid channels, five fluid inlets and five fluid channels or six fluid inlets and six fluid channels. As illustrated in FIG. 10, the fluids may be arranged to flow concurrently or counter currently as denoted by arrows 1006 and 1008. In some cases, the fluids are arranged in a combination of concurrent flow or countercurrent flow.

In some embodiments, the heat exchanger comprises fins or baffles in at least one of the fluid channels. The fins or baffles and/or supports in the channel may be in any suitable shape, size, and combination of shapes and sizes. In various embodiments, the fins or baffles and the heat exchanger are of one part of unitary construction and are made of one material. The heat exchanger may comprise supports in at least one of the fluid channels. The supports provide structural rigidity and strength to the channels in order for the channels to withstand high temperatures and fluid pressures. In various embodiments, the heat exchanger and the supports are of unitary construction and are made of one material. In a preferred embodiment, the heat exchanger may comprise a catalyst in a portion of at least one of the fluid channels.

In some embodiments, only one layer of material separates two fluid channels, wherein the separating layer is no greater than 5 mm or 1 mm or 0.5 mm or 0.2 mm or 0.1 mm. The minimum dimension of one fluid channel may be at least twice as large as the minimum dimension of another fluid channel. The minimum dimension of one fluid channel may be at least three times as large as the minimum dimension of another fluid channel. The minimum dimension of one fluid channel may be at least four as large as the minimum dimension of another fluid channel. The minimum dimension of one fluid channel may be at least five times as large as the minimum dimension of another fluid channel. In an embodiment, at least two fluid channels converge and form an additional fluid channel.

Further discussed herein is a method of making a heat exchanger, comprising forming at least three fluid inlets; forming at least three fluid channels, wherein each of the at least three fluid channels may have a minimum dimension of no greater than 30 mm or no greater than 15 mm. The heat exchanger may be part of unitary construction or from one material. The one material may comprise one or more of Inconel, stainless steel, ceramic, aluminum, copper, brass. It should be noted that when it is mentioned herein that a part is made from “one material”, it is implied to mean “substantially one material”. “One material includes trace elements and other residual components that may remain in the material during construction. This may include residual solvents, binders, or other materials remaining during and after the process of forming the part has been completed.

In an embodiment, each of the three fluid channels may have a minimum dimension of no greater than 10 mm or 5 mm. The method comprises converging at least two of the three fluid channels. In some instances, the method comprises converging three fluid channels. The method may further comprise no brazing or soldering. The method may comprise forming four fluid inlets and four fluid channels; or forming five fluid inlets and five fluid channels; or forming six fluid inlets and six fluid channels. In some embodiments, at least two of the fluid channels converge.

In an embodiment, the method of making a multi-fluid heat exchanger, comprising forming at least three fluid inlets and at least three fluid channels further comprises forming fins or baffles in at least one of the fluid channels as the at least one of the fluid channels is being formed. The fins or baffles and the heat exchanger may be one part and made of one material. In an embodiment, the method comprises forming supports in at least one of the fluid channels as the at least one of the fluid channels is being formed. The supports and the heat exchanger may be of unitary construction and made of one material. The heat exchanger may be made via additive manufacturing (AM), wherein additive manufacturing may comprise one or more of selective laser melting (SLM) and selective laser sintering (SLS). Other suitable AM techniques are also contemplated.

Discussed herein is a method of using a heat exchanger, wherein said heat exchanger comprises at least three fluid inlets and at least three fluid channels, wherein each of the at least three fluid channels has a minimum dimension of no greater than about 30 mm, the method comprising introducing at least three fluid streams into the heat exchanger and extracting at least one fluid stream from the heat exchanger. In other embodiments, each of the at least three fluid channels have a minimum dimension of no greater than about 15 mm. In an embodiment, the method comprises allowing at least two fluid streams to come in contact with one another. The method may include allowing three fluid streams to come in contact with one another.

In an embodiment, the method comprises utilizing the multi-fluid heat exchanger with an EC reactor. The method may comprise allowing the at least three fluid streams to enter the EC reactor. In a preferred embodiment, the EC reactor comprises a fuel cell.

In an embodiment, the method of using a heat exchanger comprises introducing the extracted at least one fluid stream into an absorption cooling device. The method may further comprise introducing the extracted at least one fluid stream into a water recycle apparatus. The method may further comprise introducing the extracted at least one fluid stream into a carbon dioxide harvesting apparatus. In other embodiments, the method comprises introducing two of the at least three fluid streams into a combustion device.

In an embodiment, the fluid streams flow concurrently or counter currently or a combination thereof. In an embodiment, one fluid stream is adjacent to or sandwiched between two other fluid streams.

As an example, a system comprises a vessel configured to contain an EC reactor, a heat exchanger comprising at least three fluid inlets and at least three fluid channels, wherein each of the at least three fluid channels has a minimum dimension of no greater than 30 mm. The heat exchanger and the vessel may be of unitary construction. In an embodiment, each of the three fluid channels has a minimum dimension of no greater than 15 mm or 10 mm or 5 mm.

In an embodiment, at least two of the three fluid channels converge. In other embodiments, three fluid channels converge. In an embodiment, the heat exchanger comprises no brazed or soldered part. In an embodiment, the heat exchanger and the vessel are made of one material, wherein the one material comprises Inconel, stainless steel, ceramic, aluminum, copper or brass.

In an embodiment, the heat exchanger comprises fins or baffles or supports or catalysts in at least one of the fluid channels. The fins or baffles (or supports) and the heat exchanger and the vessel may be made of a single part, i.e., of unitary construction. In various embodiments, the fins or baffles (or supports) and the heat exchanger and the vessel are made of one material but may also be made of multiple materials. In an embodiment, the heat exchanger and the vessel are made via AM. The fins or baffles (or supports) and the heat exchanger and the vessel may be made via AM. In an embodiment, the AM comprises selective laser melting (SLM) or selective laser sintering (SLS). Other suitable AM techniques are also contemplated.

In an embodiment, a system comprises a reactor, wherein the reactor is placed inside the vessel. The reactor may be an EC reactor. In a preferred embodiment, the EC reactor is a fuel cell.

In an embodiment, only one layer of material separates two fluid channels, wherein the separating layer is no greater than 5 mm or 1 mm or 0.5 mm or 0.2 mm or 0.1 mm. The minimum dimension of one fluid channel may be at least twice as large as the minimum dimension of another fluid channel. The minimum dimension of one fluid channel may be at least three times, four times or five times as large as the minimum dimension of another fluid channel. In an embodiment, at least two fluid channels converge and form an additional fluid channel.

In an embodiment, a system comprises a reformer chamber, wherein the reformer chamber, the vessel, and the heat exchanger are of unitary construction. The reformer chamber is configured to contain a reformer. Such a reformer, for example, is able to reform hydrocarbons into hydrogen or hydrogen and carbon monoxide. In an embodiment, the system comprises an absorption cooler. In some cases, the absorption cooler, the reformer chamber, the vessel, and the heat exchanger are part of unitary construction. In an embodiment, the system comprises humidifier, water recycle unit, carbon dioxide harvesting apparatus, water heater, or combinations thereof.

### Integrated Heat Exchanger

Disclosed herein is an electrochemical (EC) reactor, such as a solid oxide reactor (SOR), comprising a first electrode, a second electrode, an electrolyte between the first and second electrodes, and a first heat exchanger, wherein said first heat exchanger is in fluid communication with the first electrode. The minimum distance between the first electrode and the first heat exchanger is no greater than 10 cm, no greater than 5 cm or no greater than 1 cm. In still other embodiments, the minimum distance is no greater than 5 mm or no greater than 1 mm. The EC reactor comprises a second heat exchanger, wherein the second heat exchanger is in fluid communication with the second electrode. The minimum distance between the second electrode and the second heat exchanger no greater than 10 cm, no greater than 5 cm or no greater than 1 cm. In still other embodiments, the minimum distance is no greater than 5 mm or no greater than 1 mm.

In one embodiment, the first heat exchanger is adjacent to the first electrode, or alternatively wherein the second heat exchanger is side-by-side or adjacent to the second electrode. The one or more heat exchangers may be placed side-by-side the components in an EC reactor, or on top of or below the components (i.e., electrodes) of an EC reactor. FIG. 4B is an illustrative example where an integrated multi-fluid heat exchanger comprising 416 and 418 is at the bottom of a repeat unit/stack in a fuel cell separated only by an interconnect layer 420 from the anode 410. In this case, the minimum distance between the heat exchanger and the repeat unit/stack is only the thickness of the interconnect, which is 1 mm or less, 0.5 mm or less, 200 microns or less, or in the range of about 100 nm to about 100 microns. In some embodiments, the first heat exchanger and the second heat exchanger are the same heat exchanger, wherein the heat exchangers form a multi-fluid heat exchanger. The EC reactor may comprise a solid oxide fuel cell, solid oxide flow battery, electrochemical gas producer, or electrochemical compressor. The EC reactor may comprise a reformer upstream of the first electrode or a reformer in contact with the first electrode or a reformer in the first heat exchanger. The EC reactor may comprise two or more repeat units separated by interconnects, wherein each repeat unit comprises a first electrode, a second electrode, and an electrolyte. Each repeat unit may comprise at least one heat exchanger adjacent to the repeat unit.

Herein also disclosed is an EC reactor, such as a solid oxide reactor (SOR), comprising a stack and a heat exchanger. The stack has a stack height and comprises multiple repeat units separated by interconnects, wherein each repeat unit comprises a first electrode, a second electrode, and an electrolyte between the first and second electrodes. The heat exchanger is in fluid communication with the stack and wherein the minimum distance between the stack and the heat exchanger is no greater than 2 times the stack height, or no greater than the stack height, or no greater than half the stack height. The heat exchanger may be adjacent to the stack. The heat exchanger comprises at least three fluid inlets and at least three fluid channels, wherein each of the at least three fluid channels has a minimum dimension of no greater than 30 mm. The stack or the heat exchanger may further comprise a reformer. The reformer may be built into the stack or the heat exchanger. In an embodiment, the interconnect comprises no fluid dispersing element and the electrodes comprise fluid dispersing components or fluid channels.

In an embodiment, the EC reactor is in the form of a cartridge (such as that illustrated in FIGS. 4A-D). The cartridge may comprise a fuel entrance on a fuel side of the cartridge, an oxidant entrance on an oxidant side of the cartridge, at least one fluid exit, wherein the fuel entrance has a width of W_{f}, the fuel side of the cartridge has a length of L_{f}, the oxidant entrance has a width of Wₒ, the oxidant side of the cartridge has a length of Lₒ, wherein W_{f}/L_{f} is in the range of 0.1 to 1.0, 0.1 to 0.9, 0.2 to 0.9, 0.5 to 0.9, or 0.5 to 1.0 and Wₒ/Lₒ is in the range of 0.1 to 1.0, 0.1 to 0.9, 0.2 to 0.9, 0.5 to 0.9, or 0.5 to 1.0. In some embodiments, the entrances and exit are on one surface of the cartridge wherein the cartridge comprises no protruding fluid passage on the surface. The cartridge may be detachably fixed to a mating surface and not soldered nor welded to the mating surface. The cartridge may be bolted to or pressed to the mating surface. The mating surface may comprise a matching fuel entrance, matching oxidant entrance, and at least one matching fluid exit.

Further disclosed herein is a EC reactor cartridge, such as a solid oxide reactor cartridge (SORC), comprising a first electrode, a second electrode, an electrolyte between the first and second electrodes, and a heat exchanger, wherein said heat exchanger is in fluid communication with the first electrode or the second electrode or both. The minimum distance between the heat exchanger and the first electrode or the second electrode is no greater than 10 cm, or no greater than 5 cm, or no greater than 1 cm, or no greater than 5 mm, or no greater than 1 mm.

In an embodiment, the EC reactor cartridge comprises a reformer upstream of the first electrode or a reformer in contact with the first electrode or a reformer in the heat exchanger. The EC reactor cartridge may comprise a fuel entrance on a fuel side of the cartridge, an oxidant entrance on an oxidant side of the cartridge, at least one fluid exit, wherein the fuel entrance has a width of W_{f}, the fuel side of the cartridge has a length of L_{f}, the oxidant entrance has a width of Wₒ, the oxidant side of the cartridge has a length of Lₒ. The ratio of W_{f}/L_{f} is in the range of 0.1 to 1.0, 0.1 to 0.9, 0.2 to 0.9, 0.5 to 0.9, or 0.5 to 1.0 and the ratio of W₀/L is in the range of 0.1 to 1.0, 0.1 to 0.9, 0.2 to 0.9, 0.5 to 0.9, or 0.5 to 1.0. The entrances and exit may be on one surface of the cartridge and wherein the cartridge comprises no protruding fluid passage on the surface. The EC reactor cartridge may be detachably fixed to a mating surface and not soldered nor welded to the mating surface.

Discussed herein is a method of forming an EC reactor, such as a solid oxide reactor (SOR), comprising forming a first electrode in a device, forming an electrolyte in the same device, forming a second electrode in the same device, and forming a heat exchanger in the same device, wherein the electrolyte is between the first electrode and the second electrode and is in contact with the electrodes. The heat exchanger may be in fluid communication with the first electrode or the second electrode or both. The forming method may comprise one or more of material jetting, binder jetting, inkjet printing, aerosol jetting, aerosol jet printing, vat photopolymerization, powder bed fusion, material extrusion, directed energy deposition, sheet lamination, ultrasonic inkjet printing, direct (dry) powder deposition, or combinations thereof. Preferably, the forming is accomplished by inkjet printing.

In an embodiment, the method of forming an EC reactor further comprises heating the EC reactor. The heating may be performed in situ. The heating may be performed using electromagnetic radiation (EMR). The method of forming an EC reactor may further comprise forming multiple repeat units and interconnects between the repeat units, wherein a repeat unit comprises the first electrode, the electrolyte, and the second electrode. In an embodiment, forming the repeat units and the interconnects take place in the same device. In a preferred embodiment, the method comprises heating the repeat units and the interconnects in situ using EMR. In a preferred embodiment, the method further comprises forming a reformer. The reformer may be formed in the same device.

In an embodiment, the interconnects in the EC reactor comprise no fluid dispersing element. In an embodiment, the method of forming an EC reactor comprises forming a first template while forming the first electrode, wherein the first template is in contact with the first electrode; removing at least a portion of the first template to form channels in the first electrode. The method further comprises forming a second template while forming the second electrode, wherein the second template is in contact with the second electrode; removing at least a portion of the second template to form channels in the second electrode. In an embodiment, the first electrode comprises fluid dispersing components (FDC) or fluid channels; wherein the second electrode comprises fluid dispersing components (FDC) or fluid channels.

In an embodiment, the EC reactor, such as an SOR, is formed into a cartridge. The cartridge comprises a fuel entrance on a fuel side of the cartridge, an oxidant entrance on an oxidant side of the cartridge, at least one fluid exit, wherein the fuel entrance has a width of W_{f}, the fuel side of the cartridge has a length of L_{f}, the oxidant entrance has a width of Wₒ, and the oxidant side of the cartridge has a length of Lₒ. The ratio of W_{f}/L_{f} may be in the range of 0.1 to 1.0, 0.1 to 0.9, 0.2 to 0.9, 0.5 to 0.9, or 0.5 to 1.0 and the ratio of Wₒ/Lₒ is in the range of 0.1 to 1.0, 0.1 to 0.9, 0.2 to 0.9, 0.5 to 0.9, or 0.5 to 1.0. In an embodiment, the entrances and exit are on one surface of the cartridge and said cartridge comprises no protruding fluid passage on said surface. In an embodiment, the cartridge is detachably fixed to a mating surface and not soldered nor welded to the mating surface. The cartridge may be bolted to or pressed to the mating surface. In an embodiment, the method comprises forming a reformer upstream of the first electrode or a reformer in contact with the first electrode or a reformer in the heat exchanger. The reformer may be formed in the same device.

Also disclosed herein is a method comprising forming an EC reactor stack and a heat exchanger, wherein the stack having a stack height comprises multiple repeat units separated by interconnects, wherein each repeat unit comprises a first electrode, a second electrode, and an electrolyte between the first and second electrodes. The heat exchanger may be in fluid communication with the stack and wherein the minimum distance between the stack and the heat exchanger is no greater than 2 times the stack height, or no greater than the stack height, or no greater than half the stack height.

In an embodiment, the EC reactor stack, such as an SOR, and the heat exchanger are formed in the same device. The method may comprise forming the stack and the heat exchanger into a cartridge. The cartridge may be detachably fixed to a mating surface and not soldered nor welded to the mating surface.

Further discussed herein is a method comprising forming an EC reactor, such as a SOR, comprising a first electrode, a second electrode, an electrolyte between the first and second electrodes, and a heat exchanger. The heat exchanger may be in fluid communication with the first electrode or the second electrode or both. The minimum distance between the heat exchanger and the first electrode or the second electrode is no greater than 10 cm, no greater than 5 cm, no greater than 1 cm, no greater than 5 mm, or no greater than 1 mm. In some cases, the electrodes, the electrolyte, and the heat exchanger are formed in the same device. The method in some cases also comprises forming the EC reactor into a cartridge. The cartridge may be detachably fixed to a mating surface and not soldered nor welded to the mating surface.

Disclosed herein is a method comprising forming an EC reactor cartridge comprising forming a first electrode, forming a second electrode, forming an electrolyte between the first and second electrodes, and forming a heat exchanger. In an embodiment, the heat exchanger is in fluid communication with the first electrode or the second electrode or both. In an embodiment, the electrodes, the electrolyte, and the heat exchanger are formed in the same device. In an embodiment, the method comprises forming a reformer upstream of the first electrode or a reformer in contact with the first electrode or a reformer in the heat exchanger. In an embodiment, the reformer is formed in the same device.

### Integrated Absorption Chiller

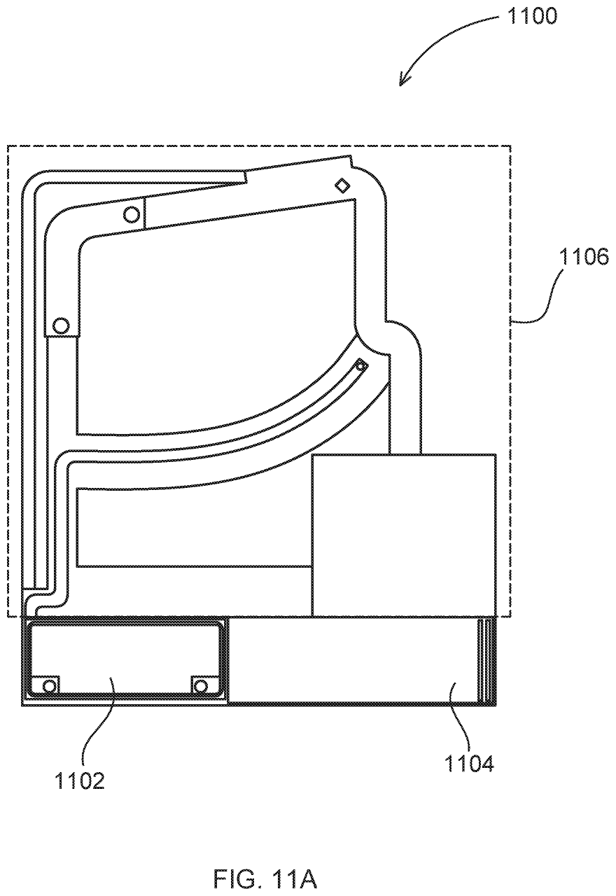

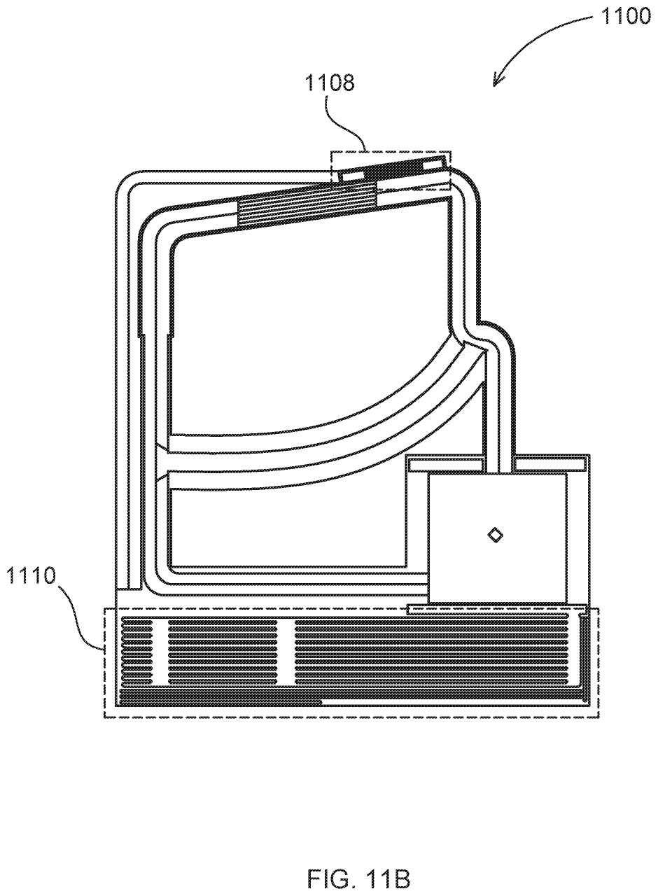

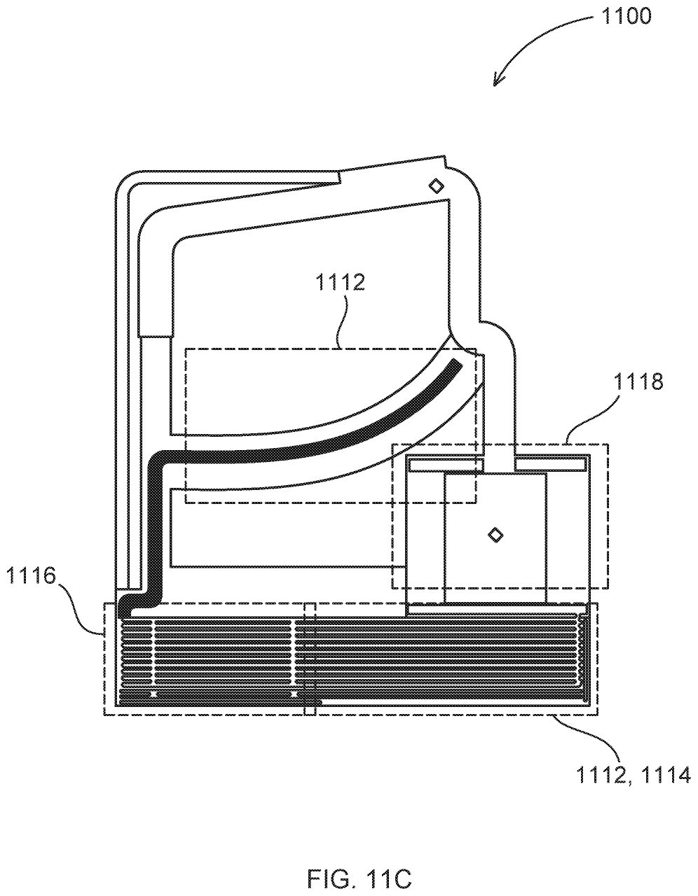

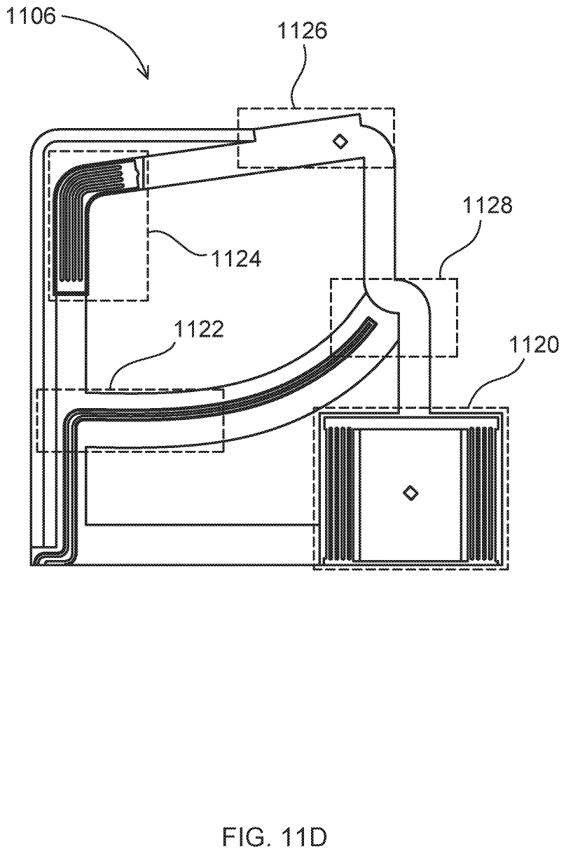

FIG. 11A illustrates an integrated absorption chiller in an electrochemical reactor system 1100, according to an embodiment of the disclosure. The discussion herein regarding the system with the integrated absorption chiller takes fuel cell as an example. But this system is applicable to any suitable electrochemical reactor as known to one skilled in the art, such as solid oxide flow battery. System 1100 comprises a fuel cell chamber 1102, an optional reformer chamber 1104 and an integrated chiller 1106. In an exemplary embodiment, system 1100 is formed as one single part of unitary construction. In an exemplary embodiment, the system 1100 comprises a fuel cell in the fuel cell chamber 1102. The fuel cell chamber, reformer chamber, and integrated chiller may be of a single material. The single material may comprise Inconel, stainless steel, ceramic, aluminum, copper, or brass.

The system 1100 may further comprise a heat exchanger, wherein the heat exchanger comprises at least three fluid inlets and at least three fluid channels. Each of the at least three fluid channels may have a minimum dimension of no greater than 30 mm. The fuel cell chamber 1102, reformer chamber 1104, integrated chiller 1106, and the heat exchanger may be of unitary construction. The heat exchanger may comprise fins or baffles or supports in at least one of the fluid channels. The system 1100 may comprise no brazed or soldered part. The integrated chiller may further comprise a generator, absorber, evaporator, condenser as previously described herein and illustrated in FIG. 9. System 1100 may further comprise a rectifier. The heat exchanger can be configured such that exhaust from the fuel cell chamber 1102 is conveyed to the generator of the integrated chiller 1106. In an embodiment, only one layer of material separates the generator of the integrated chiller 1106 from the exhaust.

FIG. 11B illustrates a cross-sectional view of system 1100, according to an embodiment of the disclosure. FIG. 11B illustrates single part system 1100 comprising a fuel cell chamber 1102, reformer chamber 1104 and integrated chiller 1106 and further showing an air heat exchanger 1108 and an afterburner 1110.

FIG. 11C illustrates a cross-sectional view of system 1100, according to an embodiment of the disclosure. FIG. 11C illustrates single part system 1100 comprising a fuel cell chamber 1102, reformer chamber 1104 and integrated chiller 1106 and further showing a fuel heat exchanger 1112, water heat exchanger 1114, air heat exchanger 1116, and exhaust heat 1118. It should be clarified that there are two locations or zones of a fuel heat exchanger 1112 in system 1100 though they are of the same fuel heat exchanger unit 1112.

FIG. 16D illustrates a cross-sectional view of the integrated chiller 1106, according to an embodiment of the disclosure. Integrated chiller 1106 in FIG. 16D further shows a generator 1120, absorber 1122, evaporator 1124, condenser 1126, and rectifier 1128. System 1100 may further comprise a multi fluid stream heat exchanger as described previously herein.

In an embodiment, the system 1100 further comprises a reformer or a desulfurization unit or both. The system 1100 may comprise a humidifier or a water recycle unit or both. The system 1100 comprise a carbon dioxide harvesting apparatus. The system 1100 may comprise a water heater and optionally a water tank. The system 1100 may comprise a grey water processor.

Also disclosed herein is a method of making an apparatus, comprising forming a fuel cell chamber 1102, optionally forming a reformer chamber 1104, and forming an integrated chiller 1106, wherein the fuel cell chamber 1102, reformer chamber 1104, and integrated chiller 1106 are a single part. The method comprises making the apparatus from one material. The one material comprises Inconel, stainless steel, ceramic, aluminum, copper, or brass.

In an embodiment, the method comprises forming a heat exchanger, wherein the heat exchanger, the fuel cell chamber, the reformer chamber, and the integrated chiller are one part. The heat exchanger comprises at least three fluid inlets and at least three fluid channels. Each of the at least three fluid channels has a minimum dimension of no greater than 30 mm, no greater than 15 mm or 10 mm or 5 mm.

In an embodiment, the method comprises converging at least two of the three fluid channels and forming an additional fluid channel. The method comprises forming fins or baffles or supports in at least one of the fluid channels as the at least one of the fluid channels is being formed. The fins or baffles or supports and the heat exchanger may be of unitary construction and made of one material. The method may comprise no brazing or soldering. The apparatus may be made via additive manufacturing, wherein the additive manufacturing may comprise selective laser melting or selective laser sintering.

Further described herein is a method comprising placing a fuel cell in a fuel cell chamber 1102, optionally placing a reformer in a reformer chamber 1104, allowing exhaust from the fuel cell to add thermal energy to an integrated chiller 1106, wherein the fuel cell chamber 1102, reformer chamber 1104, and integrated chiller 1106 are a single part of unitary construction. The integrated chiller 1106 may heat at least one reactant for the fuel cell. The integrated chiller 1106 may be used to cool a space, a fluid, an apparatus, data centers, computing equipment or combinations thereof.

In an embodiment, the method comprises allowing exhaust from the fuel cell to heat at least one reactant for the fuel cell in a heat exchanger, wherein the heat exchanger, the fuel cell chamber, the optional reformer chamber, and the integrated chiller are of unitary construction. The heat exchanger may comprise at least three fluid inlets and at least three fluid channels, wherein each of the at least three fluid channels has a minimum dimension of no greater than 30 mm. The method may comprise introducing at least three fluid streams into the heat exchanger and extracting at least one fluid stream from the heat exchanger. The method may comprise allowing at least two fluid streams to come in contact with one another. The method may comprise introducing the extracted at least one fluid stream into the integrated chiller 1106. The fluid streams may flow concurrently or counter currently or a combination thereof. One fluid stream may be adjacent to or sandwiched between two other fluid streams. Only one layer of material may separate two fluid channels, wherein the layer may be no greater than 5 mm or 1 mm or 0.5 mm.

In an embodiment, the method may comprise introducing exhaust from the fuel cell into a water recycle apparatus, a carbon dioxide harvesting apparatus, a humidifier, a water heater or a combination thereof.

In an embodiment, heat is exchanged between a fluid that passes through the fuel cell chamber 1102 and at least a portion of the integrated chiller 1106. The integrated chiller 1106 may comprise lithium bromide or ammonia. Heat from the fuel cell or fuel cell chamber 1102 may cause phase change in a fluid in the integrated chiller 1106.

### Example

The following example is provided as part of the disclosure of various embodiments of the present invention. As such, none of the information provided below is to be taken as limiting the scope of the invention.

### Example 1. Fuel Cell Stack Configurations

A 48-Volt fuel cell stack has 69 cells with about 1000 Watts of power output. The fuel cell in this stack has a dimension of about 4 cm×4 cm in length and width and about 7 cm in height. A 48-Volt fuel cell stack has 69 cells with about 5000 Watts of power output. The fuel cell in this stack has a dimension of about 8.5 cm×8.5 cm in length and width and about 7 cm in height.

It is to be understood that this disclosure describes exemplary embodiments for implementing different features, structures, or functions of the invention. Exemplary embodiments of components, arrangements, and configurations are described to simplify the present disclosure; however, these exemplary embodiments are provided merely as examples and are not intended to limit the scope of the invention. The embodiments as presented herein may be combined unless otherwise specified. Such combinations do not depart from the scope of the disclosure.

Additionally, certain terms are used throughout the description and claims to refer to particular components or steps. As one skilled in the art appreciates, various entities may refer to the same component or process step by different names, and as such, the naming convention for the elements described herein is not intended to limit the scope of the invention. Further, the terms and naming convention used herein are not intended to distinguish between components, features, and/or steps that differ in name but not in function.

While the disclosure is susceptible to various modifications and alternative forms, specific embodiments thereof are shown by way of example in the drawings and description. It should be understood, however, that the drawings and detailed description are not intended to limit the disclosure to the particular form disclosed, but on the contrary, the intention is to cover all modifications, equivalents and alternatives falling within the spirit and scope of this disclosure.

What is claimed is:

1. A system comprising an electrochemical reactor chamber, an integrated chiller, and optionally a reformer chamber, wherein the reactor chamber, integrated chiller, and optional reformer chamber are of unitary construction.

2. The system of claim 1 further comprising an electrochemical reactor in the reactor chamber.

3. The system of claim 1, wherein the reactor chamber, optional reformer chamber, and integrated chiller are of a single material.

4. The system of claim 1 further comprising a heat exchanger, wherein the heat exchanger comprises at least three fluid inlets and at least three fluid channels, wherein each of the at least three fluid channels has a minimum dimension of no greater than 30 mm.

5. The system of claim 4, wherein the reactor chamber, the optional reformer chamber, the integrated chiller, and the heat exchanger are of unitary construction.

6. The system of claim 1, wherein the integrated chiller comprises a generator, absorber, evaporator, condenser, and optionally a rectifier.

7. The system of claim 6, wherein the heat exchanger is configured such that exhaust from the reactor chamber is conveyed to the generator of the integrated chiller.

8. A system comprising at least one electrochemical reactor, a vessel containing the at least one electrochemical reactor, and an absorption chiller comprising a heating loop and a cooling loop; wherein the vessel comprises a heat exchange wall or a multi-fluid heat exchanger; and wherein at least a portion of the heat exchange wall or at least a portion of the multi-fluid heat exchanger transfers heat to the heating loop of the absorption chiller.

9. The system of claim 8, wherein at least a portion of the heat exchange wall or at least a portion of the multi-fluid heat exchanger is an integral part of the heating loop of the absorption chiller.

10. The system of claim 8, wherein the cooling loop is configured to cool a residential space, a commercial space, or an apparatus.

11. The system of claim 1, wherein the at least one electrochemical reactor is a solid oxide fuel cell or a solid oxide flow battery.

12. A method comprising placing an electrochemical reactor in an electrochemical reactor chamber, optionally placing a reformer in a reformer chamber, allowing exhaust from the reactor to add thermal energy to an integrated chiller, wherein the reactor chamber, reformer chamber, and integrated chiller are of unitary construction.

13. The method of claim 12, wherein the integrated chiller heats at least one reactant for the reactor.

14. The method of claim 12, wherein the integrated chiller cools data centers or computing equipment.

15. The method of claim 12 comprising allowing exhaust from the reactor to heat at least one reactant for the reactor in a heat exchanger, wherein the heat exchanger, the reactor chamber, the optional reformer chamber, and the integrated chiller are of unitary construction.

16. The method of claim 15, wherein the heat exchanger comprises at least three fluid inlets and at least three fluid channels, wherein each of the at least three fluid channels has a minimum dimension of no greater than 30 mm.

17. The method of claim 16, wherein only one layer of material separates two fluid channels, wherein the layer is no greater than 5 mm thick.

18. The method of claim 12, wherein heat is exchanged between a fluid that passes through the reactor chamber and at least a portion of the integrated chiller.

19. The method of claim 12, wherein the integrated chiller comprises lithium bromide or ammonia.

20. The method of claim 12, wherein heat from the reactor or reactor chamber causes phase change in a fluid in the integrated chiller.
